(19) United States
(12) Patent Application Publication
(10) Pub. No.: US 2025/0203301 A1
(43) Pub. Date: Jun. 19, 2025

(54) ADVANCED PASSIVE INTEGRITY MANAGEMENT OF AN IMPLANTABLE DEVICE

(71) Applicant: COCHLEAR LIMITED, Macquarie University, NSW (AU)

(72) Inventors: Per HILLSTRÖM, Macquarie University (AU); Tommy BERGS, Macquarie University (AU)

(21) Appl. No.: 18/842,925

(22) PCT Filed: Mar. 3, 2023
(86) PCT No.: PCT/IB2023/052008

§ 371 Date: Aug. 30, 2024

Related U.S. Application Data
(60) Provisional application No. 63/359,552, filed on Jul. 8, 2022.
(60) Provisional application No. 63/316,183, filed on Mar. 3, 2022.

(51) Int. Cl. H04R 25/00; H04R 17/00

(52) U.S. Cl. CPC H04R 25/606; H04R 17/00; H04R 25/65; H04R 2225/67; H04R 2460/13

(57) ABSTRACT

A device including a housing and a piezoelectric component, wherein the piezoelectric component is supported in the housing via at least one curved surface of a support element. In an embodiment the device is an active transcutaneous bone conduction device. In an embodiment, the curved surface is a spherical rolling element that is rigid.

### CROSS-REFERENCE TO RELATED APPLICATIONS

This application claims priority to U.S. Provisional Application No. 63/316,183, entitled ADVANCED PASSIVE INTEGRITY MANAGEMENT OF AN IMPLANTABLE DEVICE, filed on Mar. 3, 2022, naming Per HILLSTRÖM as an inventor. This application also claims priority to U.S. Provisional Application No. 63/359,552, entitled ADVANCED PASSIVE INTEGRITY MANAGEMENT OF AN IMPLANTABLE DEVICE, filed on Jul. 8, 2022, naming Per HILLSTRÖM as an inventor. The entire contents of each application being incorporated herein by reference in their entirety.

### BACKGROUND

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In accordance with an embodiment, there is a device, comprising a housing and a piezoelectric component, wherein the piezoelectric component is supported in the housing via at least one curved surface of a support element.

In accordance with an embodiment, there a component of a bone conduction device, comprising a housing; and a transducer-seismic mass assembly, wherein the component is configured to enable permanent shock-proofing of the assembly beyond that which results from damping, and all vibrational paths from the transducer-seismic mass assembly, during normal operation, extend through a component that translates in its entirety with the transducer-seismic mass assembly when the component is subjected to a shock acceleration in a first direction and translates in its entirety with the transducer-seismic mass assembly when the component is subjected to a shock acceleration in a second direction opposite the first direction, the translations being relative to the housing.

In accordance with an embodiment, there is a component of a bone conduction device, comprising a housing and a transducer-seismic mass assembly, wherein the component is configured to enable permanent shock-proofing of the assembly beyond that which results from damping, and all vibrational paths from the transducer-seismic mass assembly, during normal operation, extend through a component that translates in its entirety with the transducer-seismic mass assembly when the component is subjected to a shock acceleration in a first direction and translates in its entirety with the transducer-seismic mass assembly when the component is subjected to a shock acceleration in a second direction opposite the first direction, the translations being relative to the housing.

In accordance with an embodiment, there is a method, comprising obtaining a component of a medical device prosthesis including a piezoelectric bender, the piezoelectric bender being shock-proofingly supported in the component, and operating the component in a first mechanical state such that the piezoelectric bender bends in a manner that at least one of consumes or generates electricity, wherein the piezoelectric bender is supported in the component by at least one resilient element, and the shock-proofing provides shock protection in both directions normal to a plane of extension of the piezoelectric bender, and the at least one resilient element experiences compression when respective shock forces are applied in both directions sufficient to cause the piezoelectric bender to translate within the component.

A bone conduction device, comprising a housing made of metal having a height, the height being the smallest dimension, the housing establishing a hermetically sealed interior, a transducer-seismic mass assembly located in the hermetically sealed interior, the transducer-seismic mass assembly including a piezoelectric bender and two counterweight masses located opposite one another at ends of the piezoelectric bender, wherein the transducer-seismic mass assembly is supported in the housing by at least one spherical ball, during normal operation, the spherical ball is in contact with a first angled surface and a second angled surface, the first angled surface being fixed relative to the housing and the second angled surface being fixed relative to the transducer-seismic mass assembly, the bone conduction device being configured with permanent shock-proofing, wherein the permanent shock-proofing is such that movement of the transducer-seismic mass assembly in a first direction parallel to the height direction of the housing eliminates the contact between the ball and the first angled surface while maintaining contact between the ball and the second angled surface, and movement of the transducer-seismic mass assembly in a second direction opposite the first direction eliminates the contact between the ball and the second angled surface while maintaining contact between the ball and the first angled surface.

In another embodiment, there is a device, comprising a housing, piezoelectric component and a support assembly configured to support the piezoelectric component in the housing, wherein the support assembly includes a spring, wherein the spring is, with respect to a cross-section lying on and parallel to a longitudinal axis of the device, in at least three-point contact or three-line contact with other components of the support assembly.

In another embodiment, there is a device, comprising a housing, a piezoelectric component having a maximum dimension and a spring, wherein the piezoelectric component is supported by the spring, and the spring extends along an axis that runs substantially parallel to the maximum dimension.

In another embodiment, there is a device, comprising a housing, a piezoelectric component having a maximum dimension and a spring, wherein the piezoelectric component is supported by the spring, and the spring has a curved major axis.

In another embodiment, there is a device, comprising a housing, a transducer-seismic mass assembly and support assembly configured to support the transducer-seismic mass assembly in the housing, wherein the support assembly is configured to hold the transducer-seismic mass assembly at a first location within the housing in a first acceleration/deceleration environment while enabling the transducer-seismic mass assembly to move from the first location in a second acceleration/deceleration environment greater than the first environment, and the support assembly is configured so that a force applied to the transducer-seismic mass assembly that drives the transducer-seismic mass assembly to the first location when away from the first location increases over a first distance from the first location and then at least one of remains constant, decreases or increases at rate less than the increase over the first distance over a second distance greater than the first distance from the first location, and the first distance and the second distance are distances over which the transducer-seismic mass assembly is free to move within the housing.

### BRIEF DESCRIPTION OF THE DRAWINGS

Some embodiments are described below with reference to the attached drawings, in which:

FIGS. 1A and 1B are perspective views of exemplary bone conduction devices in which at least some embodiments can be implemented;

FIGS. 1C and 1D show alternate devices in which at least some embodiments can be implemented;

FIG. 2 is a schematic diagram conceptually illustrating a percutaneous bone conduction device;

FIG. 3 is a schematic diagram conceptually illustrating a passive transcutaneous bone conduction device;

FIG. 3A is a schematic diagram conceptually illustrating an active transcutaneous bone conduction device in accordance with at least some exemplary embodiments;

FIG. 4 is a schematic diagram of an outer portion of an implantable component of a bone conduction device;

FIG. 5 is a schematic diagram of a cross-section of an exemplary implantable component of a bone conduction device;

FIG. 6 is a schematic diagram of a cross-section of the exemplary implantable component of FIG. 5 in operation;

FIG. 7 is a schematic diagram of a cross-section of the exemplary implantable component of FIG. 5 in a failure mode;

FIG. 8 is a schematic diagram of a cross-section of an exemplary embodiment that prevents the failure mode conceptually represented in FIG. 7;

FIG. 9 is a schematic diagram of a portion of the cross-section of the exemplary embodiment depicted in FIG. 8;

FIGS. 9A-9C are schematic diagrams depicting features of the embodiment of FIG. 8 and variations thereof;

FIGS. 10 and 10A show features of the embodiment of FIG. 8;

FIGS. 11-14 show different mechanical states of the embodiment of FIG. 9;

FIGS. 14A to 14B show alternate embodiments;

FIG. 15 shows vibration paths according to an embodiment;

FIGS. 15A-15B show features of alternate embodiments;

FIGS. 16-26 and 28 show additional alternate embodiments;

FIG. 27 shows an exemplary flowchart for an exemplary method;

FIGS. 28A-35C show additional alternate embodiments;

FIGS. 36-38 show additional exemplary embodiments;

FIGS. 39, 41-43 show additional exemplary embodiments; and

FIG. 40 shows details of an exemplary spring.

### DETAILED DESCRIPTION

Merely for ease of description, the techniques presented herein are primarily described herein with reference to an illustrative medical device, namely a hearing prosthesis. First introduced is a percutaneous bone conduction device. The techniques presented herein may also be used with a variety of other medical devices that, while providing a wide range of therapeutic benefits to recipients, patients, or other users, may benefit from the teachings herein used in other medical devices. For example, any techniques presented herein described for one type of hearing prosthesis, such as a percutaneous bone conduction device, corresponds to a disclosure of another embodiment of using such teaching with another hearing prosthesis, including other types of bone conduction devices (active transcutaneous and/or passive transcutaneous), middle ear auditory prostheses (particularly, the EM vibrator/actuator thereof), direct acoustic stimulators), etc. The techniques presented herein can be used with implantable/implanted microphones (where such is a transducer that receives vibrations and outputs an electrical signal (effectively, the reverse of an EM actuator), whether or not used as part of a hearing prosthesis (e.g., a body noise or other monitor, whether or not it is part of a hearing prosthesis) and/or external microphones. (And again, the EM transducers disclosed herein can correspond to implanted or external body vibration monitors.) The techniques presented herein can also be used with vestibular devices (e.g., vestibular implants), sensors, seizure devices (e.g., devices for monitoring and/or treating epileptic events, where applicable), and thus any disclosure herein is a disclosure of utilizing such devices with the teachings herein (and visa-versa), providing that the art enables such. The teachings herein can also be used with conventional hearing devices, such as telephones and ear bud devices connected MP3 players or smart phones or other types of devices that can provide audio signal output, that use an EM transducer. Indeed, the teachings herein can be used with specialized communication devices, such as military communication devices, factory floor communication devices, professional sports communication devices, etc.

By way of example, any of the technologies detailed herein which are associated with components that are implanted in a recipient can be combined with information delivery technologies disclosed herein, such as for example, devices that evoke a hearing percept, to convey information to the recipient. By way of example only and not by way of limitation, a sleep apnea implanted device can be combined with a device that can evoke a hearing percept so as to provide information to a recipient, such as status information, etc. In this regard, the various sensors detailed herein and the various output devices detailed herein can be combined with such a non-sensory prosthesis or any other nonsensory prosthesis that includes implantable components so as to enable a user interface, as will be described herein, that enables information to be conveyed to the recipient, which information is associated with the implant.

While the teachings detailed herein will be described for the most part with respect to hearing prostheses, in keeping with the above, it is noted that any disclosure herein with respect to a hearing prosthesis corresponds to a disclosure of another embodiment of utilizing the associated teachings with respect to any of the other prostheses noted herein, and/or with any of the other technologies herein (e.g., a body vibration sensor using an EM transducer as detailed herein), whether a species of a hearing prosthesis, or a species of a sensory prosthesis.

Also, it is noted that in at least some exemplary embodiments, the electromagnetic transducers disclosed herein can be utilized as vibration sensors and equipment and/or structure and/or vehicles. By way of example only and not by way of limitation, in an exemplary embodiment, any and transducer according to the teachings detailed herein can be utilized to detect vibrations in general, and determine the frequency thereof in particular, that are imparted on to, for example, the door of an automobile. This can have utilitarian value with respect to determining whether or not there are vibrations that will result in discomfort or otherwise an irritating driving situation for a driver thereof.

Conversely, the teachings detailed herein can be utilized in a vibrator context to impart vibrations onto/into, equipment and/or structure and/or vehicles. As will be detailed below, in an exemplary embodiment, a vibrator according to the teachings detailed herein can be utilized to maintain the flow of dust particulates from a collecting hopper of an electrostatic precipitator. In an exemplary embodiment, the vibrator detailed herein can maintain the flow of pasta or some other quasi-particle group of products, for example from bins to a packaging line, etc.

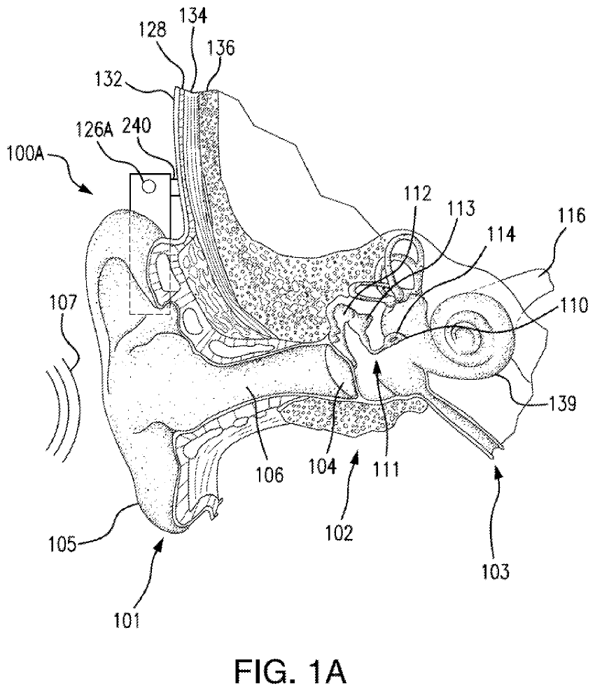

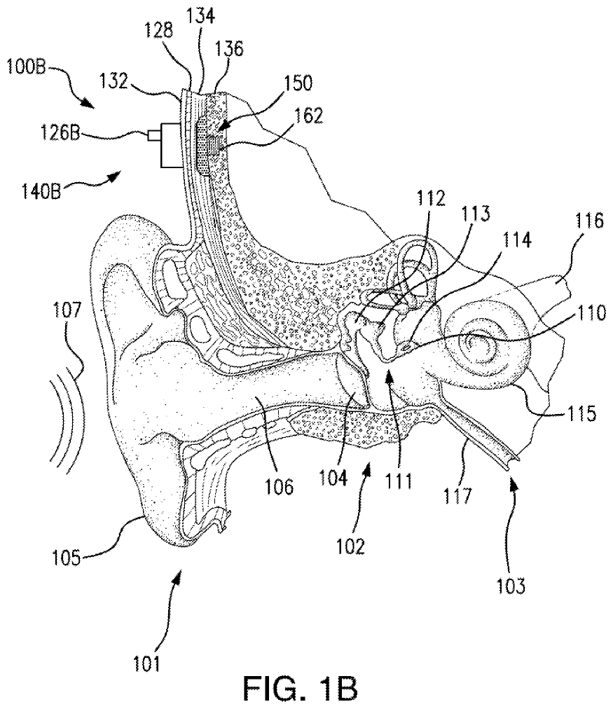

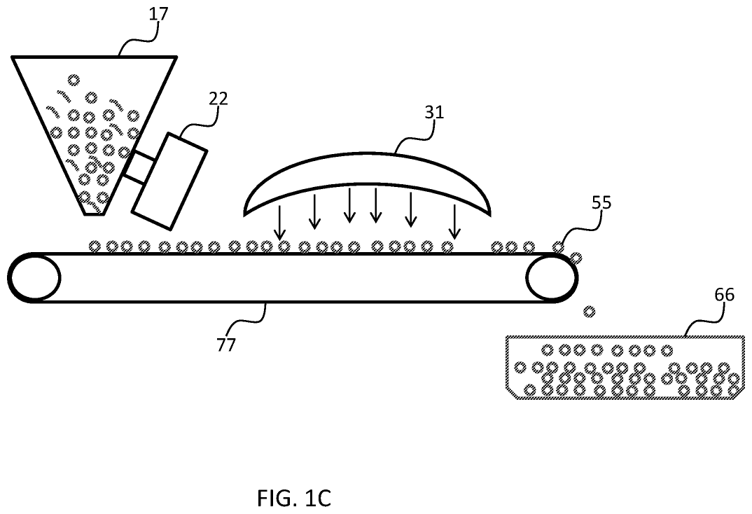

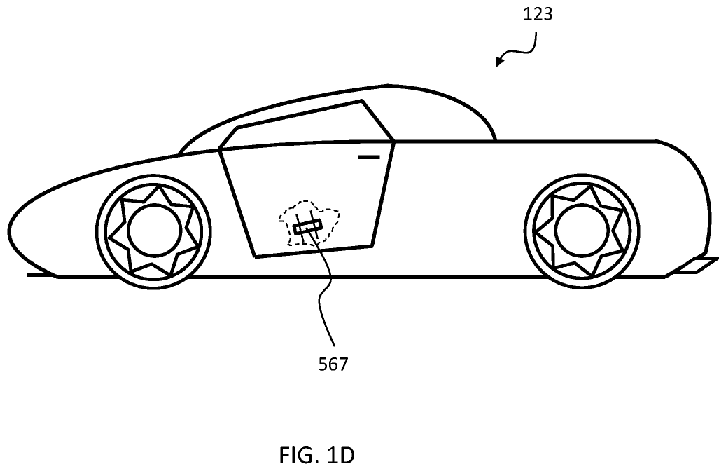

FIG. 1A is a perspective view of a bone conduction device 100A in which embodiments may be implemented. As shown, the recipient has an outer ear 101, a middle ear 102 and an inner ear 103. Elements of outer ear 101, middle ear 102 and inner ear 103 are described below, followed by a description of bone conduction device 100.

In a fully functional human hearing anatomy, outer ear 101 comprises an auricle 105 and an ear canal 106. A sound wave or acoustic pressure 107 is collected by auricle 105 and channeled into and through ear canal 106. Disposed across the distal end of ear canal 106 is a tympanic membrane 104 which vibrates in response to acoustic wave 107. This vibration is coupled to oval window or fenestra ovalis 210 through three bones of middle ear 102, collectively referred to as the ossicles 111 and comprising the malleus 112, the incus 113, and the stapes 114. The ossicles 111 of middle ear 102 serve to filter and amplify acoustic wave 107, causing oval window 210 to vibrate. Such vibration sets up waves of fluid motion within cochlea 139. Such fluid motion, in turn, activates hair cells (not shown) that line the inside of cochlea 139. Activation of the hair cells causes appropriate nerve impulses to be transferred through the spiral ganglion cells and auditory nerve 116 to the brain (not shown), where they are perceived as sound.

FIG. 1A also illustrates the positioning of bone conduction device 100A relative to outer ear 101, middle ear 102 and inner ear 103 of a recipient of device 100. As shown, bone conduction device 100 is positioned behind outer ear 101 of the recipient and comprises a sound input element 126A to receive sound signals. Sound input element may comprise, for example, a microphone, telecoil, etc. In an exemplary embodiment, sound input element 126A may be located, for example, on or in bone conduction device 100A, or on a cable extending from bone conduction device 100A.

In an exemplary embodiment, bone conduction device 100A comprises an operationally removable component and a bone conduction implant. The operationally removable component is operationally releasably coupled to the bone conduction implant. By operationally releasably coupled, it is meant that it is releasable in such a manner that the recipient can relatively easily attach and remove the operationally removable component during normal use of the bone conduction device 100A. Such releasable coupling is accomplished via a coupling assembly of the operationally removable component and a corresponding mating apparatus of the bone conduction implant, as will be detailed below. This as contrasted with how the bone conduction implant is attached to the skull, as will also be detailed below. The operationally removable component includes a sound processor (not shown), a vibratory electromagnetic actuator and/or a vibratory piezoelectric actuator and/or other type of actuator (not shown-which are sometimes referred to herein as a species of the genus vibrator) and/or various other operational components, such as sound input device 126A. In this regard, the operationally removable component is sometimes referred to herein as a vibrator unit. More particularly, sound input device 126A (e.g., a microphone) converts received sound signals into electrical signals. These electrical signals are processed by the sound processor. The sound processor generates control signals which cause the actuator to vibrate. In other words, the actuator converts the electrical signals into mechanical motion to impart vibrations to the recipient's skull.

As illustrated, the operationally removable component of the bone conduction device 100A further includes a coupling assembly 240 configured to operationally removably attach the operationally removable component to a bone conduction implant (also referred to as an anchor system and/or a fixation system) which is implanted in the recipient. In the embodiment of FIG. 1, coupling assembly 240 is coupled to the bone conduction implant (not shown) implanted in the recipient in a manner that is further detailed below with respect to exemplary embodiments of the bone conduction implant. Briefly, an exemplary bone conduction implant may include a percutaneous abutment attached to a bone fixture via a screw, the bone fixture being fixed to the recipient's skull bone 136. The abutment extends from the bone fixture, which is screwed into bone 136, through muscle 134, fat 128 and skin 232 so that the coupling assembly may be attached thereto. Such a percutaneous abutment provides an attachment location for the coupling assembly that facilitates efficient transmission of mechanical force.

It is noted that while many of the details of the embodiments presented herein are described with respect to a percutaneous bone conduction device, some or all of the teachings disclosed herein may be utilized in transcutaneous bone conduction devices and/or other devices that utilize a vibratory electromagnetic actuator. For example, embodiments include active transcutaneous bone conduction systems utilizing the electromagnetic actuators disclosed herein and variations thereof where at least one active component (e.g., the electromagnetic actuator) is implanted beneath the skin. Embodiments also include passive transcutaneous bone conduction systems utilizing the electromagnetic actuators disclosed herein and variations thereof where no active component (e.g., the electromagnetic actuator) is implanted beneath the skin (it is instead located in an external device), and the implantable part is, for instance a magnetic pressure plate. Some embodiments of the passive transcutaneous bone conduction systems are configured for use where the vibrator (located in an external device) containing the electromagnetic actuator is held in place by pressing the vibrator against the skin of the recipient. In an exemplary embodiment, an implantable holding assembly is implanted in the recipient that is configured to press the bone conduction device against the skin of the recipient. In other embodiments, the vibrator is held against the skin via a magnetic coupling (magnetic material and/or magnets being implanted in the recipient and the vibrator having a magnet and/or magnetic material to complete the magnetic circuit, thereby coupling the vibrator to the recipient).

More specifically, FIG. 1B is a perspective view of a transcutaneous bone conduction device 100B in which embodiments can be implemented.

FIG. 1B also illustrates the positioning of bone conduction device 100B relative to outer ear 101, middle ear 102 and inner ear 103 of a recipient of device 100. As shown, bone conduction device 100 is positioned behind outer ear 101 of the recipient. Bone conduction device 100B comprises an external component 140B and implantable component 150. The bone conduction device 100B includes a sound input element 126B to receive sound signals. As with sound input element 126A, sound input element 126B may comprise, for example, a microphone, telecoil, etc. In an exemplary embodiment, sound input element 126B may be located, for example, on or in bone conduction device 100B, on a cable or tube extending from bone conduction device 100B, etc. Alternatively, sound input element 126B may be subcutaneously implanted in the recipient, or positioned in the recipient's ear. Sound input element 126B may also be a component that receives an electronic signal indicative of sound, such as, for example, from an external audio device. For example, sound input element 126B may receive a sound signal in the form of an electrical signal from an MP3 player electronically connected to sound input element 126B.

Bone conduction device 100B comprises a sound processor (not shown), an actuator (also not shown) and/or various other operational components. In operation, sound input device 126B converts received sounds into electrical signals. These electrical signals are utilized by the sound processor to generate control signals that cause the actuator to vibrate. In other words, the actuator converts the electrical signals into mechanical vibrations for delivery to the recipient's skull.

In accordance with some embodiments, a fixation system 162 may be used to secure implantable component 150 to skull 136. As described below, fixation system 162 may be a bone screw fixed to skull 136, and also attached to implantable component 150.

In one arrangement of FIG. 1B, bone conduction device 100B is a passive transcutaneous bone conduction device. That is, no active components, such as the actuator, are implanted beneath the recipient's skin 132. In such an arrangement, the active actuator is located in external component 140B, and implantable component 150 includes a magnetic plate, as will be discussed in greater detail below. The magnetic plate of the implantable component 150 vibrates in response to vibration transmitted through the skin, mechanically and/or via a magnetic field, that are generated by an external magnetic plate.

In another arrangement of FIG. 1B, bone conduction device 100B is an active transcutaneous bone conduction device where at least one active component, such as the actuator, is implanted beneath the recipient's skin 132 and is thus part of the implantable component 150. As described below, in such an arrangement, external component 140B may comprise a sound processor and transmitter, while implantable component 150 may comprise a signal receiver and/or various other electronic circuits/devices.

FIG. 1C depicts an exemplary embodiment of a bin 17 to which is attached, in vibrational communication, a vibrator 22. The vibrator 22 vibrates, and thus “shakes” the material therein to more evenly distribute a solid mixture of electrostatically charged particles and golf balls 55. Briefly, the shaking results in a more evenly distributed coating of the particles on the golf balls, after which they are dropped out of the bin 17 onto conveyor belt 77, where they are taken to heater 31 which bakes the particles one to the outer surface of the golf balls. The now coated golf balls then fall into bin 66 for later packaging.

FIG. 1D depicts another exemplary embodiment that can utilize a transducer. Here, transducer 567 is located inside the door of automobile 123, held in the interior compartment thereof by straps, where the transducer 567, more accurately, the housing of the transducer 567 is in vibrational communication with the body of the door. In this embodiment, the transducer 567 is in electrical communication with an onboard computer of the automobile 123. The transducer detects, vibrations, such as those above the 500 Hz level, which might result in an uncomfortable sensation for the driver. An onboard computer can adjust the operation of the automobile 123 so as to potentially alleviate the vibration.

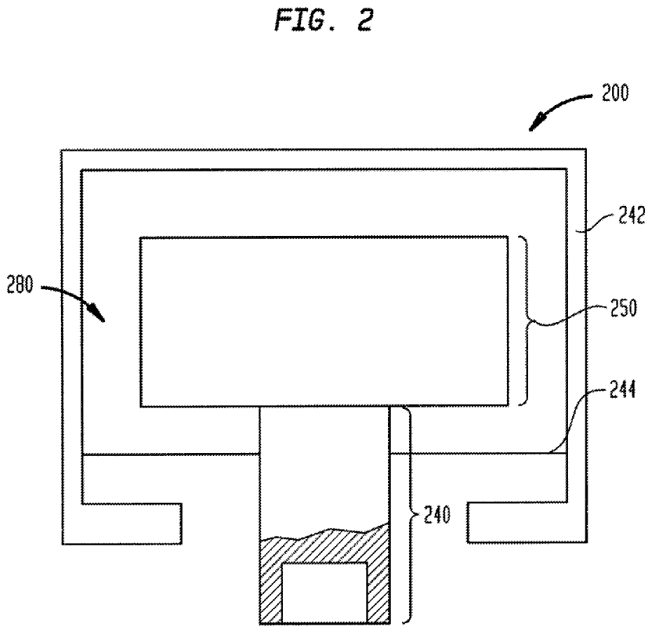

FIG. 2 is an embodiment of a bone conduction device 200 in accordance with an embodiment corresponding to that of FIG. 1A, illustrating use of a percutaneous bone conduction device. Bone conduction device 200, corresponding to, for example, element 100A of FIG. 1A, includes a housing 242, a vibratory electromagnetic actuator 250, a coupling assembly 240 that extends from housing 242 and is mechanically linked to vibratory electromagnetic actuator 250. Collectively, vibratory electromagnetic actuator 250 and coupling assembly 240 form a vibratory actuator-coupling assembly 280. Vibratory actuator-coupling assembly 280 is suspended in housing 242 by spring 244. In an exemplary embodiment, spring 244 is connected to coupling assembly 240, and vibratory electromagnetic actuator 250 is supported by coupling assembly 240.

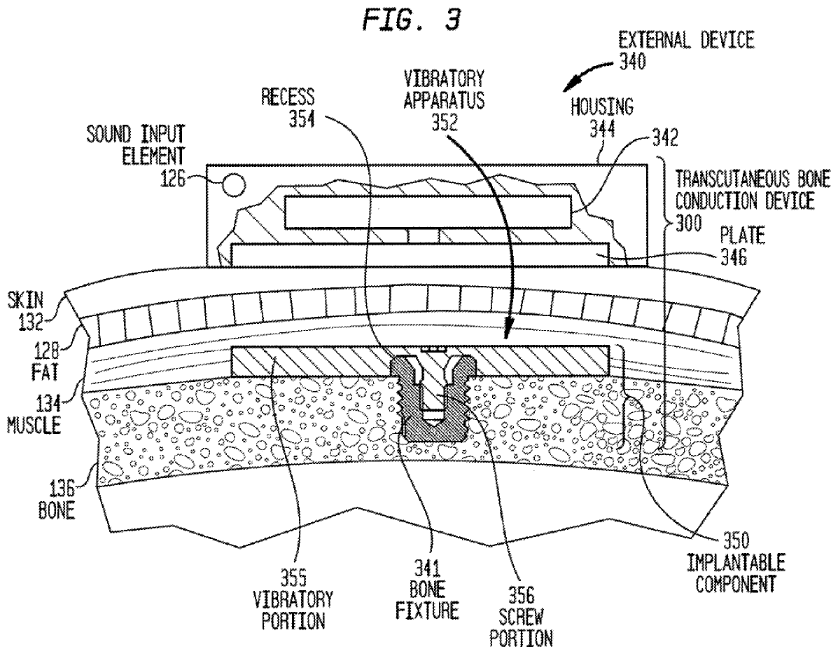

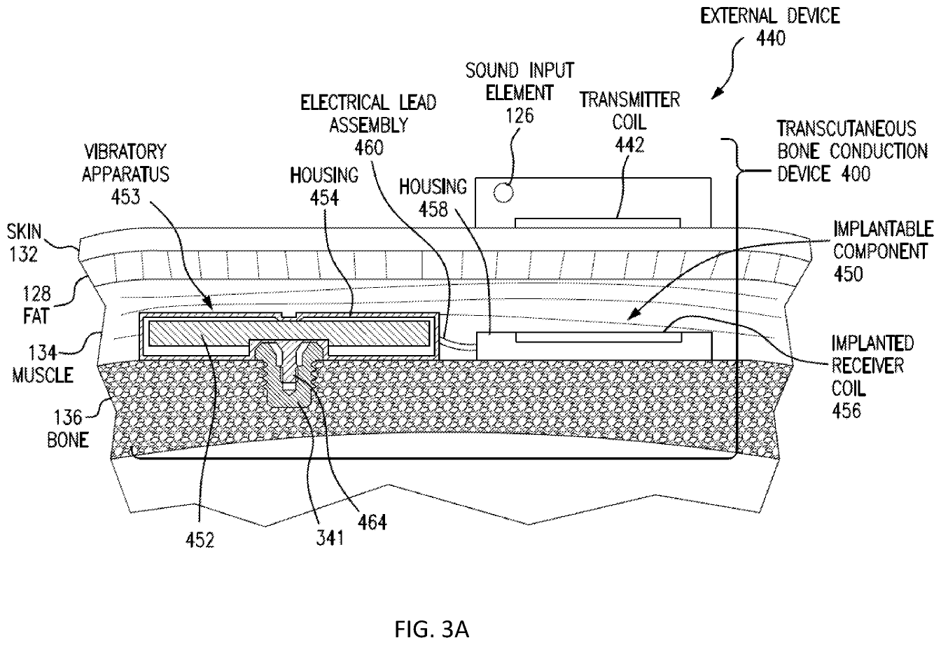

FIG. 3 depicts an exemplary embodiment of a transcutaneous bone conduction device 300 according to an embodiment that includes an external device 340 (corresponding to, for example, element 140B of FIG. 1B) and an implantable component 350 (corresponding to, for example, element 150 of FIG. 1B). The transcutaneous bone conduction device 300 of FIG. 3 is a passive transcutaneous bone conduction device in that a vibratory electromagnetic actuator 342 is located in the external device 340. Vibratory electromagnetic actuator 342 is located in housing 344 of the external component, and is coupled to plate 346. Plate 346 may be in the form of a permanent magnet and/or in another form that generates and/or is reactive to a magnetic field, or otherwise permits the establishment of magnetic attraction between the external device 340 and the implantable component 350 sufficient to hold the external device 340 against the skin of the recipient.

In an exemplary embodiment, the vibratory electromagnetic actuator 342 is a device that converts electrical signals into vibration. In operation, sound input element 126 converts sound into electrical signals. Specifically, the transcutaneous bone conduction device 300 provides these electrical signals to vibratory actuator 342, or to a sound processor (not shown) that processes the electrical signals, and then provides those processed signals to vibratory electromagnetic actuator 342. The vibratory electromagnetic actuator 342 converts the electrical signals (processed or unprocessed) into vibrations. Because vibratory electromagnetic actuator 342 is mechanically coupled to plate 346, the vibrations are transferred from the vibratory actuator 342 to plate 346. Implanted plate assembly 352 is part of the implantable component 350, and is made of a ferromagnetic material that may be in the form of a permanent magnet, that generates and/or is reactive to a magnetic field, or otherwise permits the establishment of a magnetic attraction between the external device 340 and the implantable component 350 sufficient to hold the external device 340 against the skin of the recipient. Accordingly, vibrations produced by the vibratory electromagnetic actuator 342 of the external device 340 are transferred from plate 346 across the skin to plate 355 of plate assembly 352. This can be accomplished as a result of mechanical conduction of the vibrations through the skin, resulting from the external device 340 being in direct contact with the skin and/or from the magnetic field between the two plates. These vibrations are transferred without penetrating the skin with a solid object such as an abutment as detailed herein with respect to a percutaneous bone conduction device.

As may be seen, the implanted plate assembly 352 is substantially rigidly attached to a bone fixture 341 in this embodiment. Plate screw 356 is used to secure plate assembly 352 to bone fixture 341. The portions of plate screw 356 that interface with the bone fixture 341 substantially correspond to an abutment screw discussed in some additional detail below, thus permitting plate screw 356 to readily fit into an existing bone fixture used in a percutaneous bone conduction device. In an exemplary embodiment, plate screw 356 is configured so that the same tools and procedures that are used to install and/or remove an abutment screw (described below) from bone fixture 341 can be used to install and/or remove plate screw 356 from the bone fixture 341 (and thus the plate assembly 352).

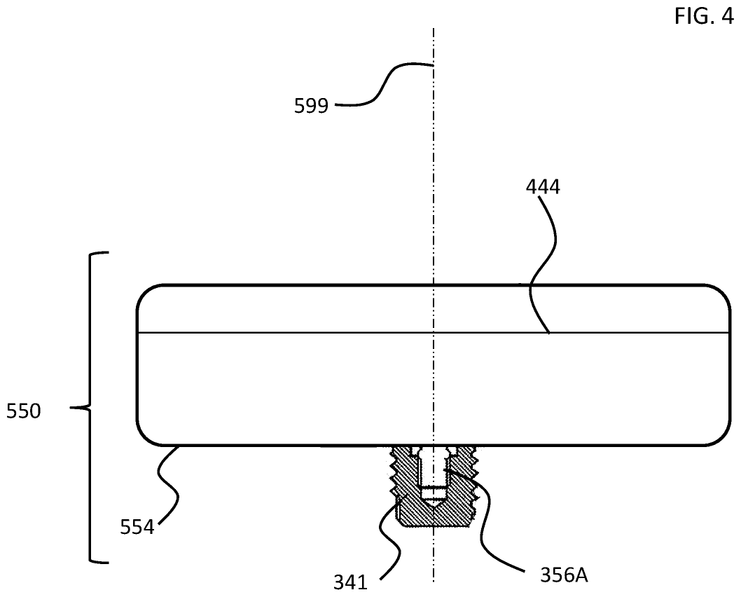

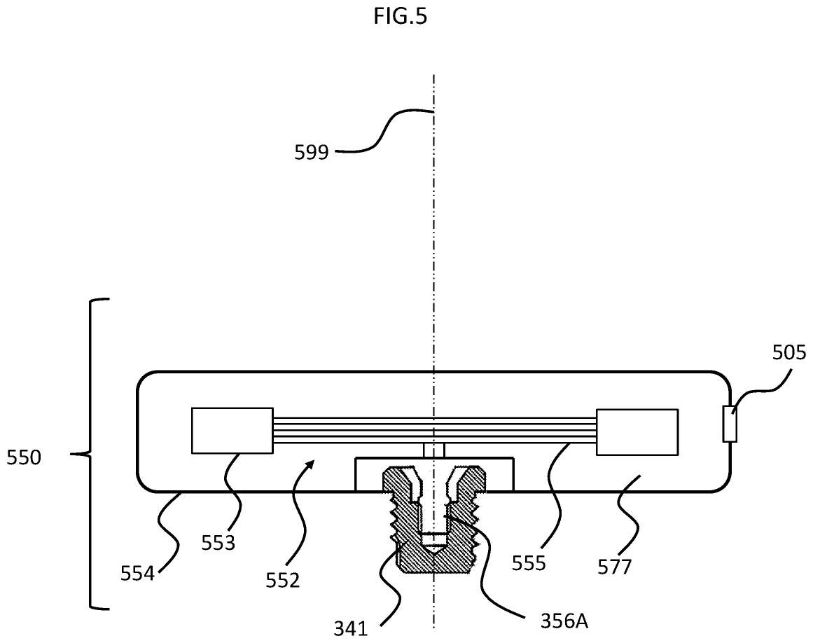

FIG. 3A depicts an exemplary embodiment of a transcutaneous bone conduction device 400 according to another embodiment that includes an external device 440 (corresponding to, for example, element 140B of FIG. 1B) and an implantable component 450 (corresponding to, for example, element 150 of FIG. 1B). The transcutaneous bone conduction device 400 of FIG. 4 is an active transcutaneous bone conduction device in that the vibratory actuator 452 is located in the implantable component 450. Specifically, a vibratory element in the form of vibratory actuator 452 is located in housing 454 of the implantable component 450. In an exemplary embodiment, much like the vibratory actuator 342 described above with respect to transcutaneous bone conduction device 300, the vibratory actuator 452 is a device that converts electrical signals into vibration.

External component 440 includes a sound input element 126 that converts sound into electrical signals. Specifically, the transcutaneous bone conduction device 400 provides these electrical signals to vibratory electromagnetic actuator 452, or to a sound processor (not shown) that processes the electrical signals, and then provides those processed signals to the implantable component 450 through the skin of the recipient via a magnetic inductance link. In this regard, a transmitter coil 442 of the external component 440 transmits these signals to implanted receiver coil 456 located in housing 458 of the implantable component 450. Components (not shown) in the housing 458, such as, for example, a signal generator or an implanted sound processor, then generate electrical signals to be delivered to vibratory actuator 452 via electrical lead assembly 460. The vibratory electromagnetic actuator 452 converts the electrical signals into vibrations.

The vibratory electromagnetic actuator 452 is mechanically coupled to the housing 454. Housing 454 and vibratory actuator 452 collectively form a vibratory element 453. The housing 454 is substantially rigidly attached to bone fixture 341.

Some exemplary features of the vibratory electromagnetic actuator usable in some embodiments of the bone conduction devices detailed herein and/or variations thereof will now be described in terms of a vibratory electromagnetic actuator used in the context of the percutaneous bone conduction device of FIG. 1A. It is noted that any and/or all of these features and/or variations thereof may be utilized in transcutaneous bone conduction devices such as those of FIGS. 1B, 3, and 4 and/or other types of prostheses and/or medical devices and/or other devices, at least with respect to enabling utilitarian performance thereof. It is also noted that while the embodiments detailed herein are detailed with respect to an electromagnetic actuator, the teachings associated therewith are equally applicable to electromagnetic transducers that receive vibrations and output a signal indicative of the vibrations, at least unless otherwise noted. In this regard, it is noted that use of the term actuator herein also corresponds to transducer, and vice versa, unless otherwise noted.

FIGS. 4 and 5 depict another exemplary embodiment of an implantable component usable in an active transcutaneous bone conduction device, here, implantable component 550. FIG. 4 depicts a side view of the implantable component 550 which includes housing 554 which entails two housing bodies made of titanium in an exemplary embodiment, welded together at seam 444 to form a hermetically sealed housing. FIG. 5 depicts a cross-sectional view of the implantable component 550.

In an exemplary embodiment, the implantable component 550 is used in the embodiment of FIG. 3 in place of implantable component 450. As can be seen, implantable component 550 combines an actuator 552 (corresponding with respect to functionality to actuator 452 detailed above). Briefly, it is noted that the vibrating actuator 552 includes a so-called counterweight/mass 553 that is supported by piezoelectric components 555. In the exemplary embodiment of FIG. 5, the piezoelectric components 555 flex upon the exposure of an electrical current thereto, thus moving the counterweight 553. In an exemplary embodiment, this movement creates vibrations that are ultimately transferred to the recipient to evoke a hearing percept.

As can be understood from the schematic of FIG. 5, in an exemplary embodiment, the housing 554 entirely and completely encompasses the vibratory apparatus 552, but includes feedthrough 505, so as to permit the electrical lead assembly 460 to communicate with the vibrating actuator 452 therein. It is briefly noted at this time that some and/or all of the components of the embodiment of FIG. 5 are at least generally rotationally symmetric about the longitudinal axis 559. In this regard, the screw 356A is circular about the longitudinal axis 559. Back lines have been omitted for purposes of clarity in some instances.

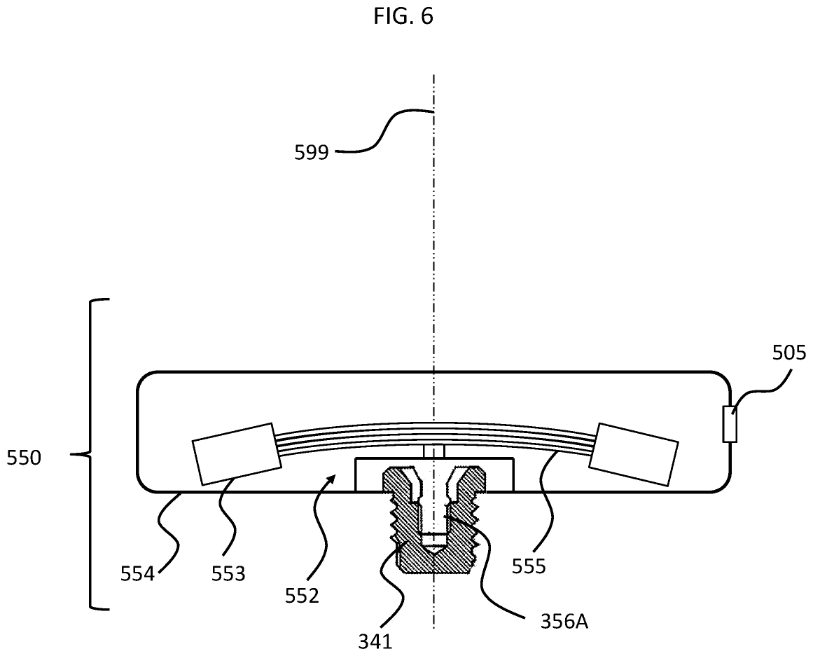

Still with reference to FIG. 5, as can be seen, there is a space 577 located between the housing 554 in general, and the inside wall thereof in particular, and the counterweight 553. This space has utilitarian value with respect to enabling the implantable component 550 to function as a transducer in that, in a scenario where the implantable component is an actuator, the piezoelectric material 555 can flex, which can enable the counterweight 553 to move within the housing 554 so as to generate vibrations to evoke a hearing percept. FIG. 6 depicts an exemplary scenario of movement of the piezoelectric material 555 when subjected to an electrical current along with the movement of the counterweight 553. As can be seen, space 577 provides for the movement of the actuator 552 within housing 554 so that the counterweight 553 does not come into contact with the inside wall of the housing 554. However, the inventors of the present application have identified a failure mode associated with such an implantable component 550. Specifically, in a scenario where prior to the attachment of the housing 554 and the components therein to the bone fixture 341, the housing and the components therein are subjected to an acceleration above certain amounts and/or a deceleration above certain amounts, the piezoelectric material 555 will be bent or otherwise deformed beyond its operational limits, which can, in some instances, have a deleterious effect on the piezoelectric material.

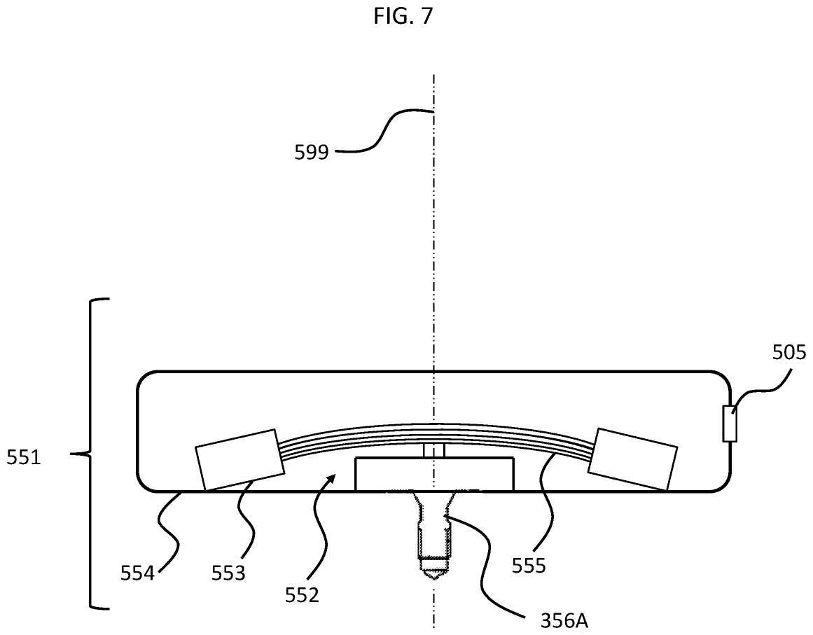

FIG. 7 depicts an exemplary failure mode, where implantable subcomponent 551 (without bone fixture 541) prior to implantation into a recipient (and thus prior to attachment to the bone fixture 541) is dropped from a height of 1.25 m onto a standard operating room floor or the like. The resulting deceleration causes the piezoelectric material 555, which is connected to the counterweight 553, to deform as seen in FIG. 7. This can break or otherwise plastically deform the piezoelectric material 555 (irrespective of whether the counterweight 553 contacts the housing walls, in some embodiments-indeed, in many embodiments, the piezoelectric material 555 will fail prior to the counterweights contacting the walls-thus, FIG. 7 is presented for purposes of conceptual illustration). The teachings detailed herein are directed towards avoiding such a scenario when associated with such decelerations and/or accelerations.

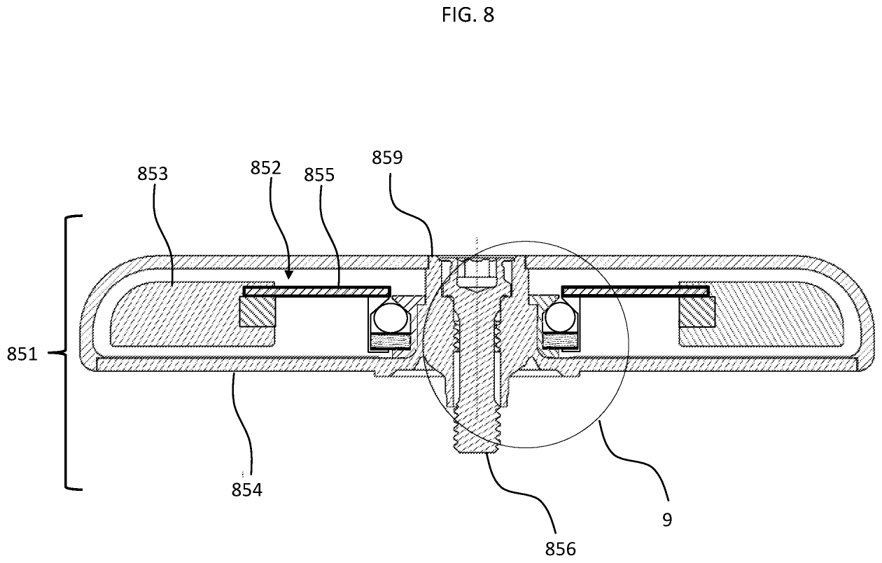

FIG. 8 depicts an exemplary embodiment of an exemplary implantable subcomponent 851 having utilitarian value in that such can reduce or otherwise eliminate the failure mode associated with that depicted in FIG. 7. FIG. 8 depicts a cross-section through the geometric center of the subcomponent 851. Implantable subcomponent 851 includes a housing 854 that encases an actuator 852, which actuator includes a piezoelectric material 855 corresponding to material 555 of FIG. 7, and a counterweight 853 that corresponds to the counterweight 553 of FIG. 7. Also seen in FIG. 8 is that the housing 854 includes a core 859. In this exemplary embodiment, the core 859 is an integral part with the bottom of the housing. The core 859 has a passage through which screw 856 extends, which screw is configured to screw into the bone fixture implanted into the bone of the recipient so as to fix the implantable subcomponent 851 to bone of the recipient. In this exemplary embodiment, the core 859 is such that the screw 856 can extend therethrough while maintaining a hermetically sealed environment within the housing (e.g., the housing subcomponent that forms the top of the housing 854 can be laser welded at the seams with the housing subcomponent that forms the bottom of the housing 854 and the core 859).

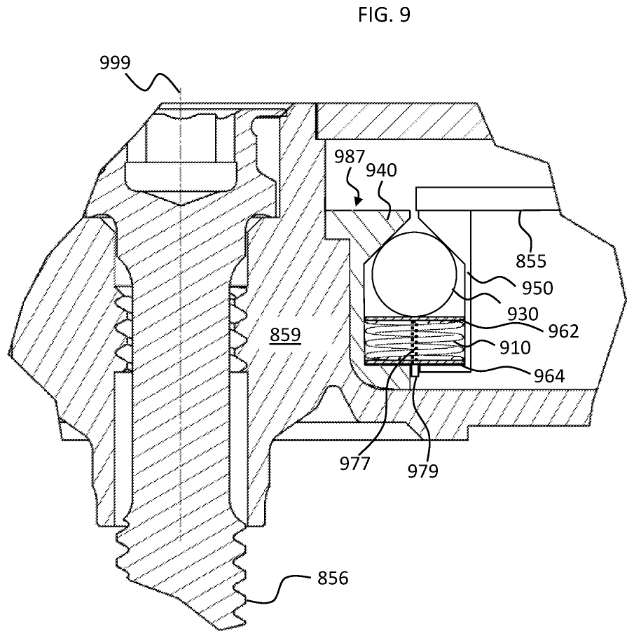

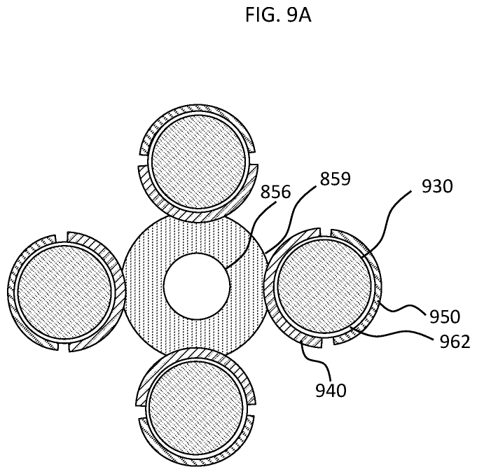

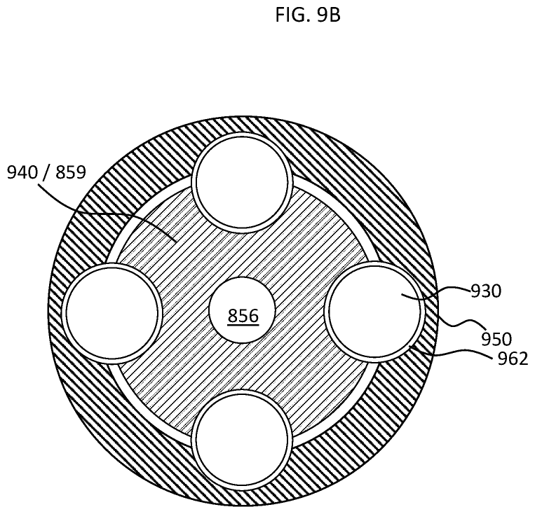

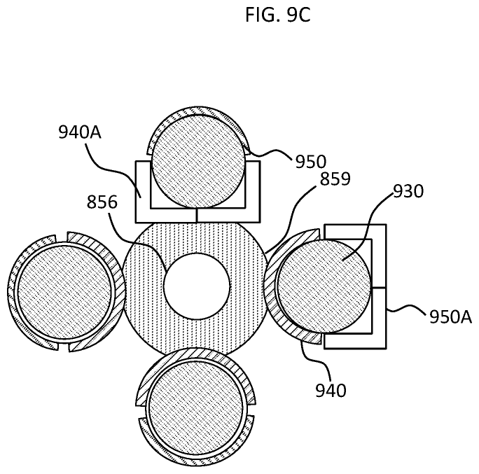

FIG. 9 depicts a larger view of a portion of the embodiment of FIG. 8, corresponding roughly to the structure in circle 9 of FIG. 8. (In some embodiments, the piezoelectric material 855 is coated with a coating, thereby establishing the piezoelectric component. In some alternate embodiments, the piezoelectric material has no coating. Hereinafter, any use of the phrase piezoelectric material corresponds to a disclosure of piezoelectric material with coating, and thus a disclosure of a piezoelectric component, as well as a disclosure of a piezoelectric material without a coating (which still can be a piezoelectric component—there is just no coating), unless otherwise specified.) The piezoelectric component 855 is connected to the core 859 by a support assembly 987. One portion of the assembly 987 is fixed relative to the core 859 and does not move, while another portion of the assembly 987 moves relative to the core, the movement providing the shock protection according to embodiments herein.

Support assembly 987 is made up of static spring subassembly support 940 which is fixed relative to the core 859/the housing (and this could be, in an alternate embodiment, monolithic with the core, as opposed to a separate component as shown-more on this below), and dynamic spring subassembly support 950 which moves relative to the core, but is fixed relative to the piezoelectric component 855. The piezoelectric component 855 is adhesively bonded to the support 950 for example, or attached by any regime that can have utilitarian value. Assembly 987 further includes spring subassembly that includes spring 910 and spring plates 964 and 962. With reference to FIG. 9, spring plate 964 provides flat and structurally rigid surfaces that interface with surfaces 942 and 952 on the bottom, and spring 910 on the top. Spring plate 962 provides flat and structurally rigid surfaces that interface with spring 910 on the bottom, and ball 930 on the top.

The piezoelectric component 855 is configured so that the bending portion is located beyond/outboard the outer boundaries of the dynamic spring subassembly support 950. In an exemplary embodiment, as measured from the longitudinal axis of the implantable subcomponent 999, more than or less than and/or equal to 10%, 15%, 20%, 25%, 30%, 35%, 40%, 45%, 50%, 55%, 60%, 65%, 70%, 75%, 80% or more, or any value or range of values therebetween in 0.1% increments (22.3% to 34.2%, 25.7%, etc.) of the distance to the end of the piezoelectric component 855 (the most outboard portion) is a portion that does not bend or flex or move when exposed to electricity. It is noted that the phrase piezoelectric component as used herein includes both the portion that flexes or otherwise moves when exposed to electricity, as well as the portion thereof that does not flex or otherwise move when exposed to electricity.

In an exemplary embodiment, as will be described in greater detail below, the assembly 987 provides shock-proofing to the implantable subcomponent 851. As will be described in greater detail below, the assembly 987 permits the entire piezoelectric component 855 to move upwards and/or downwards (including the most inboard portions thereof, that would normally be fixed to the housing to react against actuation of the piezoelectric component) when subjected to a high acceleration and/or a high deceleration. The countermass also moves. This is as opposed to the scenario where only a portion of the piezoelectric component moves when exposed to these high accelerations/decelerations. In this regard, the combination of the piezoelectric component and the counterweight creates a transducer-seismic mass assembly. In an exemplary embodiment, the assembly 987 permits the entire transducer-seismic mass assembly to move upwards and/or downwards when subjected to a high acceleration and/or a high deceleration. Again, this is as opposed to a scenario where only a portion of that transducer-seismic mass assembly moves.

Hereinafter, the configuration utilizing apparatuses to allow the piezoelectric component to move when subjected to an acceleration and/or deceleration is sometimes referred to herein for purposes of linguistic economy as a shock-proof assembly 987.

While the spring 910 is depicted as a coil spring, as will be seen below, in some exemplary embodiments, other types of springs can be utilized, such as leaf springs and bevel springs.

Ball 930 is, in some embodiments, a steel ball, or an iron ball, or a titanium ball. Glass balls could be used, depending on some embodiments. Aluminum could be used depending on the desired hardness. Ball 930 is rigid. During normal operation, or more accurately, when the support 950 is in the normal position for normal operation, as seen in FIG. 9 (a non-shock state—the implant operating in a 1 G environment/or even if there is some acceleration and/or deceleration (owing to activity of the recipient) a 1 G plus or minus 0.3 G environment, for example)) the vibrations produced by actuation of the piezoelectric component are conducted to dynamic spring subassembly support 950 (where the piezoelectric component is rigidly attached to the support 950, which is then conducted from the support 950 to the ball 930, and then from the ball 930 to the support 940, and then to the core 859 and then to the bone (or to the bone fixture) to which the core 859 is connected. This will be described in greater detail below.

FIG. 9A depicts a cross-sectional view of a portion of the implantable component taken through the center of the ball 930, which view is perpendicular to the longitudinal axis 999. As seen, there are sections of support subcomponents 950 and 940. Subcomponents 940 are rigidly connected to the core 859 and/or the bottom of the housing, so as to achieve the static feature thereof. Support subcomponents 950 are free to move relative to the supports 940. In between can be seen plates 962 over which is superimposed the balls 930. This shows an example of an individual support subcomponents for each ball. In contrast, FIG. 9B shows a monolithic support subcomponent 950 and a monolithic support subcomponent 940 that is monolithic with the core 859. That said, in an alternate embodiment, the support subcomponent 940 that is monolithic for all of the balls 930 can be fitted around the core and otherwise attached to the core (e.g., by an interference fit for example).

One or both of the surrounding support subcomponents can be made of the above noted materials for the balls (the materials need not be the same as the ball and/or the same for both subcomponents). In an embodiment, the material of the subcomponents will have the same hardness as the balls. In an embodiment, the material of one or both support subcomponents has a hardness that is 50, 60, 70, 80, 90, 100, 110, 120, 130, 140, 150, 160, 170, 180, 190, 200% or more (or less) or any value or range of values therebetween in 1% increments than that of the ball(s). (And harnesses need not be the same in both support components.)

And note that the hardness of the various balls can be different between each ball. The hardness can vary from 50, 60, 70, 80, 90 or 100% or any value or range of values therebetween in 1% increments from the hardest ball.

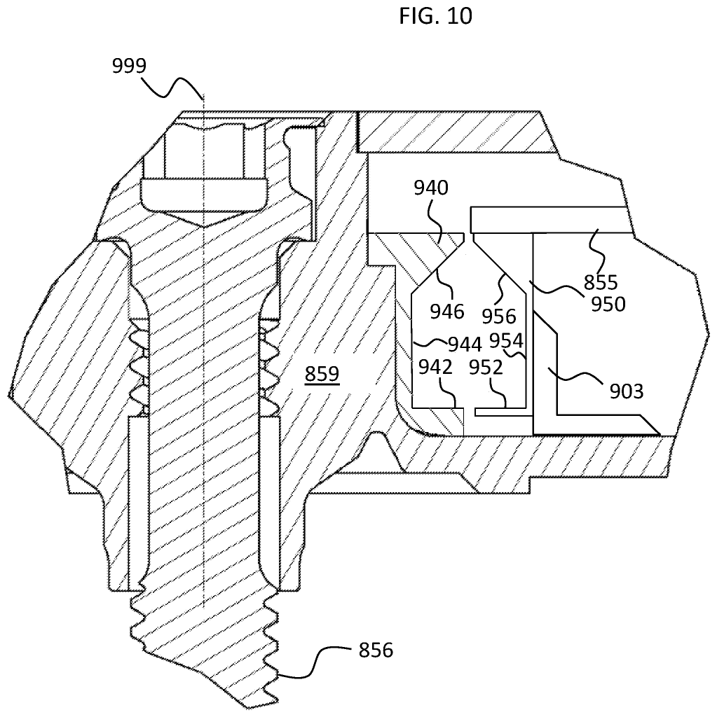

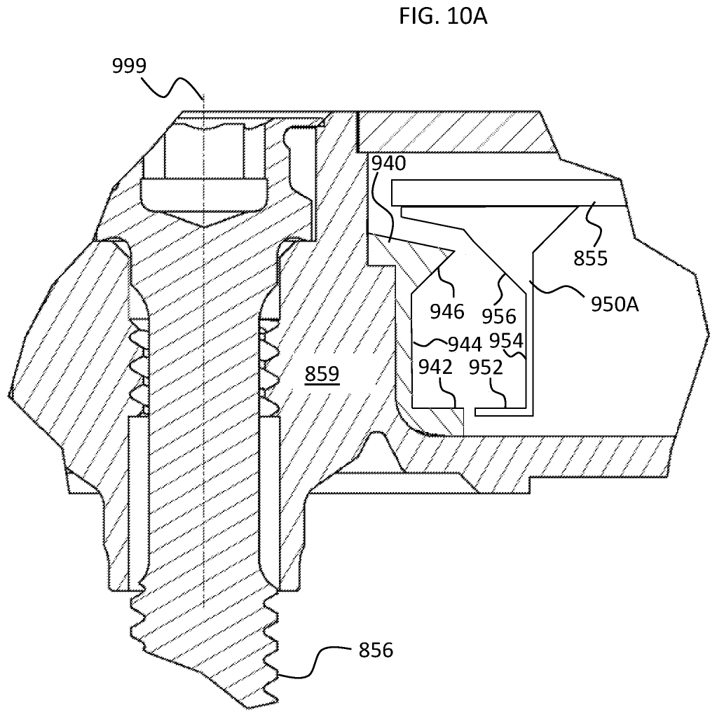

And it is briefly noted that the embodiment of FIG. 10 shows a cross-section without backdrops. In some embodiments, the surfaces 956 and 954 and/or the surfaces 946 and 944 can be curved or flat. FIGS. 9A and 9B show curved surfaces, but, the cross-section of FIG. 10 can be such that the surfaces extend into and out of the plane of the figure linearly (at least until the surface ends, such as ending at a place where the surface then extends parallel to the plane of FIG. 10). An embodiment of this is seen in FIG. 9C. Here, this presents a composite device where the inboard support subassembly 940A has a rectangular cross-section but the outboard support subassembly 950 remains as disclosed above. Conversely, there can be seen an outboard support subassembly 950A that has a rectangular cross-section but the inboard subassembly 940 is still used. In some embodiments, subassembly 940A can be used in combination with subassembly 950A to establish a support assembly 987. Moreover, the embodiment of FIG. 9 also shows how a support subassembly 940 can have point contact with the ball 930 even though support subassembly 940 has a curved cross-section. If the radius of curvature of the support 940 is larger than the radius of curvature of the ball (or if the radius of curvature of the support is smaller than the radius of curvature of the ball) point contact can be achieved. This can also be the case with respect to the surfaces 946 and 956 albeit depending on how those surfaces are arranged (the surfaces can be part of a cone (interior of a cone) or part of a hemispherical body, or a curved body), line contact and/or point contact can be achieved, especially if different radiuses of curvature relative to the ball 930 are utilized for those surfaces.

And it is also noted that surface to surface contact can be achieved (as opposed to point or line) between the ball and the supports, such as where the radiuses of curvatures of the ball and the surfaces are the same. This would be curved surface to curved surface contact. Moreover, cylindrical rollers or conical rollers can be used in some embodiments. Here, the balls shown in the figures would instead be cross-sections of cylinders, and the support assemblies would be linear into and out of the page to accommodate the cylinders.

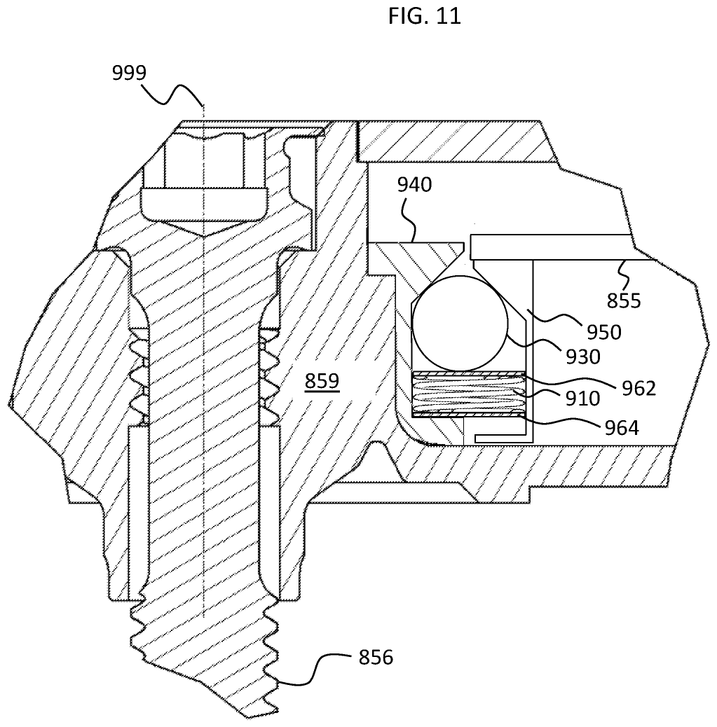

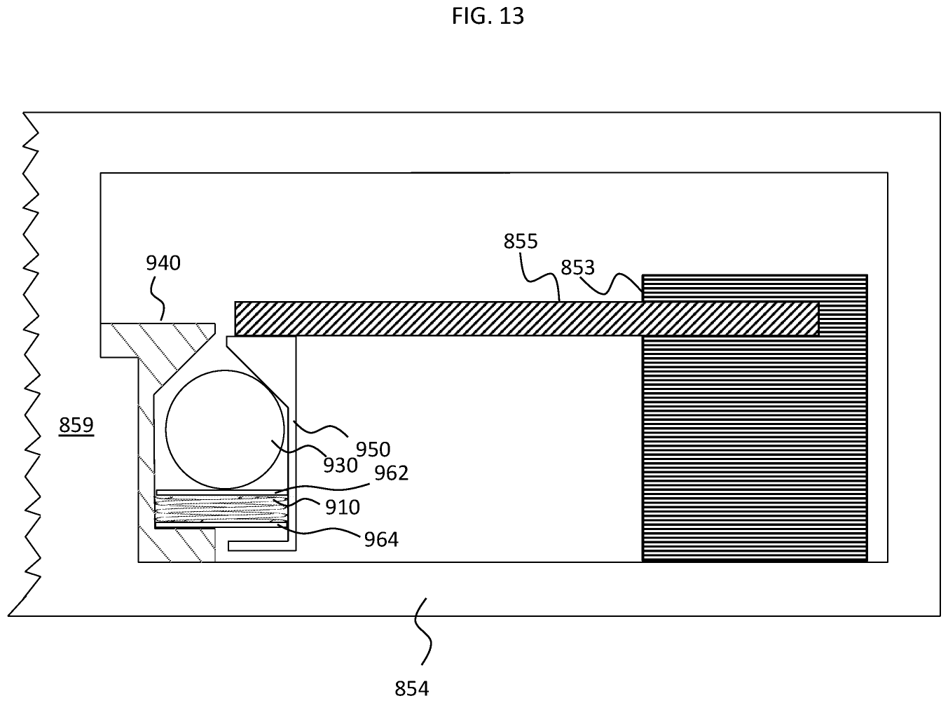

FIGS. 11-14 depict an exemplary principle of operation of the shock-proof assembly of the embodiment of FIG. 8, with some of the components shown in quasi-functional terms/black box format (e.g., the counterweight 853). As can be seen, in this exemplary embodiment, the transducer-seismic mass assembly in general, and the piezoelectric component 855 in particular, has moved from the position present in the state depicted in FIGS. 8 and 9 to the state depicted in FIG. 10 or in FIG. 13. It is briefly noted that in the embodiment of FIG. 10, the support 950 bottoms out on the housing wall 854, but in FIG. 13, the support 950 does not bottom out on the housing wall. In the embodiment of FIG. 10, the counter mass 853 can also bottom out on the bottom of the housing wall 854. This can have utilitarian value with respect to obtaining a symmetric force distribution on the ends of the piezoelectric component 855. That is, when both the support 950 and the counter mass 853 bottom out, there is little to no bending moment on the piezoelectric element 855. That said, because the inertia of the support 950 is relatively low compared to the inertia of the counter mass 853, if the support 950 does not bottom out, there is still at least in some embodiments a significantly low enough bending moment on the piezoelectric component 855 to avoid damage thereto.

In some embodiments, neither the support 950 nor the counter mass 853 bottoms out against the housing. In these embodiments, the fact that the piezoelectric component 855 is spring mounted by spring 910 is sufficient enough to reduce the overall bending moment on the piezoelectric component to avoid or otherwise at least sufficiently reduce the possibility of failure. And of course, it is to be understood that not all accelerations will cause bottoming out even if the device is arranged to bottom out. In an exemplary embodiment that avoids bottoming out, the spring 910 could be sized and dimensioned so that the spring collapses to its most collapsed state possible, stopping further movement of the support 950 in the downward direction.

In an exemplary embodiment, the state depicted in FIGS. 8 and 9 are referred to herein as the first mechanical state of the implantable subcomponent, and the state depicted in FIGS. 11 and/or 13 is referred to herein as the second mechanical state of the implantable subcomponent. With respect to FIGS. 11 and 13, in this exemplary embodiment, the implantable subcomponent has been subjected to an upward acceleration or a downward deceleration (upward acceleration means that it has a velocity component upward which is increasing per second, and downward deceleration means that it has a velocity component downward which is decreasing per second). By way of example only and not by way of limitation, the second mechanical state depicted in FIGS. 11 and/or 13 can be that which exists when the implantable subcomponent is dropped from a height of one meter or so in a one G environment at the time that it contacts a concrete floor or the like. In this regard, the bottom of the housing 854 will strike the floor, and thus will stop further movement of the housing downwards towards the center of the earth. This will stop suddenly, as concrete tends to be a material that has poor shock absorption properties. The resulting deceleration could be 10, 20, 30, 40, 50, 60, 70, 80, 90, 100, 125, 150, 175, 200, 225, 250, 275, 300, 350, 400, 450, or 500 or more Gs. By way of example only and not by way of limitation, with respect to a 5, 6, 7, 8, 9, 10, 11, 12, 13, 14, 15 or more gram counterweight 853, 10, 11, 12, 13, 14, 15, 16, 17, 18, 19, 20, 21, 22, 23, 24, 25, 26, 27, 28, 29 or 30 or more Newtons of downward force could be experienced at the center of mass of the counterweight 853, and thus the outer ends of the piezoelectric component 855. In a scenario where the piezoelectric component 855 was hard or rigidly mounted to the core 859, this could be bad. In this regard, the failure mode detailed above with respect to the piezoelectric material bending as seen in FIG. 7 could occur. This could break the relatively brittle piezoelectric material and/or plastically deform the piezoelectric material. This can be considered to be not as utilitarian as that which would be the case if the piezoelectric material did not break.

However, because the piezoelectric component 855 is not hard mounted or rigidly mounted to the core 859, or hard mounted or rigidly mounted directly or indirectly to the housing for that matter, but instead is mounted in a manner such that the piezoelectric component can move relative to the housing, the forces imparted on to the counterweight 853, which forces are transferred to the piezoelectric component 855, results in the piezoelectric component 855 moving downward upon those forces resulting in forces at the spring 910 being greater than the compression force of the spring in the first mechanical state of FIG. 8. In the embodiment depicted in FIG. 11 and FIG. 13, the spring constant of the spring 910 is such that the forces imparted onto spring 910 in the deceleration scenario just described above are sufficient to compress the spring as shown in a manner that results in the counterweight 853 striking the bottom of the housing 854. In this exemplary embodiment, this stops any substantial further motion of the piezoelectric component 855 (there can be some further movement of the inboard portions of the piezoelectric component 855 (e.g., most prominently, the portions of the piezoelectric component 855 that face the core 859, at least in some embodiments), owing to the fact that the inboard portions are still free to move downward in the embodiment of FIG. 13, subject to the counterforce of the spring 910, but this downward movement is negligible with respect to preserving the structural integrity of the piezoelectric component 855). In essence, the piezoelectric component floats inside the housing.

As is to be understood from the figures, in an exemplary embodiment, the piezoelectric component 855 is free to move along the core 859. In an exemplary embodiment, the piezoelectric component 855 can be slip fit around the core 859 (looking from above, the piezoelectric component 855 is in the form of a non-square rectangle with a hole at the geometric center thereof, through which the core 859 extends). In an exemplary embodiment, the piezoelectric material 855 is offset from the core 859. In an exemplary embodiment, this offset can be about 0.05 mm, 0.075 mm, 0.1 mm, 0.15 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, or 1.5 mm (on any one side or all sides, can be an average space when taken about the circumference of the core 859, can be a total gap of the inner diameter of the hole through the piezoelectric component and the outer diameter of the core 859 when at the first mechanical state-all of these aforementioned values are in the first mechanical state-etc.) or any value or range of values therebetween in 0.001 mm increments. The point is, in an exemplary embodiment, the piezoelectric component 855 is configured to move relative to the housing 854 in general, and the core 859 in particular. It is also noted that in an exemplary embodiment, the aforementioned values can also be applicable to a bushing or the like that is interposed between the piezoelectric component 855 and the core 859. Any arrangement that will enable the piezoelectric component 855 to move according to the teachings detailed herein and/or variations thereof can be utilized in at least some exemplary embodiments.

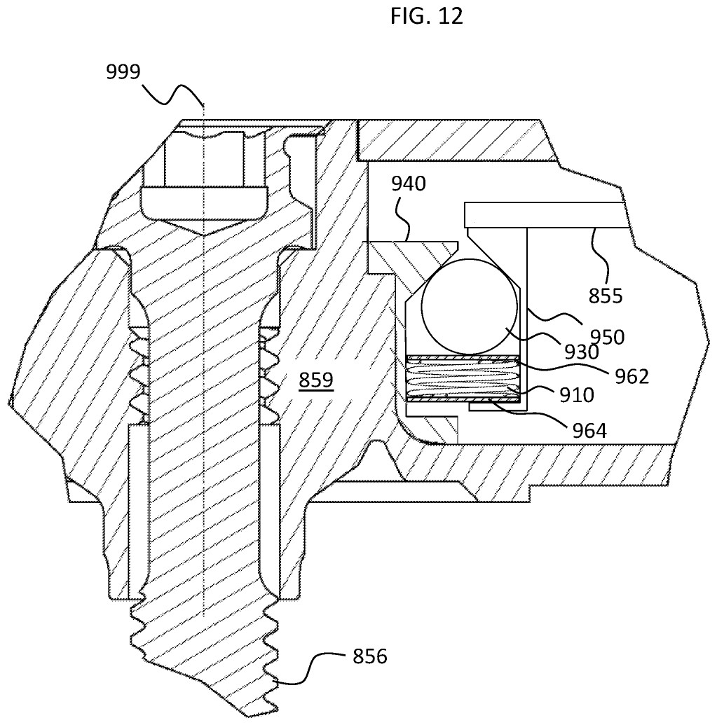

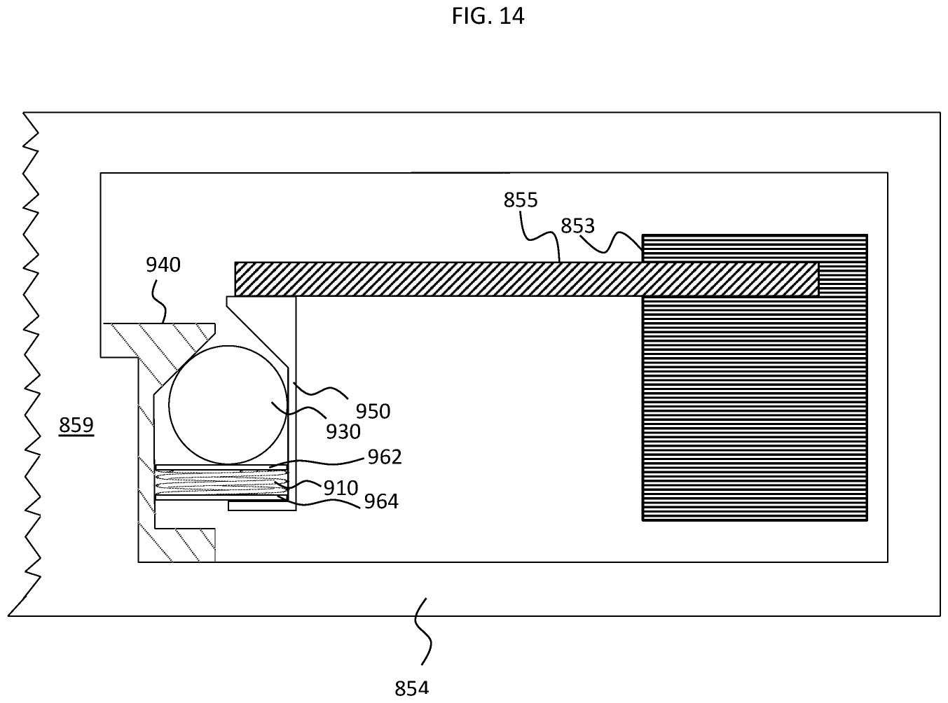

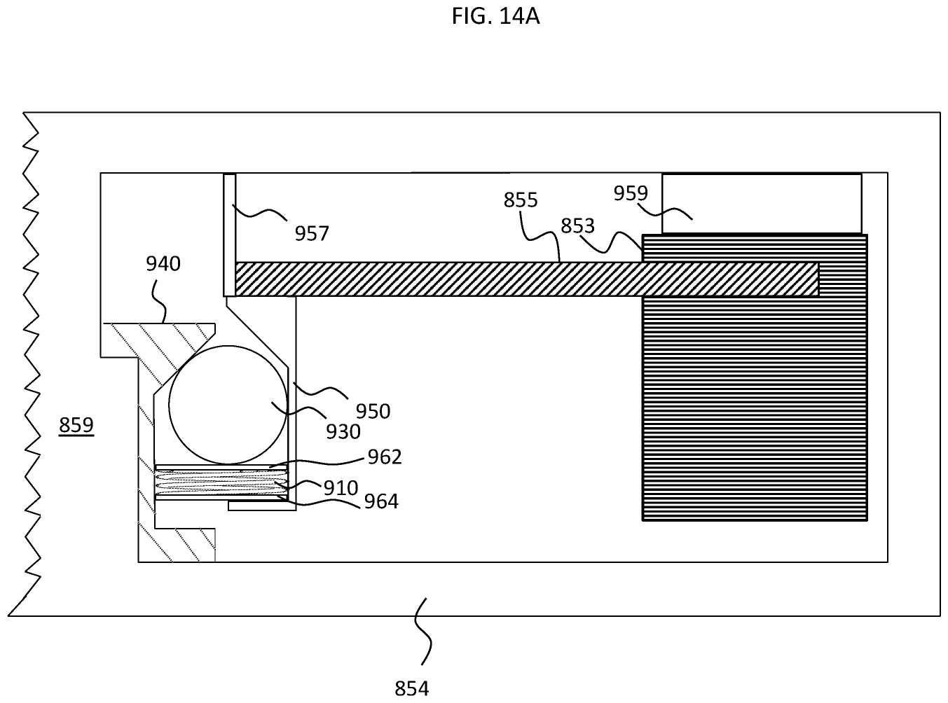

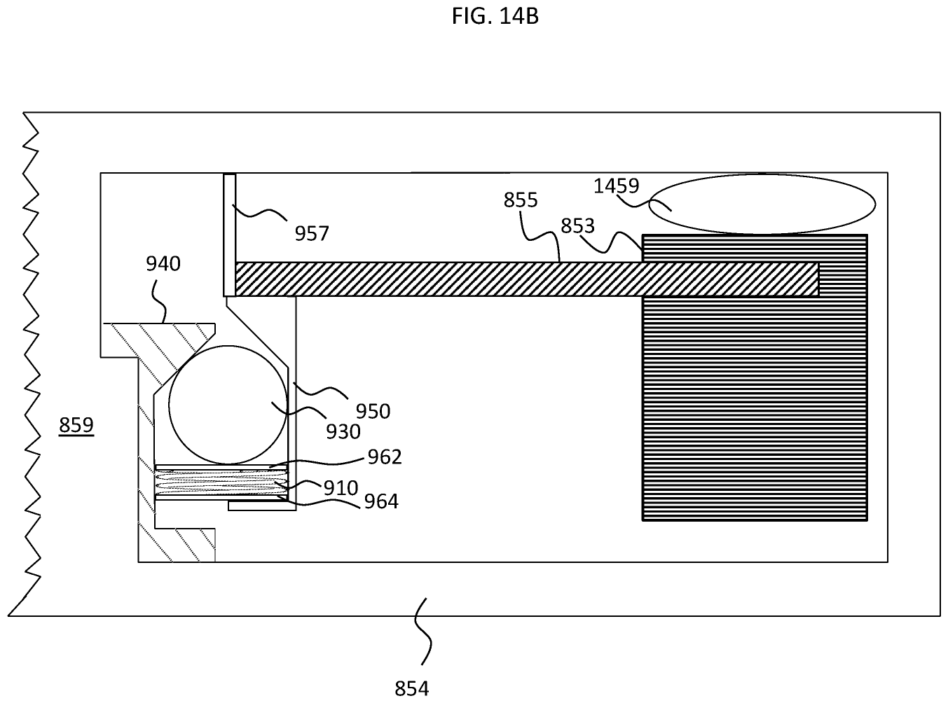

FIGS. 12 and 14 depict an exemplary principle of operation of the shock-proof assembly of the embodiment of FIG. 8. As can be seen, in this exemplary embodiment, the transducer-seismic mass assembly in general, and the piezoelectric component 855 in particular, has moved from the position present in the state depicted in FIGS. 8 and 9 to the state depicted in FIGS. 12 and/or 14. In an exemplary embodiment, the state depicted in FIGS. 12 and/or 14 is referred to herein as the third mechanical state of the implantable subcomponent. With respect to FIG. 12 and FIG. 14, in this exemplary embodiment, the implantable subcomponent has been subjected to a downward acceleration or an upward deceleration. By way of example only and not by way of limitation, the third mechanical state depicted in FIG. 12 and FIG. 14 can be that which exists when the implantable subcomponent is dropped upside down from a height of one meter or so in a one G environment at the time that it contacts a concrete floor or the like. In this regard, the top of the housing 854 will strike the floor, and thus will stop further movement of the housing downwards towards the center of the earth. This will stop suddenly, as concrete tends to be a material that has poor shock absorption properties. The resulting deceleration can be those detailed above. By way of example only and not by way of limitation, with respect to the above values for the counterweight 853, where the above downward forces are experienced through the center of mass of the counterweight experienced at the center of mass of the counterweight 853, and thus the outer ends of the piezoelectric component 855. However (and the following discussion will be directed, for simplicity, to a scenario where the implantable subcomponent is right side up, and somehow experiences an upward deceleration or a downward acceleration sufficient to move the transducer-counterweight assembly) in an exemplary scenario of the upward deceleration scenario could be a scenario associated with horseplay where the implantable component is thrown upwards and the top of the housing strikes a ceiling made of concrete-such an exemplary scenario could happen in a scenario where the teachings detailed herein are utilized for an external component of a passive transcutaneous bone conduction device, because the piezoelectric component 855 is not hard mounted or rigidly mounted to the core 859, or hard mounted or rigidly mounted directly or indirectly to the housing for that matter, but instead is mounted in a manner such that the piezoelectric component can move relative to the housing, the forces imparted onto the counterweight 853, which forces are transferred to the piezoelectric component 855, results in the piezoelectric component 855 moving upward upon those forces resulting in forces at the spring 910 being greater than the compression force of the spring in the first mechanical state of FIG. 8. In the embodiment depicted in FIGS. 12 and/or 14, the spring constant of the spring 910 is such that the forces imparted onto spring 910 in the deceleration scenario (an upward velocity component that reduces per second) sufficient to compress the spring 910 as shown in a manner that results in the counterweight 853 moving upwards with the entire piezoelectric component 855, thus preventing the over stressing of the piezoelectric component that could result in the failure mode detailed above.

The embodiment of FIG. 12 and FIG. 14 depicts the counterweight 853 stopping or otherwise halting with respect to upward movement relative to the housing prior to contacting the housing 854. Accordingly, it is noted that in at least some exemplary embodiments, utilitarian shock-proof features detailed herein can be utilized without the counterweight 853 striking the housing 854. That said, it is to be understood that in at least some exemplary embodiments, there can be a deceleration and/or an acceleration scenario where the counterweight 853 strikes the inside of the housing 854, thus further compressing spring 910 beyond that which is depicted in FIGS. 12 and/or 14. As will be understood from the relative locations of the components of FIGS. 11 and/or 14, it can be seen that the bottom of the piezoelectric component 855 rises above the top of the support 940. In an exemplary embodiment, this could induce another type of failure mode in that the piezoelectric component 855 could get hung up on the shoulder 940, thus preventing the piezoelectric component 855 from returning to the first mechanical state of FIGS. 8 and 9. Accordingly, in some embodiments, spacers are utilized to obtain the bottoming out in the upward direction. In this regard, FIG. 14A shows a spacer 957 connected to the support 950, which strikes the top portion of housing wall 854, and spacer 959 located on the top of seismic mass 853, which strikes the top of the housing wall 854, all upon sufficient upward movement of the transducer-seismic mass assembly. Here, the mass of the spacers can be sufficiently low so as to reduce the inertia associated there with or otherwise keep the inertia associated there with within utilitarian limits. For example, the seismic mass would be positioned and sized to achieve a certain force output. It thus could be that the seismic mass cannot be extended upwards and/or downwards by more than a certain amount. Thus, the utilization of a lighter mass material, which can be a polymer or can be an aluminum structure, to make the spacer and/or the utilization of a composite structure to achieve lightweight strength, and/or the utilization of a hollow structure to establish the spacer can utilize at least some exemplary embodiments providing that the spacer is sufficiently strong to achieve utilitarian value with respect to bottoming out the transducer-seismic mass assembly without creating too much inertia that would detract from the performance of the implantable component (or external component in the case of a passive transcutaneous bone conduction device and/or a percutaneous bone conduction device-any reference to one corresponds to a reference to any of the other herein unless otherwise noted providing that the art enables such).

Alternatively, or in addition to this, stops can be included as part of the housing 854 (e.g., dimples formed in the upper and/or lower shell). Such exemplary stops would stop further upward movement of the counterweight 853. Thus, in a scenario where sufficient upward deceleration exists, there can be a scenario that results in the counterweight 853 striking the stops and thus housing 854 when stops are an integral part thereof (they can be monolithic and/or attached to the housing as separate components (consider the spacer attached to the housing instead of attached to the counterweight). In this exemplary embodiment, this stops any substantial further motion of the piezoelectric component 855 (there will be some further movement of the inboard portions of the piezoelectric component 855 (e.g., most prominently, the portions of the piezoelectric component 855 that face the core 859, at least in some embodiments, if there is no inboard stop—but in some embodiments, the inboard stop can also be attached to the housing/can be integral with the housing wall), owing to the fact that the inboard portions are still free to move upward, subject to the counterforce of the spring 910, but this upward movement is negligible with respect to preserving the structural integrity of the piezoelectric component 855).

Briefly, FIG. 10A shows an alternate support subassembly 950A that has a more extensive top surface to provide additional bonding surface with the piezoelectric component 950A. As seen, embodiments include the piezoelectric component extending inboard of the support subassembly 940, but in an overlapping fashion.

FIG. 14B depicts an alternate exemplary embodiment where the shockproof according to the exemplary embodiment of FIG. 8 is combined with a damping component 1459. In an exemplary embodiment, damping component 1459 is a silicone gel component that extends from the inside of the housing to the upper surface of the counterweight 853 (the schematic of FIG. 14B is the implantable subcomponent in the third mechanical state, and thus the damping component 1459 is depicted in its compressed state). In some exemplary embodiments, such a damping component is located in between the bottom of the counterweight 853 and the housing 854 as well. In an exemplary embodiment, the damping component(s) can be configured such that they are adhered to both the housing and the counterweight. In an alternate embodiment, the damping component can be adhered to only one of the housing and the counterweight, where contact between the other and the damping component occurs upon sufficient movement of the counterweight relative to the housing. Any arrangement that can enable damping according to the teachings detailed herein can be utilized in at least some exemplary embodiments. In the embodiment of FIG. 14B, the damping component is also configured to limit the upward travel of the counterweight 853. In this regard, in an exemplary embodiment, the damping component 1459 can be configured so as to compress no more than a certain amount when exposed to sufficiently high deceleration, beyond which sufficiently high deceleration, other failure modes would occur (e.g., other than the failure mode where the piezoelectric material breaks). Alternatively, the damping component 1459 can be combined with the stops of FIG. 12.

In an exemplary embodiment, the damping component 1459 can correspond to one or more of the embodiments detailed in U.S. patent application Ser. No. 14/555,899, entitled Medical Device Having An Impulse Force-Resistant Component, filed Nov. 28, 2014, listing Wim Bervoets as an inventor. In an exemplary embodiment, the effective “damping” can be reduced relative to that which is the case in the absence of the teachings detailed herein vis-à-vis enabling the piezoelectric component 855 to move relative to the housing.

To be clear, while the stop and the dampener component have been depicted as present on the top of the implantable subcomponent, in an alternate embodiment, the stop and/or the damper can be located on the bottom (and such component can be located at both places).

In some embodiments, the height of the counterweight 853 can be high enough to achieve the bottoming out on the housing without the need of a spacer for example.

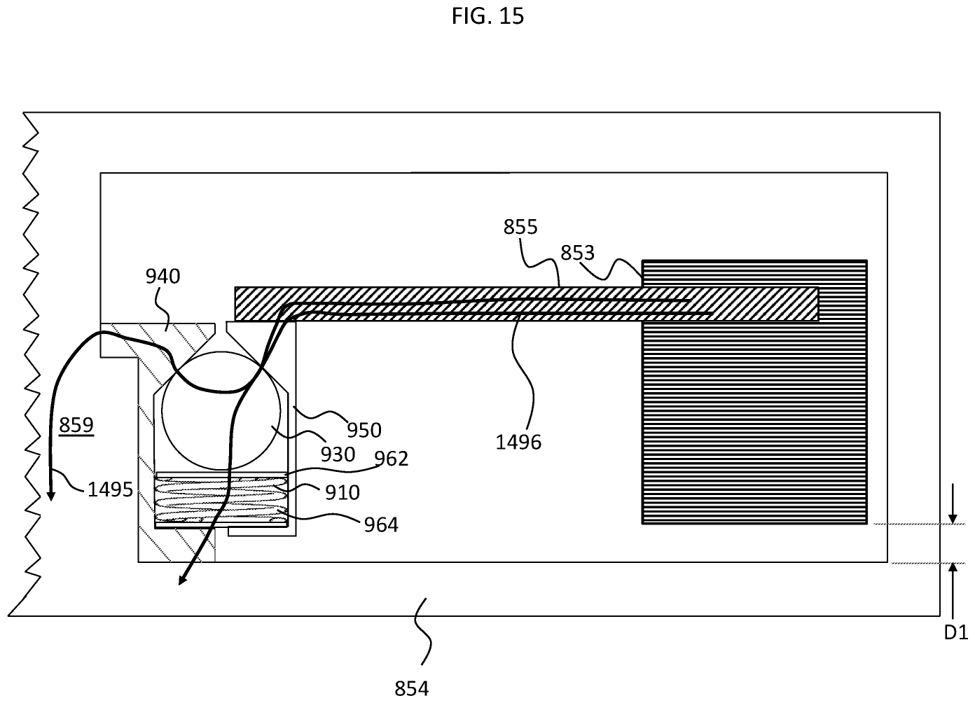

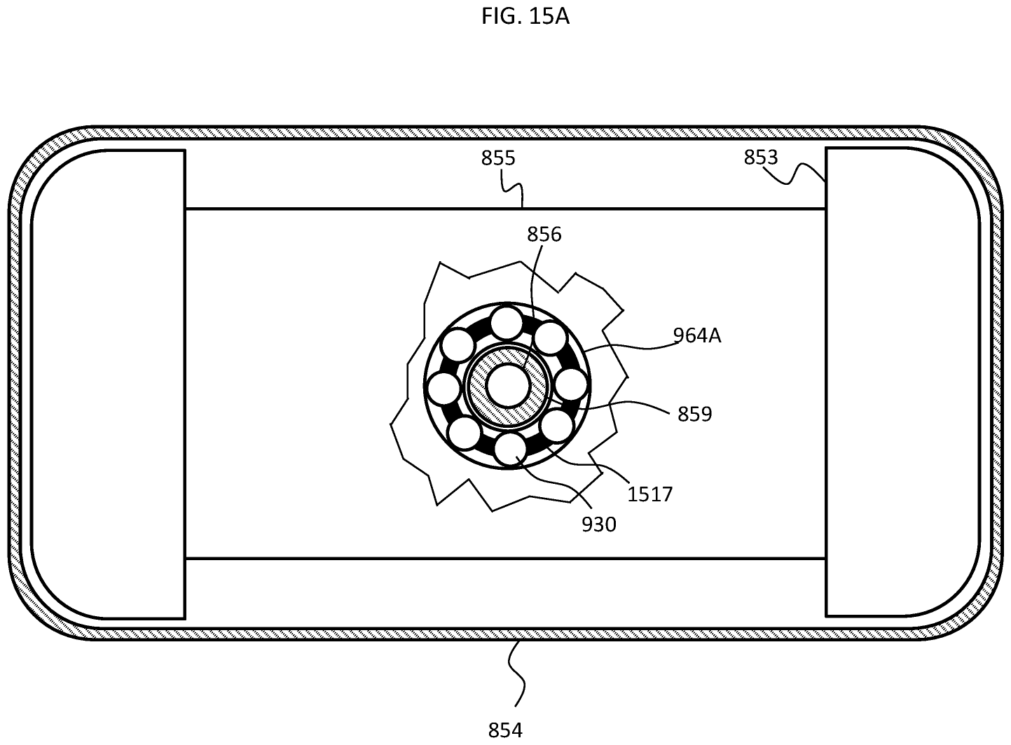

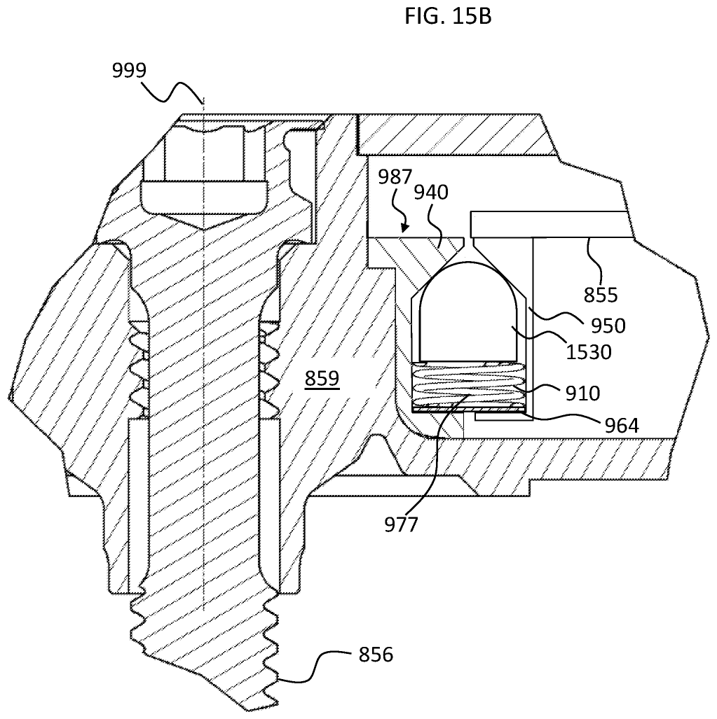

The view of FIG. 9 shows only one of the assemblies 987. In at least some exemplary embodiments, a plurality of assemblies 987 are evenly arrayed about the core 859. In an exemplary embodiment, there are two or three or four or five or six or seven or eight or nine or 10 or 11 or 12 or more assemblies 987 or any value or range of values therebetween in one increments arrayed about the core 859. That said, in an exemplary embodiment, the supports are respectively part of an overall structure that extends about the core 859 in a manner analogous to the inner race and an outer race of a ball bearing assembly. Briefly, as seen in FIG. 15A, which shows a cross-sectional view of the implantable component 851 looking downward, with a break in the piezoelectric component 855 to show the components underneath, where the supports 949 and 950 are not shown for purposes of clarity, it can be seen that there are eight balls 930 arrayed about the core 859, the balls being maintained spatially separate from each other via a cage 1517. The cage 1517 permits the balls to rotate although it is noted that in some embodiments, the balls need not rotate, and in some embodiments, element 1517 can be a plurality of tubes or pieces of metal that are each separately welded or otherwise adhered to each ball. In an exemplary embodiment, element 1517 can be a ring that extends through each ball. Again, in some embodiments, the balls need not rotate. Any device, system, and/or method that can enable the balls to be positioned about the longitudinal axis so that they do not become asymmetrically positioned can be utilized in at least some exemplary embodiments. Moreover, in some embodiments, a dense pack can be utilized, where each ball contacts each other, thus holding the balls in place. This can have utilitarian value with respect to embodiments where the balls do not move in the lateral direction. (It is noted that some embodiments of the cage permit the balls to move in the lateral direction the balls need not be perfectly symmetrically arrayed about the core in at least some exemplary embodiments. It can be enough that the balls are maintained within respective relatively limited areas in which the balls can move a certain amount, providing that those areas are symmetrically arrayed about the core.

Still with respect to FIG. 15A, element 964A corresponds in functionality to the plate 962 detailed above, but here, element 962A is a circular plate with a circular hole therethrough, which hole extends about the core 858. There is a similarly situated plate above the balls 930 (not shown) which corresponds in functionality to the plate 962. Because of the unitary arrangement of the assembly 987, where there is just a single support 940 and a single support 950, for example, there can also be a single bottom plate and a single top plate, the functionalities of these plates corresponding to the plates detailed above. That said, in an alternate embodiment, the respective plates can be connected to one another, such as by respective beams that extend outboard away from the plates to an outer ring that extends about support(s) 950. Indeed, in an exemplary embodiment, the plates can be stamped from a single sheet of metal, where the plates are analogous to inwardly pointing fingers.

In an exemplary embodiment, there can be an equal number of springs 910 as the number of balls 930 while in other embodiments, there can be more or fewer springs than the number of balls 930. In an exemplary embodiment, there are two, three, four, five, six, seven, eight, nine, 10, 11, 12, or more helical springs, or any value or range of those therebetween in one spring increments. Moreover, in some embodiments, such as where a bevel spring is utilized, there may be only a single spring. Indeed, the utilization of a single assembly 987 can enable the use of a single spring that is a helical spring. In this regard, in an exemplary embodiment, a single helical spring can extend about the core 859. That said, in an exemplary embodiment, multiple bevel springs can be utilized as well. Any type of spring arrangement that can enable the teachings detailed herein can be utilized in at least some exemplary embodiments.

Still, in some embodiments, there are a plurality of assemblies 987 that are arrayed about the core 859. In an exemplary embodiment, the balls 930 shown in FIG. 15A can represent the positions of the respective assemblies 987. Thus, in this exemplary embodiment, there would be eight separate assemblies 987 arrayed as shown, and thus there would be eight plates 962 and 964, and eight supports 940 and eight supports 950, and eight springs 910, etc. Each separate support 950 would be separately connected to the piezoelectric component 855 (as opposed to the embodiment of FIG. 15A, where the single outer support would be connected to the piezoelectric component 855).

With reference to FIGS. 9 and 10, shoulders/surfaces 942 and 952 carry the plate 964 during normal operation, the first mechanical state. Shoulder/surfaces 942 also stops the plate 964 from traveling downward past that surface as can be seen in FIG. 11, even though surface/shoulder 952 travels further down below surface/shoulder 942. In an exemplary embodiment, the assembly 987 is sized and dimensioned so that the plates are held for the most part in the parallel orientation or otherwise in an orientation extending normal to the direction of the longitudinal axis 999. This can be achieved by tolerancing the support 940 relative to the support 950 so that the structure thereof holds the plates in the utilitarian orientation. While the embodiment shown utilizes flat plates, in another exemplary embodiment, the plates can be cups or hollow cylinders with one end open where the openings face each other, and the spring 910 can be located inside those hollow cylinders (providing there is sufficient clearance with respect to the ends of the cylinders to enable the spring 9102 compress to an amount that is utilitarian—in some embodiments, the ends of the cylinders can be utilized as a bottoming out feature where the ends of the cylinders strike each other upon sufficient compression of the spring).

It is noted that in some embodiments, the spring 910 can be attached in a rigid manner to the plates 962 and/or 964. This can aid in keeping the plates sufficiently parallel or otherwise sufficiently aligned with the various shoulders to enable operation of the shock proofing in a utilitarian manner.

It is briefly noted that the utilitarian value of utilizing a single plate 964A (and a single plate above plate 964A) for example exists because the plate will balance itself out because the plate extends about the core 859. That is, there will be no moment on one side of the plate that is not counteracted by a moment on the opposite side of the plate.

As noted above, in some embodiments, there are two springs 910 and two balls 930 located on either side of the core 859 (and the respective components). For purposes of linguistic economy, reference will be made to only one spring and one ball and two plates and two supports on one side-all references to one spring etc. on one side correspond to references to the other springs on the other side unless otherwise specified. And also, any reference to a given assembly 987 corresponds to a disclosure of such with regard to the other embodiments of the assemblies 987 detailed herein unless otherwise noted providing that the art enables such.

As seen in FIGS. 11 and 12, when the devices are in the second mechanical state and the third mechanical state, the spring 910 is compressed relative to that which is the case in the first mechanical state. That is, the spring 910 always compresses relative to that which is the case in the first mechanical state when the given accelerations that move the entire transducer-seismic mass assembly exist. It is briefly noted that in at least some exemplary embodiments, the spring is always under compression even in the first mechanical state. It is that the spring becomes more compressed when the transducer-seismic mass assembly moves, regardless of direction. This is because the principle of operation is such that the angled surfaces 946 and 956 prevent upward movement of the ball 930 by an equal amount of the movement of surface 952 (the ball 930 moves less). Corollary to this is that surface 942 prevents the plate 962 from moving downward beyond surface 942, and thus downward movement of the ball 930 owing to downward movement of the transducer-seismic mass assembly compresses the spring.

In an embodiment, the spring is in its relaxed state in the first mechanical state. That said, in an embodiment, the spring is also compressed in a first mechanical state. In an embodiment, there is a mechanical component that prevents the spring from extending to its relaxed state in the first mechanical state. By way of example only and not by way of limitation, there can be a rod 977 that extends from plate 962 downward through a hole in plate 964, which hole is dimensioned larger than the rod so that the rod can freely move in the longitudinal direction thereof within the hole (and/or the plate 964 can move relative to the rod). On the side of plate 964 opposite plate 962, there can be a nut 979 or washer nut combination or some other component that is sized and dimensioned larger than the hole that prevents the bolts (or more accurately, the component) from pulling through the hole. When the top plate 962 is moved towards the bottom plate 964, such as when the devices are in the second mechanical state, the rod extends through the hole in plate 964 and moves in a one-to-one manner with the plate 962. Conversely, when the plate 964 moves upward to reach the third mechanical state, the plate 964 moves over the rod upward towards plate 962 thus, the plate can slide along the rod or vice versa. But because there is a nut or other component on one end of the rod, the most that the plates can move is the distance of the rod as limited by the nut, thus keeping the spring in compression. This can enable the precise positioning of the transducer-seismic mass assembly irrespective of the relaxed position of the spring (for the most part).

Moreover, this can enable a range of limited G forces that will not result in movement of the transducer-seismic mass assembly from the location is positioned in in the first mechanical state. More specifically, consider a scenario where there is downward force on spring 910 by plate 962 owing to the compression of the spring relative to the relaxed state of spring 910 due to the plate 964 being connected to plate 962 (e.g., by the rod above), where the downward force is constant and limited to that which results from the distance between the two plates being compressed. In an exemplary embodiment, in the first mechanical state, this is F1. F1 equals the force which results from the distance that the spring 910 is compressed from its relaxed state times the k value of the spring (in this exemplary embodiment, spring 910 is a traditional spring where the k value is constant, and the force required to compress the spring increases linearly with increasing compression).

Because the spring is pre-compressed, there are a range of forces in the upward and downward directions that can be experienced by the transducer-seismic mass assembly that will not cause the transducer-seismic mass assembly to move from the first mechanical state. In this regard, if certain limited accelerations never create a force that rises above the value of F2, which corresponds to the force required or otherwise that results from the spring being in its precompressed state, the spring will not further compress and thus the transducer-seismic mass assembly will not translate in its entirety within the housing. But upon experiencing an acceleration and/or deceleration that exceeds that value of F2, where the spring can further compress, the transducer-seismic mass assembly will translate and thus the strap proofing will be implemented. In this exemplary embodiment, the downward force required to further compress the spring can be the same as the upward force required to further compress the spring, because in either scenario of movement of the transducer-seismic mass assembly from the first mechanical state, there will be compression of the spring. Accordingly, in an exemplary embodiment, the amount of upward force required to move the transducer-seismic mass assembly from the first mechanical state is equal to the amount of downward force that is required to move the transducer-seismic mass assembly from the first mechanical state.

The above said, in some embodiments, such as where the angles of the surfaces 946 and 956 are different there can be different force values that initiate movement in the different directions. More on this below.

In view of the above, it can be seen that in some embodiments, there is a piezoelectric based device, such as a prosthetic medical device, or the sensor noted above, all by way of example, comprising a housing, such as housing 854, which can be a hermetically sealed housing, and a piezoelectric component, such as component 855. Here, the piezoelectric component is supported (indirectly in the embodiment of FIG. 9) in the housing via at least one curved element, such as ball(s) 930, which can be a rolling element, which can be a metal sphere, and can be an incompressible element (solid or hollow). That said, FIG. 15B shows an alternate exemplary embodiment where a cylindrical body 1530 with a hemispherical top or a rounded top (akin to a bullet) is substituted for ball 930. In this exemplary embodiment, this could dispense with the top plate 962, although in another exemplary embodiment, the plate could be welded or otherwise adhered to the cylindrical body 1530. It is also noted that in at least some exemplary embodiments, the bottom plate 964 can be dispensed with in that the spring 910 could provide sufficient interface with the support surfaces 942 and 952 respectively indeed, this can also be the case with respect to the top plate, even with the embodiments that utilize the ball, where, for example, the ball can sit partially within the spring or otherwise directly interface with the spring in some embodiments.

Embodiments can utilize balls that have a hardness in the range of 55-65 HRC or any value or range of values therebetween in 1 HRC increments. However, balls that have less or greater hardness can also be used in some embodiments.

Consistent with the teachings detailed above, in at least some exemplary embodiments, the prosthetic medical device is configured to permit the piezoelectric component to move inside the housing beyond that which is due to electricity applied to the piezoelectric component, where, in some embodiments, the electricity is the maximum electricity appliable by the implantable component. In an exemplary embodiment, with respect to the most outboard portions of the piezoelectric component, the amount of movement in the longitudinal direction of the implantable component can be at least 100, 150, 200, 300, 400, 500, 600, 700, 800, 900, 1000, 1500, 2000, 2500, 3000, 4000, 5000%, or more, or any value or range of values therebetween in 1% increments of the amount of movement of that position when the electricity is applied that is the maximum electricity appliable by the implantable component for example.

In an embodiment, the piezoelectric component is also supported in the housing via at least one spring, such as spring 910 and the prosthetic medical device (or whatever device) has a core component about which the piezoelectric component extends, and the piezoelectric component is configured to move along a longitudinal axis of the core as a result of compression of the at least one spring, wherein force that results in the compression is transmitted through the curved element. And in some embodiments, the device is a bone conduction device (active transcutaneous, passive transcutaneous or percutaneous), the piezoelectric component is configured to vibrate in response to a captured sound, and the prosthetic medical device is configured such that at least some of the vibrations generated by the piezoelectric component travel from the piezoelectric component to the core via the curved element.

In some embodiments, the curved element is configured to move in a direction that has a substantial lateral component when the prosthetic medical device experiences a shock, thus providing shock proofing to the piezoelectric element. In an exemplary embodiment, the lateral movement can be, as measured from a center of gravity of the element, at least and/or equal to 5, 6, 7, 8, 9, 10, 11, 12, 13, 14, 15, 20, 25, 30, 35, 40, 50, 60, or 70%, or any value or range of values therebetween in 1% increments of the total movement of the closest portion of the piezoelectric component to the element in the longitudinal direction of the implantable component (in the direction of axis 999). In an exemplary embodiment, the lateral movement of the curved/rolling element can be, as measured from a center of gravity of the element, at least and/or equal to 5, 6, 7, 8, 9, 10, 11, 12, 13, 14, 15, 20, 25, 30, 35, 40, 50, 60, 70, 80, 90, 100, 110, 120, 130, 140, 150, 160, or 170%, or any value or range of values therebetween in 1% increments of the total movement of the element in the longitudinal direction of the implantable component, again as measured from the center of gravity thereof. That said, in some embodiments, there is no lateral movement of the elements, or at least the lateral movement of the element is negligible (the curved element or the rolling element).

In some embodiments, where the piezoelectric component is also supported in the housing via at least one spring, all springs supporting the piezoelectric component are located on one side of the piezoelectric component. In an exemplary embodiment, with respect to centers of gravity of the springs, in the first, second and/or third mechanical state, all centers of gravity of all the springs are located on one side of the piezoelectric component. In an exemplary embodiment, at least 60, 65, 70, 75, 80, 85, 90, 95, or 100% or any value or range of values therebetween in 1% increments of the total number of centers of gravity of all of the springs supporting the piezoelectric component located on one side of the piezoelectric component.

In an exemplary embodiment, at least 60, 65, 70, 75, 80, 85, 90, 95, or 100% or any value or range of values therebetween in 1% increments of the total mass of all of the springs supporting the piezoelectric component in the housing are located on one side of the piezoelectric component. And note that this does not include any dampeners or the like which may be located on the outboard portions as detailed above. Dampeners do not support the spring within the housing.

In an exemplary scenario where there exists downward deceleration or upward acceleration, the force acting against the compression of spring 910 will correspond to the combined mass of the piezoelectric component and the counterweight (the transducer-seismic mass assembly) times the acceleration/deceleration (i.e., F=m×a). For the purposes of this discussion, the plates 964, 962, and the spring 910 do not contribute to the mass of the transducer-seismic mass assembly. In, for example, acceleration and/or deceleration corresponding to 2 or 3 Gs, in an exemplary embodiment, the downward force F2 will increase 2 or 3 times from that which exists in the first mechanical state in a 1 G environment. If the downward force F2 is less than the force F1 resulting from the spring being compressed from its relaxed state, the piezoelectric component 855 will not move from the first mechanical state. However, if the downward force F2 is greater than the force resulting from the spring being in its compressed state, the piezoelectric component 855 will move from the first mechanical state, and thus the piezoelectric component 855 will move downward. A significantly high value F2 will result in the counterweight 853 striking the housing, and further increase in the value of F2 will be irrelevant because the counterweight will not move. Any additional increase in force F3 can be absorbed by the piezoelectric material without causing a failure mode.

Upon the decrease in the acceleration component that resulted in the development of force F2, F2 will be reduced back to its normal value that results in the presence of a 1 G environment, and thus the force F1 generated by spring 910 will then dominate, pushing the piezoelectric material 855 upwards to the first mechanical state. Because the piezoelectric material was not deformed in any substantial manner, owing to the fact that the piezoelectric material was permitted to move in its entirety with the counterweight, a bending force on the piezoelectric material which otherwise might have existed did not develop, even though the acceleration/deceleration regime was sufficient to cause the counterweight to strike the inside of the housing (which, in a scenario where the inboard portions of the piezoelectric component were hard mounted to the core, would have corresponded to the maximum amount that the piezoelectric material could be bent-FIG. 7).

With respect to upward force, the reverse is the case. Upon a sufficiently high enough deceleration with the implantable component moving in the upward direction, the force F3 imparted onto the spring 910 will become greater than the force F1 (and prior to that, it will be less than force F1, and thus the piezoelectric component 855 will not move), which will in turn cause spring 910 to compress. This will permit support 950 to move upward, and thus permit piezoelectric component 855 to move upwards. The upward movement will be concomitant with the downward movement described above, albeit in reverse, and will not be described further for purposes of textual economy.

By sizing the spring 910 appropriately, any deleterious effect resulting from the forces of the springs imparted onto the piezoelectric component 855 during any part of the travel thereof from the first mechanical state to the second mechanical state and/or the third mechanical state can be mitigated. Moreover, by sizing the spring 910 appropriately, the spring can be prevented from bottoming out over the range of motions of the transducer-seismic mass assembly, thus keeping the k value linear over the range of motions, at least in some embodiments.

And note while the embodiment just described relies on a rod assembly or otherwise relies on maintaining the plates at a maximum fixed distance, in other embodiments, controlling the position of the ball 930 can have utilitarian value with respect to achieving a pre-compression on the spring or otherwise controlling the amount of extension of the spring in the first mechanical state. In this regard, by comparing FIG. 11 to FIG. 12, it can be seen that ball 930 moves laterally as well as longitudinally (with respect to the longitudinal axis 999). In an exemplary embodiment, a strap or an elastic belt can be utilized to hold the ball 930 against the support 940 or the support 950. This can have the effect of counterbalancing the spring 910 to a certain amount. For example, if the elastic force that holds ball 930 against support 950 requires a value that exceeds the force in the spring at its compressed state to move the ball, the ball will effectively hold plate 962 “downward” or otherwise resist movement of plate 962 upward, because the ball will not be permitted to move upward (again owing to the elasticity of the component pulling the ball 930 against support 950). This can also be the case in reverse for support 940. Corollary to this is that in the embodiment where there is a single support assembly 987 that encircles core 859, the cage that holds the balls 930 can be elastic of some sort. The cage could position the ball in the center as shown in FIG. 9, where movement in the lateral direction, either inboard or outboard, is resisted by the cage until a sufficient force exists that moves the ball outboard, thus permitting the ball to move upward, and thus permitting the spring to extend. Thus, by holding the ball in place in the lateral direction, the spring can be maintained in its compressed state at least by a certain amount that has utilitarian value with respect to implementing the teachings detailed herein. That is, positioning the ball 930 can add pre-compression to the spring or otherwise maintain precompression to the spring. And note that in some embodiments, an elastic cage or the like may not be needed. A rigid cage can also achieve the maintenance of the positions of the balls—the balls need not move laterally to achieve the shock protection in at least some exemplary embodiments.

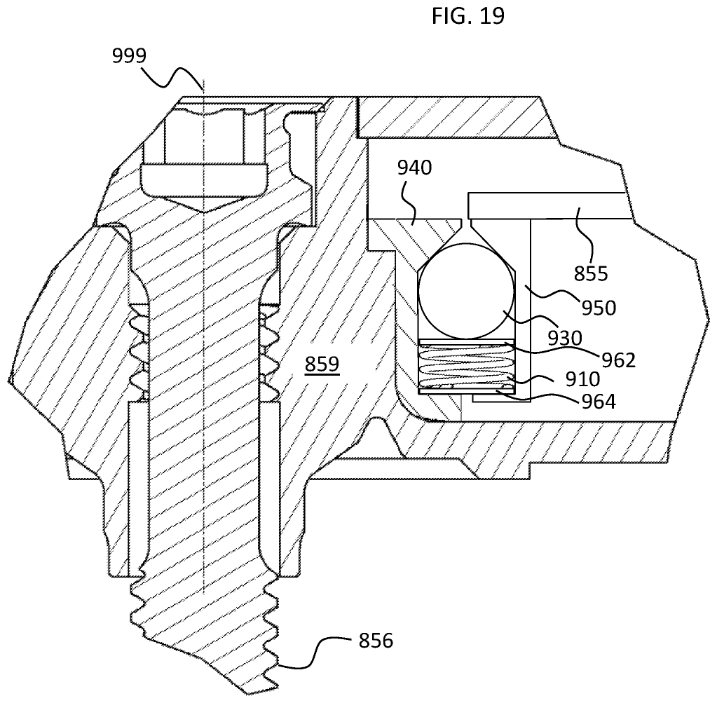

Moreover, in at least some exemplary embodiments, there may not necessarily need to be a separate component that holds the balls in place, at least with respect to achieving the precompression of the spring according to the teachings detailed herein. Jumping ahead briefly to FIG. 19, where the ball 930 is snuggly fitted between the sidewalls 944 and 954 of the support assembly 987, if lateral movement of the support 950 is prevented, lateral movement of the ball 930 is prevented. Thus, in at least some exemplary embodiments, lateral movement can be achieved by placing a bracket against support 950 and/or placing support 950 in a cylindrical cup if you will. FIG. 10 shows a sidewall of a bracket 903 that prevents support 950 from moving outboard, and where the ball 930 prevents the support from moving inboard. The support 950 is configured to slide along the bracket 903 in the up-and-down direction. Moreover, a tongue and groove arrangement can be utilized to prevent the support 950 from moving inboard irrespective of the size of the ball. That is, the tongue and groove can permit the longitudinal movement of the support 950 while preventing the lateral movement of the support 950 relative to the bracket 903.

It is noted that in this exemplary embodiment, all springs are located on one side of the piezoelectric component 855. That is, in this exemplary embodiment, there is no need for a spring that counterbalances spring 910 (such as on the opposite side of the piezoelectric component). Thus, accurate tolerancing and/or positioning of the springs need not be necessary in some embodiments.

But the reason why there need not be any spring on the opposite side of the piezoelectric component 855 is that the spring 910 has the same functionality irrespective of the direction of the force on the transducer-seismic mass assembly owing to the fact that the bottom plate 964 cannot move down further than that which is the case due to the shoulder of support 940, and the ball cannot move upward any further than that which is the case permitted by surface 956 and/or surface 954 (as will be detailed below, in some embodiments, the ball will be wedged against surface 946, surface 944, and surface 954 in addition to plate 962—that is, surface 956 can be moved completely away from ball 930—it all depends on the dimensions and size things and angling of the various components of the support assembly 987).

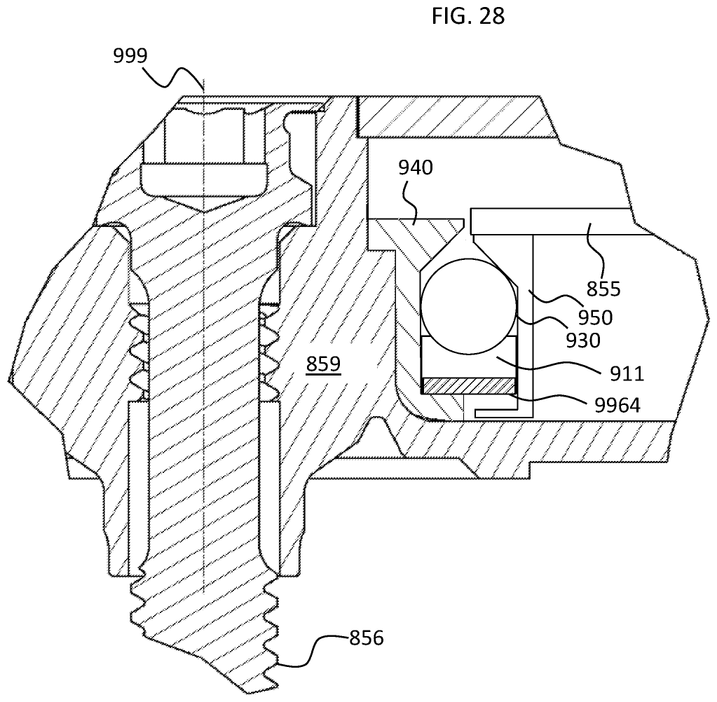

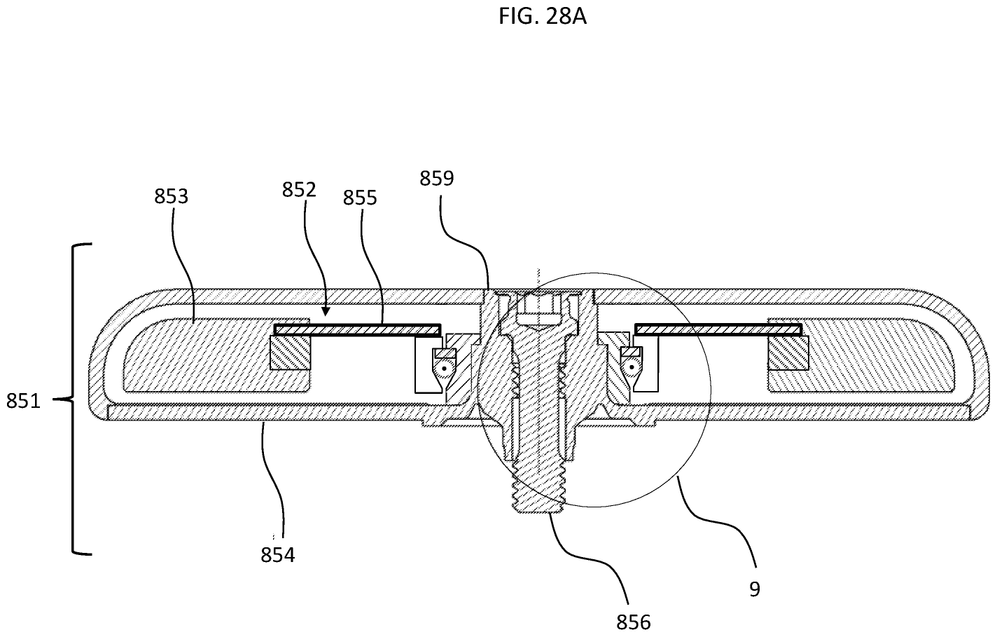

In view of the above, it can be understood that in an exemplary embodiment, there is a prosthetic metal device, such as by way of example only and not by way of limitation, a bone conduction device in general, and an implantable component of an active transcutaneous bone conduction device in particular (as is detailed herein, the teachings herein are also applicable to an external component of a passive transcutaneous bone conduction device and/or the removable component of a percutaneous bone conduction device). In view of the above, it can be understood that in an exemplary embodiment, the medical device includes a housing, and a piezoelectric component located therein. In an exemplary embodiment, the piezoelectric component is supported within the housing via at least one spring. As can be seen from FIG. 8, in an exemplary embodiment, the spring is a coiled spring. However, as will be described in greater detail below, in an exemplary embodiment, the spring can be a leaf spring. Still further, in an exemplary embodiment, the spring can be a bevel spring. Indeed, FIG. 28 shows an alternate embodiment where there is an elastomeric component 911 in the form of a cylindrical “slug” that has a rigid support 9964 (analogous to the plate 964). The elastomeric component 911 will have spring like qualities to absorb the ball 930 into the component at least partially. This can enable the use of a non-linear compression coefficient. Any spring that can enable the teachings detailed herein and/or variations thereof can be utilized in at least some exemplary embodiments. In accordance with the teachings of FIG. 8, in an exemplary embodiment, the piezoelectric component is supported in the housing by the at least one spring.

In accordance with the teachings detailed above, in an exemplary embodiment, this medical device is configured to permit the piezoelectric component to move inside the housing beyond that which is due to electricity applied to the piezoelectric component. In this regard, in an exemplary embodiment, the application of electricity to the piezoelectric component, at a maximum current and/or a maximum voltage that can be applied by the medical device, will cause the piezoelectric component to bend upward or downward, and the application of an alternating current will cause the piezoelectric component to bend upward or downward and vice versa. That said, in some embodiments, the piezoelectric component is such that in a de-energized/non-energized state, the piezoelectric component is bent downward (or upward), and the application of electrical current there to causes the piezoelectric component to bend upward (or downward), and the removal of the current therefrom causes the piezoelectric component to return to its de-energized/non-energized state, thus causing vibrations. In any event, the maximum bending that can result from application of the maximum current applyable by the medical device will cause the piezoelectric component to move (bend). In an exemplary embodiment, the medical device is configured to permit the piezoelectric component to move inside the housing beyond that which is due to electricity applied to the piezoelectric component, and, in some embodiments, beyond that which results from the maximum amount of electricity with respect current and/or voltage that is applicable to the piezoelectric component by the medical device.

For example, FIG. 15 depicts a schematic of the implantable subcomponent in the first mechanical state. Energizement of piezoelectric component 855 (or de-energizement in the embodiment where the piezoelectric component 855 is bent downward in its de-energized state) with a first current polarity (of a system with a current regime that changes to have an opposite polarity) causes the distance D1, the distance of the outboard bottom tip of the counterweight 853 (the portion of the transducer-seismic mass assembly that comes closest to the bottom of the housing during normal actuation thereof/when the piezoelectric component 855 is energized or de-energized) when the piezoelectric component is not energized in a 1 G environment with the direction of gravity acting downward, to decrease (or increase) by about X, and energizement of the piezoelectric component 855 with a second current polarity opposite the first current polarity (or energizement in the embodiment where the piezoelectric component 855 is bent downward in its de-energized state) causes the distance D1 to increase (or decrease) by about X. In an exemplary embodiment, X is about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.5, 3.0, 3.5, 4.0, 4.5, 5.0, 5.5, 6.0, 6.5, or 7.0 microns, or any value or range of values therebetween in 0.01 micron increments. X can be greater than those numbers.

In any event, the shock-proofing according to the teachings detailed herein can enable the piezoelectric component to move such that the value of D1 is reduced by at least 10%, 25%, 50%, 75%, or 100%, or any value or range of values therebetween in 0.1% increments, when subjected to a given acceleration and/or deceleration, as noted above. In an exemplary embodiment, the shock-proofing detailed herein can enable the piezoelectric component to move such that the value of D1 is reduced by an amount that is at least Y times the amount that D1 is reduced (or increased) as a result of energizement of the piezoelectric component (e.g., at the maximum current and/or voltage appliable to the piezoelectric component by the medical device), where Y is 5, 6, 7, 8, 9, 10, 11, 12, 13, 14, 15, 20, 25, 30, 35, 40, 45, 50, 55, 60, 65, 70, 80, 90, 100, 110, 120, 130, 140, 150, 175, 200, 225, 250, 375, 400, 450, 500, 550, 600, 650, 700, 750, 800, 850, 900, 950, 1000, 1100, 1200, 1300, 1400, 1500, 1600, 1700, 1800, 1900, 2000, 2250, 2500, 2750, 3000, 3500, 4000, 4500, 5000, 5500, 6000, 7000, 8000, 9000, 10000, 12500, or 15000, or more, or any value or range of values therebetween in 1 times increments, was subject to a given acceleration and/or deceleration, as noted above. Of course, as detailed above, in an exemplary embodiment, the medical device is configured to permit a seismic mass, such as the counterweight, supported by the piezoelectric component to strike a housing wall of the housing, thus halting further downward movement and/or upward movement. It is noted that the aforementioned values associated with D1 can be applicable to the outboard upper tip of the counterweight 853 as well.

Consistent with the embodiments detailed above where there is a gap between the inboard portions of the piezoelectric component 855 and the core 859 of the housing, in an exemplary embodiment, the medical device is a core component about which the piezoelectric component extends, and the piezoelectric component is configured to move along a longitudinal axis of the core as a result of compression of the at least one spring. Corollary to this is that in an exemplary embodiment, the piezoelectric component is configured to move along a longitudinal axis of the core in opposite direction as a result of compression of a spring that is when an opposite side of the piezoelectric component 855 from the at least one spring.

Still with respect to the embodiment of FIG. 8, as noted above, the subcomponent depicted in FIG. 8 is the implantable component of a bone conduction device. That said, in an alternate embodiment, the component of a bone conduction device in which the teachings detailed herein can be applicable can correspond to the external component of a passive transcutaneous bone conduction device, with a vibrator/transducer is located external to the recipient. As with the implantable component, the external component can also include a housing, and the transducer-seismic mass assembly, although in an exemplary embodiment, the housing may not necessarily be hermetically sealed, whereas in the implantable component depicted in FIG. 8, the housing is hermetically sealed from the external environment (although in other embodiments, this may not necessarily be the case, either). Note also that the teachings detailed herein with respect to shock-proofing the transducer-seismic mass assembly can also be applicable to the vibrator of a percutaneous bone conduction device, which also will include a housing, although, as with the housing of the passive transcutaneous bone conduction device containing the transducer-seismic mass assembly, that housing may not necessarily be hermetically sealed as well. In any event, irrespective of the species of bone conduction device to which the teachings detailed herein are applicable, in an exemplary embodiment, the component of the bone conduction device containing the transducer-seismic mass assembly is configured to permanently shock-proof the assembly beyond that which results from damping.

FIG. 15 further depicts an exemplary vibratory path 1495 extending from the piezoelectric material 855, through the assembly 987 to the core 859 of the housing 854, from which the vibrations then transfer into the bone of the recipient and/or into the bone fixture of the recipient, or any other intermediate component, and then into the bone of the recipient to evoke a hearing percept via bone conduction. It is also noted that in an alternate embodiment, where the device in FIG. 14A is being utilized as a sensor transducer, the vibratory path 1495 would be in the opposite direction from that represented by the arrow tip. It is noted that in some embodiments, the entire vibratory path from the piezoelectric material to the bone travels through the assembly 987 to the core 859, bypassing the spring 910. That said, in some alternate embodiments, at least a portion of the vibratory path from the piezoelectric material 855 extends through spring 910 to the housing, as represented by the arrows of 1496 in FIG. 15.

More specifically, because the piezoelectric component 855 is rigidly mounted to support 950, the vibrations can be transferred to the support 950. Because spring 910 forces the ball 930 against angled surface 956 (angled relative to surface 952/oblique relative to surface 952, in an embodiment, the angle between the two surfaces, where surface 952 is normal to axis 999, is 20, 25, 30, 35, 40, 45, 50, 55, 60, 65, or 70 degrees, or any value or range of values therebetween in 1 degree increments) with a force sufficient to hold the ball 930 against surface 956 during the normal range of movements of the piezoelectric component when energized to evoke a hearing percept over all of the magnitudes producible by the piezoelectric component (as limited by the current that can be limited to be provided to the piezoelectric component 855—this can be a result of the so-called comfort level limit or otherwise just simply an upper limit of the current appliable to the piezoelectric component). In an exemplary embodiment, the force of the ball against surface 956 in a direction normal to the surface 956 at the location where the ball 930 contacts surface 956 in the first mechanical state is at least and/or equal to 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13 Newtons, or any value or range of values therebetween in 0.1 Newton increments. But it is noted that in some embodiments, the force values can be different.

In any event, regardless of how much force or how little force is applied, providing that the force applied to the ball 930 is sufficient to enable the vibrations to travel from the support 950 to the ball 930, vibration transfer sufficient to evoke a hearing percept in a utilitarian manner will exist. Corollary to this is that providing that the ball 930 is held against surface 946 with a sufficient force, the vibrations that travel into the ball 930 will travel from the ball 9302 surface 946 and thus into support 940. In an exemplary embodiment, the features associated with surface 946 can be any of those detailed above for surface 956 albeit relatively surface 942 (and note that the values need not be the same-we are simply referencing the fact that the values can be those above for purposes of textual economy—the angle of surface 946 relative to surface 942 for example can be different from the angle of surface 956 relative to surface 952. From surface 946, or otherwise from support 940, the vibrations travel through core 859, and then into the bone fixture and/or into the housing wall and thus into the bone to evoke a hearing percept. The point is that the overwhelming majority if not all of the vibrations that evoke a hearing percept or otherwise there can be sensed by the cochlea to evoke a hearing percept travel through the core.

With reference to FIGS. 9, 11, and 12, it can be seen that the ball 930 (which is a sphere) and/or the supports 950 and 940 are sized and dimensioned so that the ball does not contact surfaces 944 and 954 in the first mechanical state. But as can be seen, when the device is in the second mechanical state, the ball 930 is forced against surface 944 as shown, and when the device is in the third mechanical state the ball 930 is forced against surface 954. Thus, during the transition from the first state to the second state or the first state to the third state, the ball 930 transitions from two point contact with the supports (or 3 point contact with the assembly 987) to three point contact of the supports (or four point contact with the assembly 987). The ball also transitions from one point contact with one of the supports to two point with one of the support while maintaining one point contact with the other support.

Embodiments can have balls with a diameter of 0.5, 0.55, 0.6. 0.65, 0.7, 0.75, 0.8, 0.85, 0.9, 0.95, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9 or 4 mm or any value or range of values therebetween in 0.01 mm increments. In some embodiments, the diameter tolerance will have no more than a deviation of anywhere between and inclusive of 0.25 to 1.0 μm or any value or range of values therebetween in 0.01 μm increments.

Thus, it can be seen that in at least some embodiments, the vibratory path from the piezoelectric component to the core 859 is always maintained, even in the second and/or third mechanical state.

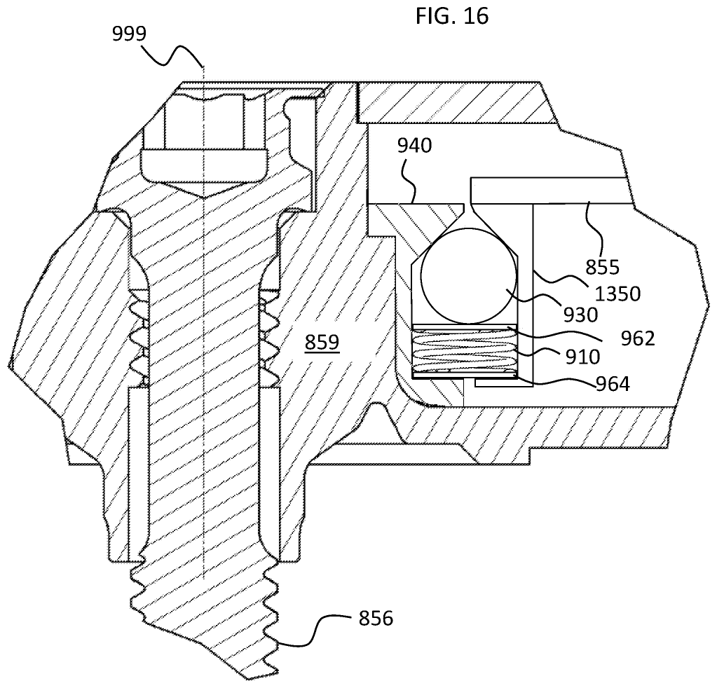

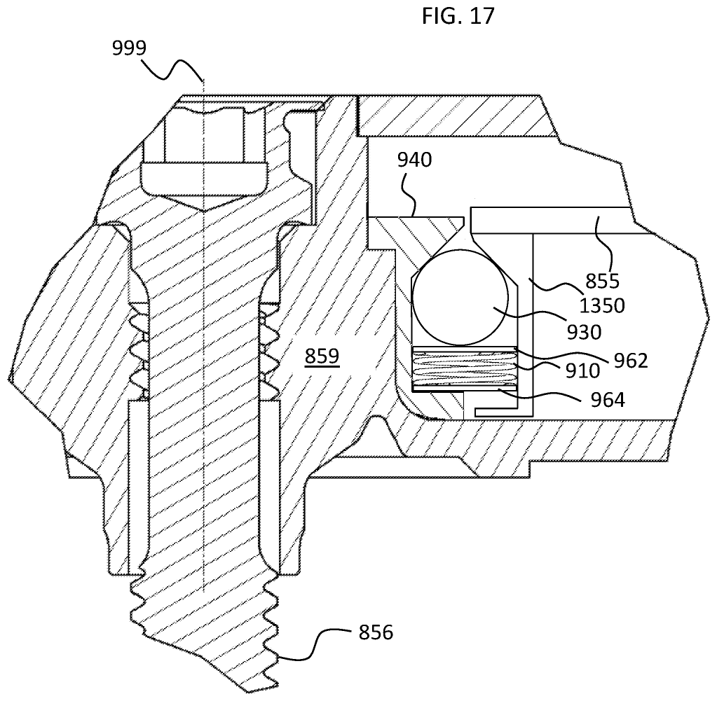

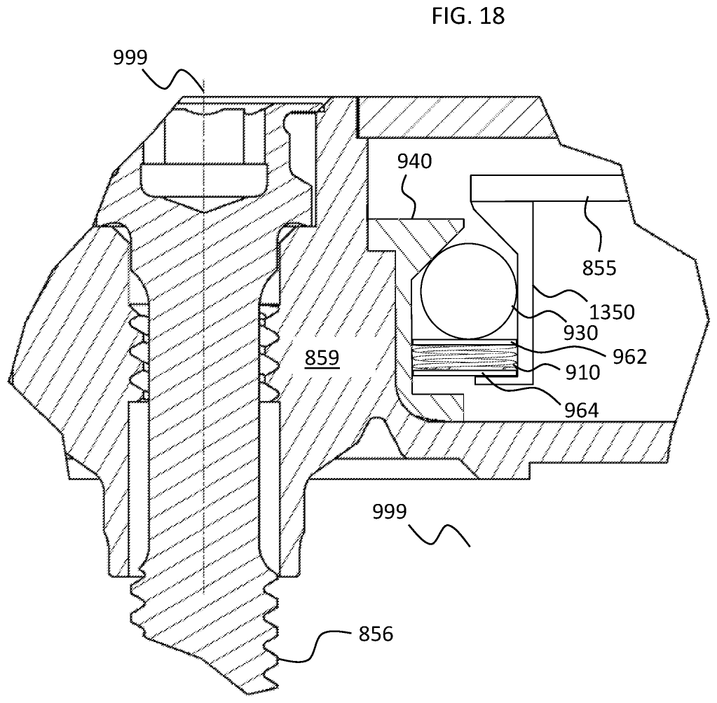

FIGS. 16-18 show another embodiment where the ball 930 is the same as that of the embodiments above (same dimensions), but the support 950 is replaced with support 1350, which has surface 954 more inboard than in the above embodiments, and thus the length of surface 956 is shorter (the length of surface 954 is longer)—the angle of surface 956 is the same as that in the above embodiments. This is the effect that when the device is in the third mechanical state, as shown in FIG. 18, the ball 930 is still only in three-point contact with the assembly 987, or single point contact with each support. This as compared to the embodiments above where there is two point contact with one of the supports, and four point contact with the assembly 987. But note the contact regime remains the same as in the above embodiments when the devices and the second mechanical state as shown in FIG. 17, where there is four-point contact with the assembly 987, or otherwise two point contact with the support 940. Note that if surface 944 is moved further outward (the opposite of the movement of surface 954 in this embodiment), the contact regime associated with the third mechanical state can be achieved for the second mechanical state as well.

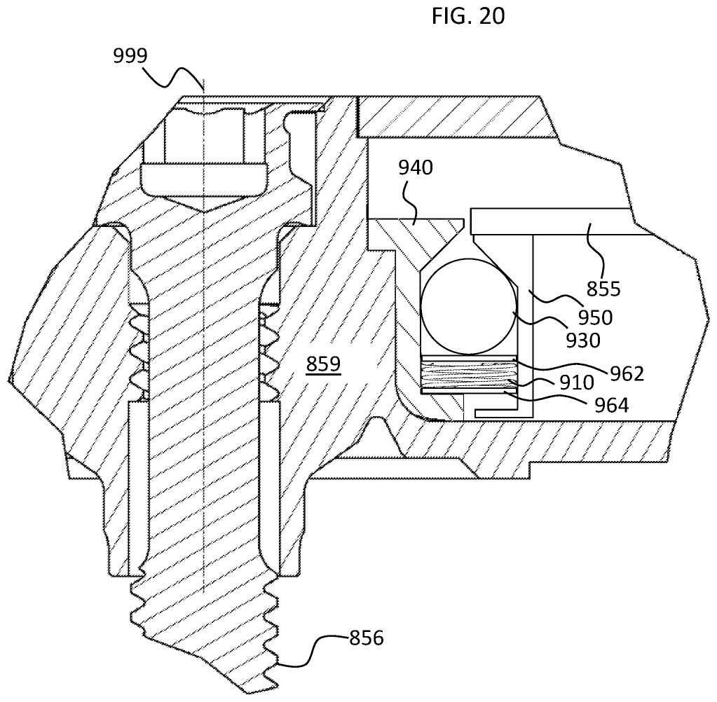

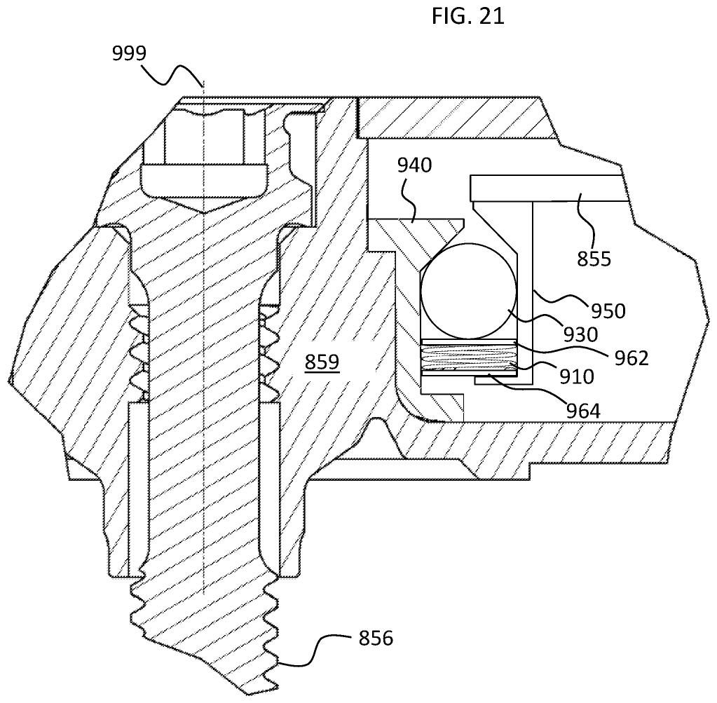

FIGS. 19-21 show another exemplary embodiment where the assembly 987 is sized and dimensioned so that there is five point contact between the ball and the rest of the assembly 987 in the first mechanical state/there is to point contact with each of the supports. In the first mechanical state, as shown in FIG. 20, the ball 930 is in four-point contact with the rest of the assembly 987, and into point contact with support 950 and in one point contact with support 940. Conversely, when the devices are in the third mechanical state as shown in FIG. 21, the ball 930 is in four-point contact with the rest of the assembly 987, in two point contact with the support 940, and in one point contact with the support 950.

In at least some exemplary embodiments where there is two point contact with one or both of the supports, the amount of vibrational energy that is transferred through those points can be equal or about equal or can be different. In an exemplary embodiment, of the total amount of vibrational energy produced, less than or equal to or greater than 10, 15, 20, 25, 30, 35, 40, 45, 50, 55, 60, 65, 70, 75, 80, 85, or 90%, or any value or range of values therebetween in 1% increments is conducted to the ball from surface 956, and of the total amount of vibrational energy produced, less than or equal to or greater than 10, 15, 20, 25, 30, 35, 40, 45, 50, 55, 60, 65, 70, 75, 80, 85, or 90%, or any value or range of values therebetween in 1% increments is conducted to the ball from surface 954. And note that the two values need not equal 100%, as some may be transferred through spring 930. Corollary to this is that in an exemplary embodiment, of the total amount of vibrational energy that enters ball 930, less than or equal to or greater than 10, 15, 20, 25, 30, 35, 40, 45, 50, 55, 60, 65, 70, 75, 80, 85, or 90%, or any value or range of values therebetween in 1% increments is conducted from the ball to surface 946, and of the total amount of vibrational energy that enters ball 930, less than or equal to or greater than 10, 15, 20, 25, 30, 35, 40, 45, 50, 55, 60, 65, 70, 75, 80, 85, or 90%, or any value or range of values therebetween in 1% increments is conducted from the ball to surface 944. And note that the two values need not equal 100%, as some may be transferred through spring 910.

In at least some embodiments, in the second mechanical state, as represented by FIG. 11, the vibrational path 1495 remains coupled because the ball 930 is in contact with the pertinent surfaces of the supports.

The movement of the piezoelectric component from the first state to the second mechanical state is automatic as it occurs without user input upon the component experiencing the G force above a certain level. This is contrasted to a situation where the recipient or some other person affirmatively takes an action to decouple the vibrational path. As will be described in greater detail below, in some embodiments, the implantable components or any other components for that matter include a device that locks the vibrational path in place, so that the vibrational path will not be decoupled when the component is exposed to a given G force level. The ability to lock the vibrational path in place from an unlocked state does not mean that the component is not configured to permanently shockproof the assembly beyond that which results from damping. That is, in an exemplary embodiment that includes this locking feature, if the locking feature is engaged such that the vibrational path will not be decoupled when the component experiences the G force levels, if the vibrational path would be decoupled in the absence of the locking, such a component meets the feature of having the permanent shock proofing detailed herein, even though at that time the component is not shock proofed. It is also the case that such a component meets the other feature detailed herein regarding the ability of a component to enable the transducer-seismic mass assembly to translate within the housing, etc. That is, even in the presence of such a lock, because the device, prior to the locking, meets these features, such a device meets these features after the locking.

As noted above, after the acceleration and/or deceleration is relieved from the component, the transducer-seismic mass assembly returns to that which is present in FIG. 9 (the first state). Thus, in an exemplary embodiment, the implantable component is configured to automatically return to the first state.

In an exemplary embodiment, there is a component of a bone conduction device, comprising a housing and a transducer-seismic mass assembly, all as noted above. In this embodiment, the piezo component is configured to enable permanent shock-proofing of the transducer-seismic mass assembly beyond that which results from damping. Here, all vibrational paths from the transducer-seismic mass assembly, during normal operation, extend through a component that translates in its entirety with the transducer-seismic mass assembly when the component is subjected to a shock acceleration in a first direction and translates in its entirety with the transducer-seismic mass assembly when the component is subjected to a shock acceleration in a second direction opposite the first direction, the translations being relative to the housing. In an embodiment, this is support 950 and/or the ball 930 (any reference to the ball 930 corresponds to a disclosure of any of the other alternate components disclosed herein).

In an embodiment, the component of the bone conduction device is configured to enable permanent shock-proofing of the assembly beyond that which results from damping and the permanently shock-proofing is a result of the component being configured to automatically at least partially decouple a vibratory path extending from the transducer-seismic mass assembly to the housing upon the hosing experiencing a G force above a certain level. In an embodiment, the component of the bone conduction device is configured so that a vibratory path extending from the transducer-seismic mass assembly to the housing is maintained during all non-destructive G forces and/or any one or more of the G forces described herein. The vibratory path is established by structure that is purposely designed to be non-damping and conduct vibrations to the housing. In an exemplary embodiment, at least 40, 45, 50, 55, 60, 65, 70, 75, 80, 85, 90, 95, or 100% of all vibrational energy produced by the transducer-seismic mass assembly can be transferred by the path to the housing when the vibratory path is maintained when experiencing any one or more of the G forces disclosed herein.

In an exemplary embodiment, the transducer-seismic mass assembly includes a piezoelectric bender and one or more counterweights located at ends of the piezoelectric bender and the bone conduction component is configured to apply an electrical current to the piezoelectric bender to cause the piezoelectric bender to bend in a vibratory manner, thereby moving the one or more counterweights towards and away from a surface of the housing in a vibratory manner. The bending can be between 10 Hz and 20,000 Hz or more or any value or range of values therebetween in 1 Hz increments, consistent with the embodiments that utilize the teachings detailed herein in a hearing prosthesis. And as seen above, the piezoelectric bender is non-rigidly connected to the housing, and the component is configured such that vibrations from the piezoelectric bender travel therefrom to the housing to evoke a hearing percept.

Again, where the bone conduction component includes the transducer-seismic mass assembly that includes a piezoelectric bender and one or more counterweights located at ends of the piezoelectric bender, and where the bone conduction component is configured to apply an electrical current to the piezoelectric bender to cause the piezoelectric bender to bend in a vibratory manner, thereby moving the one or more counterweights towards and away from a surface of the housing in a vibratory manner, the piezoelectric bender is springingly supported within the housing in a non-clamped manner. This is opposed to an arrangement where, for example, there were one or more springs on the opposite side of the piezoelectric component as shown in FIG. 9 for example, in addition to the spring shown which would be clamping.

And as detailed above, the bone conduction component is configured to enable permanent shock-proofing of the assembly beyond that which results from damping.

And continuing where the transducer-seismic mass assembly includes a piezoelectric bender that surrounds a core of a housing, the bone conduction component is configured so that portions of the piezoelectric bender that are directly adjacent the core move in a direction that has a component that is parallel to a longitudinal axis of the core when the piezoelectric bender is subjected to a force greater than 3, 4, 5, 6, 7, 8, 9, 10, 11, 12, 13, 14, 15, 16, 17, 18, 19, 20, 25, or 30 Newtons, or any value or range of values therebetween in 0.1 N increments in a direction parallel to the longitudinal direction, thereby permanently shock-proofing the assembly and/or the bone conduction component is configured so that portions of the piezoelectric bender that are directly adjacent the core will not move in the direction that has a component that is parallel to a longitudinal axis of the core when the piezoelectric bender is subjected to a force no greater than 5, 6, 7, 8, 9, 10, 11, 12, 13, 14, 15, 16, 17, 18, 19, or 20 Newtons, or any value or range of values therebetween in 0.1 N increments in a direction parallel to the longitudinal direction, thereby permanently shock-proofing the assembly (of course, depending on the embodiment, these numbers will vary).

Consistent with the teachings detailed above, in at least some exemplary embodiments, the transducer-seismic mass assembly includes a counterweight (e.g., 853), and the permanent shock-proofing is a result of the implantable component being configured to enable the counterweight to strike an interior of the housing upon subjecting the housing to a G force that would otherwise break the transducer-seismic mass assembly in the absence of the shock-proofing. In this regard, in an exemplary embodiment, the G force can be 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 100, 125, 150, 175, 200, 250, 300, 350, 400 Gs, or more, or any value or range of values therebetween in 0.1 G increments.

Also consistent with the teachings detailed above, the transducer-seismic mass assembly can include a piezoelectric bender (855 is a bender) and one or more counterweights 853 located at ends of the piezoelectric bender. (It is noted that the teachings herein can be applicable to expansion and contraction piezoelectric components in addition to benders.) In some embodiments, the implantable component is configured to apply an electrical current to the piezoelectric bender to cause the piezoelectric bender to bend in a vibratory manner, thereby moving the one or more counterweights towards and away from a surface of the housing in a vibratory manner. In some exemplary embodiments, such results in the evocation of a bone conduction hearing percept per the teachings detailed herein. In some embodiments, the piezoelectric bender is non-rigidly connected to the housing (e.g., such as the embodiment of FIG. 8.), and the implantable component is configured such that vibrations from the piezoelectric bender travel therefrom to the housing to evoke a hearing percept (again, such as the embodiment of FIG. 8). This is contrasted to an embodiment where the piezoelectric material clamped to the housing or the like.

Also, in some embodiments, again, the transducer-seismic mass assembly includes a piezoelectric bender and one or more counterweights located at ends of the piezoelectric bender, and the implantable component is configured to apply an electrical current to the piezoelectric bender to cause the piezoelectric bender to bend in a vibratory manner, thereby moving the one or more counterweights towards and away from a surface of the housing in a vibratory manner. In this embodiment, the piezoelectric bender is springingly supported within the housing (e.g., as is the case with respect to the embodiment of FIG. 8).

Also, with respect to the embodiments of the transducer-seismic mass assembly that includes a piezoelectric bender, as seen above, in some embodiments, the bender surrounds a core of a housing. Again, in an exemplary embodiment, when viewed from the top (or bottom), the piezoelectric bender looks like a non-square rectangle (e.g., “Hershey bar”), as seen in FIG. 15A for example, with a hole through the center through which the core 859 extends. In view of the above embodiments, as can be seen, portions of the piezoelectric bender that are directly adjacent the core (e.g., the interior diameter of the hole through the bender, which hole can have a circular cross-section to accommodate a circular cross-section core, a square cross-section to accommodate a square cross section core, etc.) can move in a direction parallel to a longitudinal axis of the core (i.e., with respect to the frame of reference of FIG. 8, up and down) when the piezoelectric bender is subjected to a force greater than XXX Newtons in a direction parallel to the longitudinal direction, thereby permanently shock-proofing the assembly. In an exemplary embodiment, XXX is 1.5, 2, 2.5, 3, 3.5, 4, 4.5, 5, 6, 7, 8, 9, 10, 11, 12, 13, 14, 15, 16, 17, 18, 19, 20, 21, 22, 23, 24, 25, 26, 27, 28, 29, 30, or more Newtons, or any value or range of values therebetween in 0.01 Newtons. As with all of the movements detailed herein and variations thereof, such movement can be automatic upon experiencing such forces. Still further, in an exemplary embodiment, the implantable component or any other components that matter configured such that portions of the piezoelectric bender that are directly adjacent the core will not move in the aforementioned parallel direction to the longitudinal axis when the bender is subjected to a force that is not greater than YYY, where YYY is 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 Newtons, or any value or range of values therebetween in 0.01 N. By way of example only and not by way of limitation, in an exemplary embodiment, the implantable component can be configured such that a force of 8.75 Newtons in one direction will cause the bender to move relative to the core, while a force of 8.74 N in that same direction will not cause the bender to move relative to the core.

Consistent with the teachings detailed above, in an exemplary embodiment, there is a component of a transcutaneous bone conduction device (passive or active transcutaneous bone conduction device), comprising a housing, such as any of the housing's detailed herein and/or variations thereof, and a transducer-seismic mass assembly. In at least some of these exemplary embodiments, the transducer-seismic mass assembly of the transcutaneous bone conduction device is configured to translate in its entirety within the housing. By “in its entirety,” this means that every portion thereof can translate. This as opposed to any such translation which can occur in a scenario where, for example, the piezoelectric bender is clamped rigidly to the core of the housing and the piezoelectric material is energized or otherwise provided with an electrical current to cause the bender to bend, where any translation is limited to the portions of the piezoelectric bender that are not clamped.

It is briefly noted that with respect to the various thresholds that results in movement, any disclosure of movement occurring at or above a certain value also corresponds to a disclosure of a lack of movement below that value. Still further, it is briefly noted that with respect to the various thresholds that result in lack of movement, any disclosure of lack of movement occurring below or at a certain value also corresponds to a disclosure of movement above that value.

In an embodiment, there is a bone conduction device, again comprising a housing and a transducer-seismic mass assembly including a piezoelectric component. In an embodiment of such, the transducer-seismic mass assembly of the bone conduction device is supported by a resilient element (such as spring 910 or any of the springs herein), and the bone conduction device is configured to enable the resilient element to translate in its entirety within the housing when the housing is closed. This is seen in FIGS. 11 and 12, for example, by comparison to FIG. 9. This as compared to, for example, one end of the spring being attached to a non-moving component, or even not attached, but where the spring is always maintained in compression, and one end of the spring is non-moving relative to the housing, for example.

In an embodiment, all resilient elements (e.g., springs) of the bone conduction device that substantially support the transducer-seismic mass assembly are located on one side of the transducer-seismic mass assembly, as noted above. And in some embodiments, the transducer-seismic mass assembly translates in its entirety when the bone conduction device is subjected to a shock acceleration in a first direction and translates in its entirety with the transducer-seismic mass assembly when the component is subjected to a shock acceleration in a second direction opposite the first direction, the translations being relative to the housing and a steady relaxed state of the device prior to any accelerations, and the resilient element compresses when the transducer-seismic mass assembly translates in the first direction and compresses when the transducer-seismic mass assembly translates in the second direction.

In some embodiments of the bone conduction device, the transducer-seismic mass assembly is in vibrational communication with the housing via a vibration path extending from the transducer-seismic mass assembly to the housing, the vibration path including a portion that is established only in point contact between two components of the device (this as opposed to line contact (which can be established by an edge contacting a flat surface, or a sphere contacting a concave hemisphere for example of a larger radius of curvature, for example) and face contact (which can be established by two parallel surfaces contacting each other). The point contact can exist in an embodiment where the surface 946 and/or surface 956 is a flat surface and the surface of the spherical ball 930 contacts one or both of those surfaces. The line contact can exist in an embodiment where surface 946 and/or surface 956 is a curved surface, such as can be the case when the pertinent portions of supports 940 and 950 are conical/partial hemispherical and have a radius of curvature larger than the radius of curvature of the ball 930. In at least some embodiments, the transducer-seismic mass assembly is configured to translate in a first direction corresponding to a direction towards the resilient element upon the transducer-seismic mass assembly experiencing an acceleration at least above a certain value in the first direction and the transducer-seismic mass assembly is configured to translate in a second direction opposite the first direction upon the transducer-seismic mass experiencing an acceleration at least above a certain value in a direction away from the resilient element, and pull the resilient element in the second direction in its entirety when the transducer-seismic mass assembly translates in the second direction.

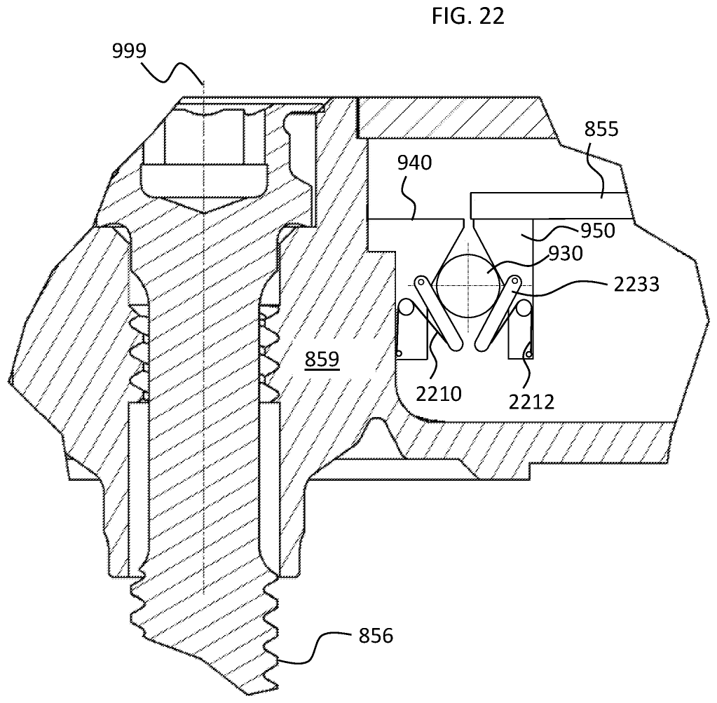

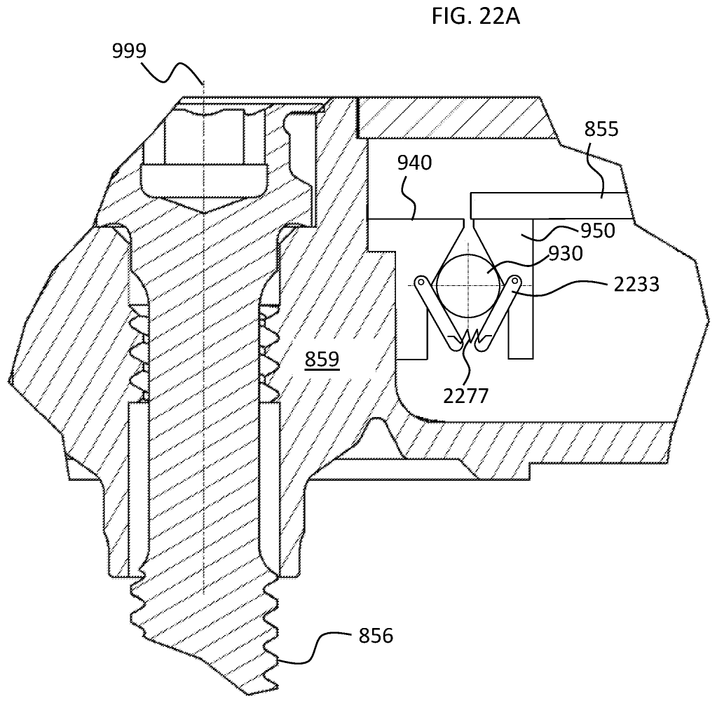

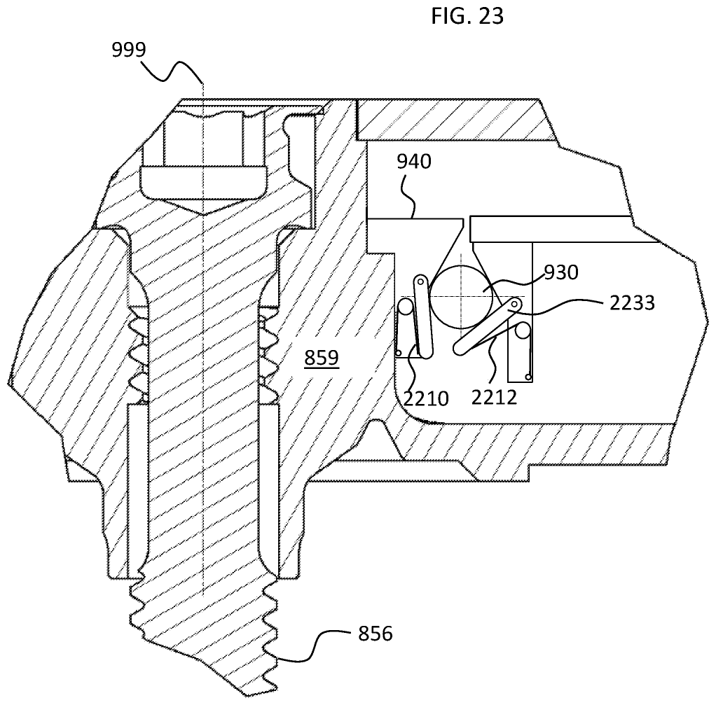

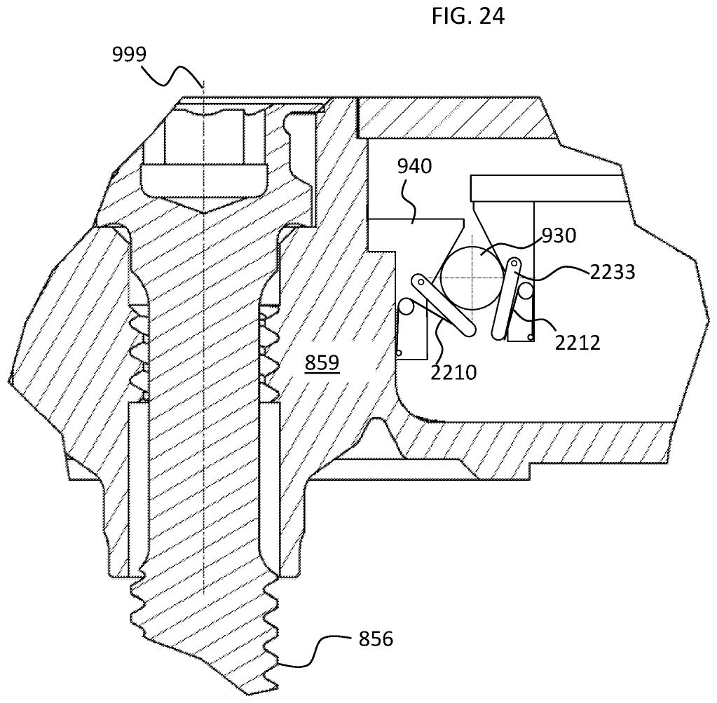

FIG. 22 presents another exemplary embodiment where levers 2233 are spring-loaded by portion springs 2210 and 2212, which levers trap ball 930 against the pertinent surfaces of support subassembly 940 and support subassembly 950. FIGS. 23 and 24 depict the device in the second mechanical state and the third mechanical state respectively. The various permutations and features detailed above can be applicable in this exemplary embodiment (e.g., three point contact or four-point contact with respect to the ball and the support and the levers, two point contact with respect to the supports, three point contact with respect to the supports, the ball 930 being able to translate in the lateral direction were not translated in the lateral direction etc.).

The embodiment of FIG. 22 utilizes two separate springs. The embodiment of FIG. 22A utilizes a single spring 2277 that connects the two levers 2233, to the extent that a single spring (per support assembly) is desired.

Note also that in an exemplary embodiment, levers 2233 can instead be leaf springs, and thus no separate spring is needed/no separate springs are needed.

Note also that while this embodiment shows two levers that articulate, in other embodiments, only one lever is present or otherwise only one lever articulates. By way of example only and not by way of limitation, a single lever embodiment can be present where the lever is positioned so that the teachings detailed herein can be implemented without a second lever. In an exemplary embodiment, a curved lever can be utilized.

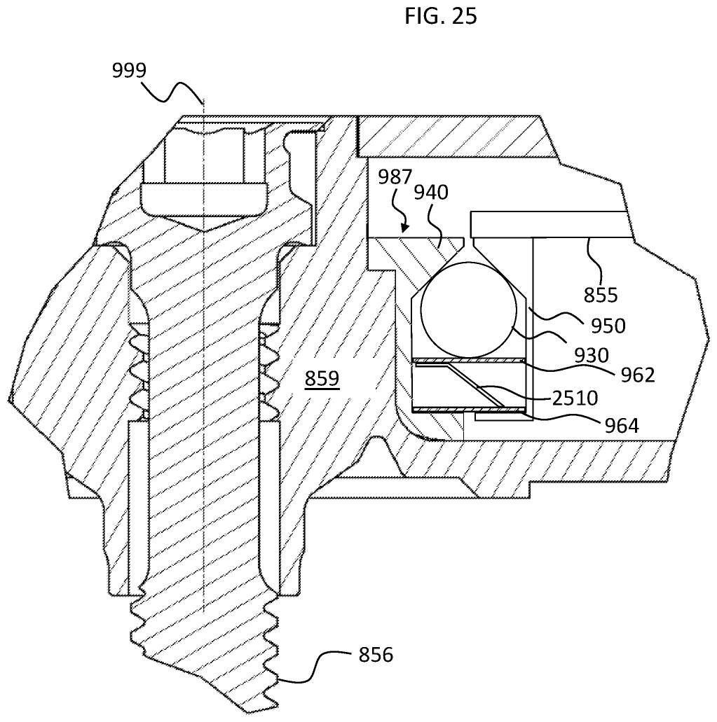

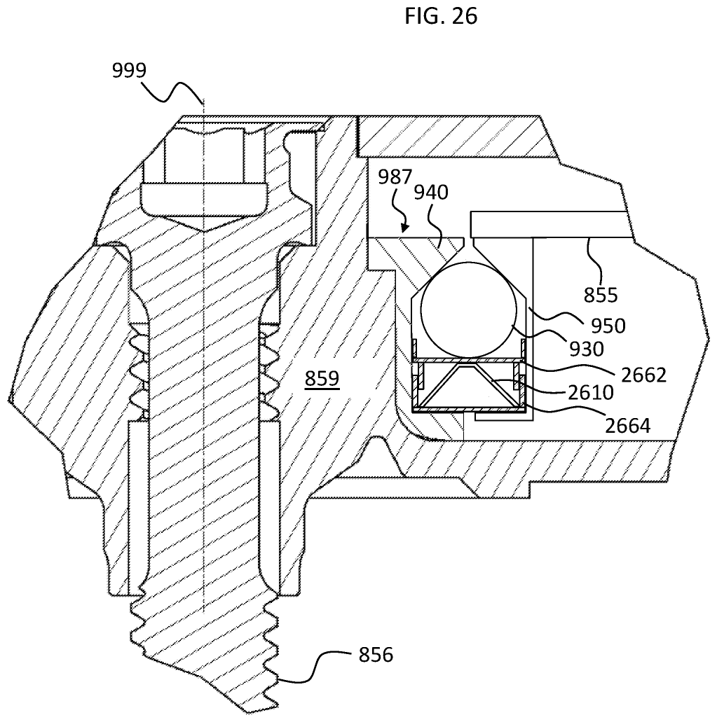

FIG. 25 presents an exemplary embodiment that utilizes a bevel spring 2510. This exemplary embodiment can have utilitarian value with respect to implementing the embodiment where the plates 962 and 964 encircle the core 859. In this exemplary embodiment, the bevel spring 2510 also encircles the core 859. That said, separate plates and separate bevel springs can be utilized in some other alternative embodiments. In this regard, FIG. 26 shows an example of a bevel spring 2610 that can be utilized with each individual support assembly 987. In this embodiment, the top of the bevel spring can be adhesively connected to the plate 962 by way of example to keep the bevel spring centered and/or to keep the plate 962 level. And further, as seen in FIG. 26, instead of plates, cups 2664 and 2662 are used. The cups use the cylindrical sidewall to keep the bottom of the cups (the equivalent of the plates) aligned/relatively level, owing to their interaction with the sides of supports 940 and 950 and are curved in a manner that slidingly interfaces with those surfaces so as to prevent the bottoms of the cups from canting/tilting, at least by an amount that can detract from the utility of the arrangement. Also shown is that the upper cup 2662 includes a cylindrical downward extension that extends into the interior of the cup 2664. This can further brace the cups so that they do not tilt here, the downward extending cylindrical portion is slip fit into the cup 2664. To be clear, both of the cups are slip fit into the respective support portions 940 and 950.

Note also that in an exemplary embodiment, the legs of the bevel spring can be linked together by a component that has strengthened tension but not compression, so that the bevel spring can be pretension in that this component prevents the legs of the bevel spring from expanding outwards to its relaxed state. Note conical springs can be used/springs in the form of a truncated hollow cone.

It is noted that any one or more of the components herein is rotationally symmetric about the longitudinal axis 999.

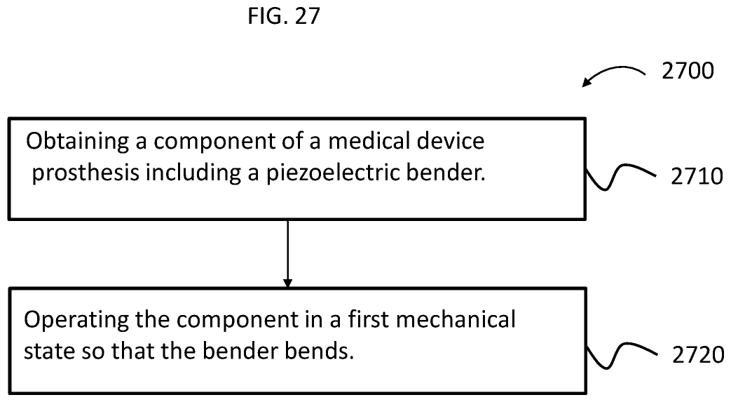

Embodiments include methods. In this regard, FIG. 27 presents an exemplary flowchart for an exemplary algorithm according to an exemplary embodiment. Here, there is method 2700, which includes method action 2710, which includes obtaining a component of a medical device prosthesis including a piezoelectric bender (such as any of the medical devices herein, or in alternate embodiments, another type of device detailed herein or another device), the piezoelectric bender being shock-proofingly supported in the component (such as by any of the arrangements herein for example). Method 2170 further includes operating the component in a first mechanical state such that the piezoelectric bender bends in a manner that at least one of consumes or generates electricity (in an alternate embodiment, the method includes attaching the component to a human instead of or including this action). Here, consistent with the teachings above, the piezoelectric bender is supported in the component by at least one resilient element, such as spring 930. Also, the shock-proofing provides shock protection in both directions normal to a plane of extension of the piezoelectric bender (along axis 999 with respect to FIG. 9) and the at least one resilient element experiences compression when respective shock forces are applied in both directions sufficient to cause the piezoelectric bender to translate within the component (as is shown in FIGS. 11 and 12, for example). In an embodiment, all resilient elements that support the bender experience compression when respective shock forces are applied in both directions sufficient to cause the piezoelectric bender to translate within the component. In an exemplary embodiment, with respect to the total number of resilient support elements supporting the bender, at least 65, 70, 75, 75, 80, 85, 90, 95, or 100%, or any value or range of values therebetween in 1% increments of the resilient support elements experience the above noted compression.

It is noted that “support” is not limited to merely support against the direction of gravity (especially because the bender floats in the housing-resistance to movement of the bender in any direction is support).

In an embodiment, as noted above, the piezoelectric bender floats in its entirety within the housing and the method includes operating the component with the piezoelectric bender floating in its entirety within the housing.

And with reference to FIG. 9, as seen, the piezoelectric bender is not sandwiched between resilient elements while the component is in the first mechanical state. Also as seen in FIG. 9, the piezoelectric bender encircles a core of a housing of the medical device in which the piezoelectric bender is located and the piezoelectric bender is spaced away from the core when in the first mechanical state. In some embodiments, the translation of the piezoelectric bender in the first direction in reaction to shock owing to the shock-proofing causes the at least one resilient element to translate in its entirety. Translation of the piezoelectric bender in the first direction in reaction to shock owing to the shock-proofing causes the at least one resilient element to compress while translating in its entirety. In an embodiment, the translation (in one direction) causes at least 65, 70, 75, 75, 80, 85, 90, 95 or 100% or any value or range of values therebetween in 1% increments of the resilient support elements supporting the bender to compress while translating.

Moreover, again with respect to translation of the piezoelectric bender in a first direction, the translation causes all resilient elements supporting the piezoelectric bender to move and translation of the piezoelectric bender in a second direction opposite the first direction causes all resilient elements supporting the piezoelectric bender to move. Still further with respect to translation of the piezoelectric bender in a first direction, the translation causes at least 65, 70, 75, 75, 80, 85, 90, 95, or 100% or any value or range of values therebetween in 1% increments of the resilient support elements supporting the bender to move and translation of the piezoelectric bender in a second direction opposite the first direction causes at least 65, 70, 75, 75, 80, 85, 90, 95, or 100% or any value or range of values therebetween in 1% of the resilient support elements supporting the bender to move.

Consistent with the teachings above, all resilient elements supporting the piezoelectric bender in the component are in compression all the time, and all resilient elements supporting the piezoelectric bender compress more, relative to the compression in the first mechanical state, when the component experiences shock sufficient to translate the piezoelectric bender. In some embodiments, at least 65, 70, 75, 75, 80, 85, 90, 95 or 100% or any value or range of values therebetween in 1% of the resilient support elements supporting the bender are in compression all the time, and at least 65, 70, 75, 75, 80, 85, 90, 95 or 100% or any value or range of values therebetween in 1% of the resilient support elements supporting the bender elements supporting the piezoelectric bender compress more, relative to the compression in the first mechanical state, when the component experiences shock sufficient to translate the piezoelectric bender.

In some embodiments of the method 2700, the component is an implantable portion of an active transcutaneous bone conduction device and the method further comprises subjecting the component to an acceleration of at least 10, 15, 20, 25, 30, 35, 40, 45, 50, 55, 60, 70, 80, 90, or 100 Gs or any value or range of values therebetween in 1 G increments, and implanting the component in a recipient after subjecting the component to the acceleration.

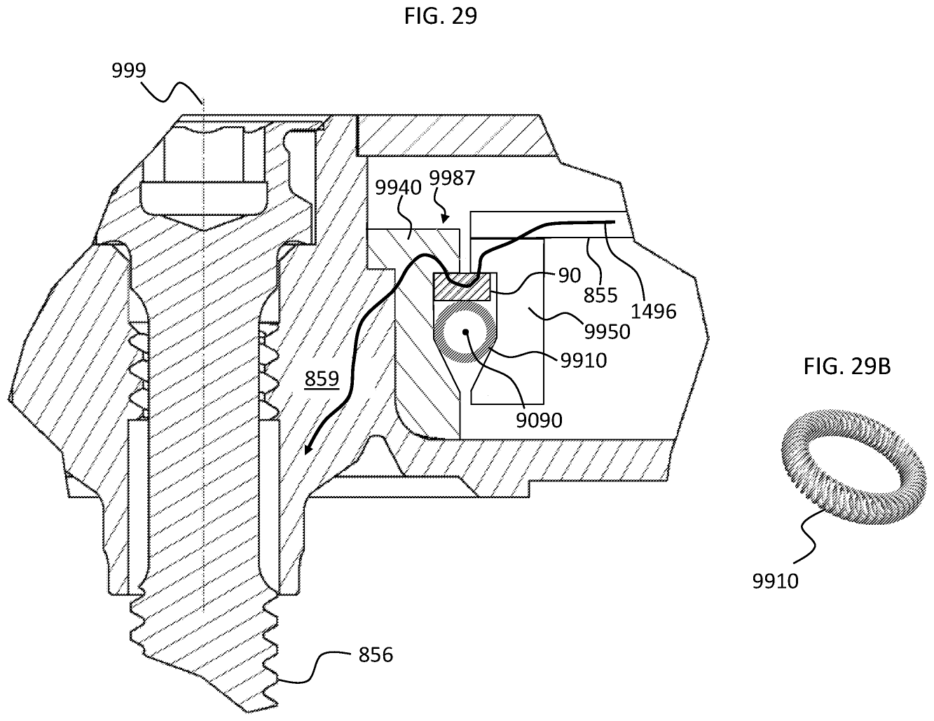

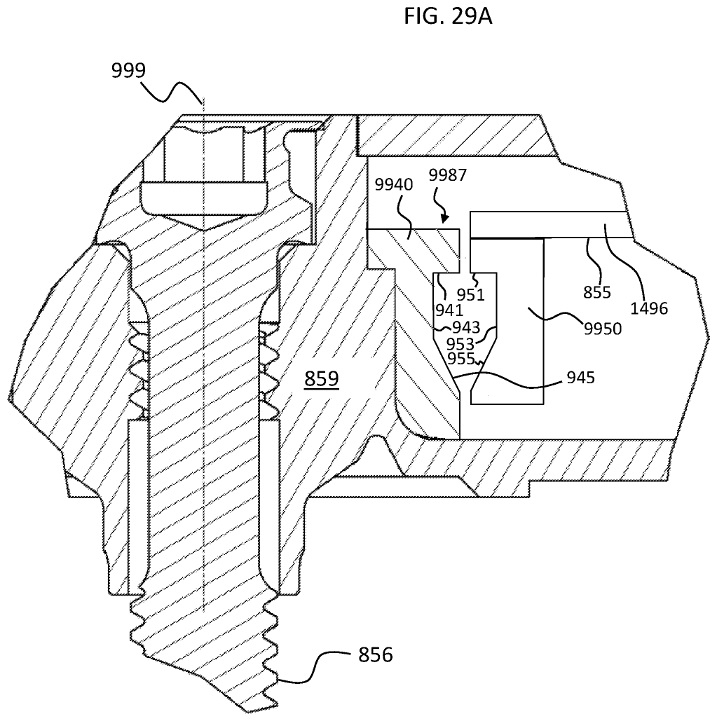

FIGS. 28A and 29 show another arrangement that provides shock proofing. FIG. 28A depicts an exemplary embodiment of an exemplary implantable sub component 851 having utilitarian value in that such can reduce or otherwise eliminate the failure mode associated with that depicted in FIG. 7. FIG. 28A depicts a cross-section through the geometric center of the subcomponent 851. Implantable subcomponent 851 includes a housing 854 that encases an actuator 852, which actuator includes a piezoelectric material 855 corresponding to material 555 of FIG. 7, and a counterweight 853 that corresponds to the counterweight 553 of FIG. 7. Also seen in FIG. 28A is that the housing 854 includes the core 859.

FIG. 29 depicts a larger view of a portion of the embodiment of FIG. 28A. Here, there is support assembly 9987, that has any one or more or all of the functionalities of support assembly 987 detailed above, provided that the art enables such. Assembly 9987 is made up of static spring subassembly support 9940 which is fixed relative to the core 859/the housing (and this could be, in an alternate embodiment, monolithic with the core, as opposed to a separate component as shown), and dynamic spring subassembly support 9950 which moves relative to the core, but is fixed relative to the piezoelectric component 855. In an embodiment, the subassembly supports have any one or more or all of the functionalities of the subassembly supports 940 and 950 respectively detailed above, provided that the art enables such. The features of the piezoelectric component 855 vis-à-vis its operation and/or interaction with the support assembly 9987 can have any one or more or all of the features thereof detailed above with respect to any one or more of the above embodiments, such as for example the adhesive bond to the support 9950. Assembly 9987 further includes a spring subassembly that includes spring 9910 and body 90. In an exemplary embodiment, with reference to FIG. 29B, spring 9910 is a garter spring. In an exemplary embodiment, spring 9910 is a polymer tube.

Body 90 provides flat and structurally rigid surfaces that interface with spring 9100 on the bottom, and the flat surfaces to which it interfaces with vis-a-vis the opposite surfaces of 9940 and 9950 on the top (the side opposite the spring). Note that in some embodiments, body 90 is slip fit onto subassembly support 9940 vis-à-vis the horizontal direction, and in other embodiments, there is a gap in that direction (the lateral position of body 90 can be controlled by a structure that permits the movement of the body 90 in the longitudinal direction but holds it in the lateral direction (e.g., a tongue and groove arrangement can be used, with the tongue can slide upward and downward in the groove, but structure one extends laterally to the body 90 to hold the plate in the lateral direction)).

In an embodiment, the piezoelectric component 855 is not clamped between two or more springs/the transducer-seismic mass assembly is not clamped between two or more springs, directly or indirectly. And no spring directly contacts the piezo.

Body 90 is interposed between the spring 9910 and the piezoelectric material 855, but all springs are located on one side in this exemplary embodiment.

The body 90 can be a circular washer that extends all the way about the core. The body 90 can instead be a distinct plate, and there can be a plurality of plates spaced about the core 859 in a manner concomitant with the plates 962 above. As will be expanded upon below, the body 90 can have various shapes, and is of a shape that is compatible with the subassemblies 9940 and 9950 (or more accurately, the space therebetween).

With reference to FIGS. 29 and 29A, body 90 provides flat and structurally rigid surfaces that interface with surfaces 941 and 951 on the top, and spring 9910 on the bottom.

Concomitant with the embodiment of FIG. 9, piezoelectric component 855 is configured so that the bending portion is located beyond/outboard the outer boundaries of the dynamic spring subassembly support 950.

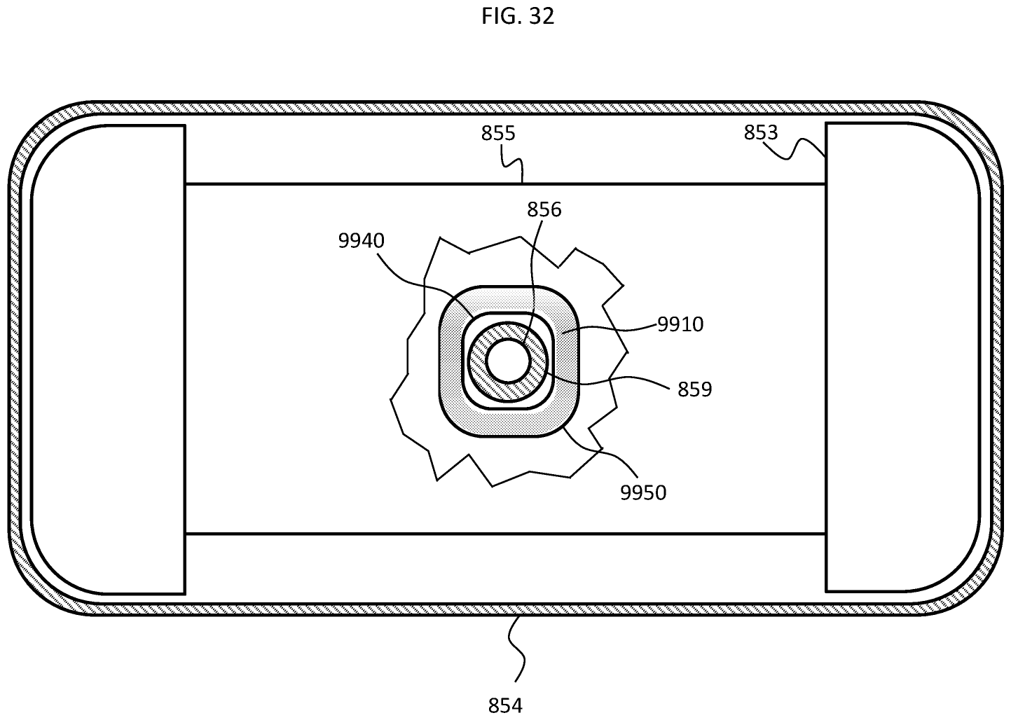

In some embodiments, the surfaces 955 and 953 and/or the surfaces 945 and 943 can be curved or flat. FIGS. 9A and 9B show curved surfaces, but the cross-section of FIG. 29A can be such that the surfaces extend into and out of the plane of the figure linearly (at least until the surface ends, such as ending at a place where the surface then extends parallel to the plane of FIG. 29A). An embodiment of this is seen in FIG. 32. Moreover, the assembly 9987 can have point contact with the spring 9910 even though support subassembly 9940 and/or subassembly 9950 has a curved cross-section. If the radius of curvature of the support 9940 is larger than the radius of curvature of the spring, point contact can be achieved (where the radius is the local radius of the spring (shown in FIG. 29), as opposed to the global radius (the large radius—the radius that establishes the path of the spring as it extends about the longitudinal axis thereof)). This can also be the case with respect to the surfaces 945 and 955 albeit depending on how those surfaces are arranged (the surfaces can be part of a cone (interior of a cone) or part of a hemispherical body, or a curved body), line contact and/or point contact can be achieved, especially if different radiuses of curvature relative to the spring are utilized for those surfaces.

And it is also noted that surface to surface contact can be achieved (as opposed to point or line) between the spring and the supports, such as where the radiuses of curvatures of the spring (local) and the surfaces are the same. This would be curved surface to curved surface contact.

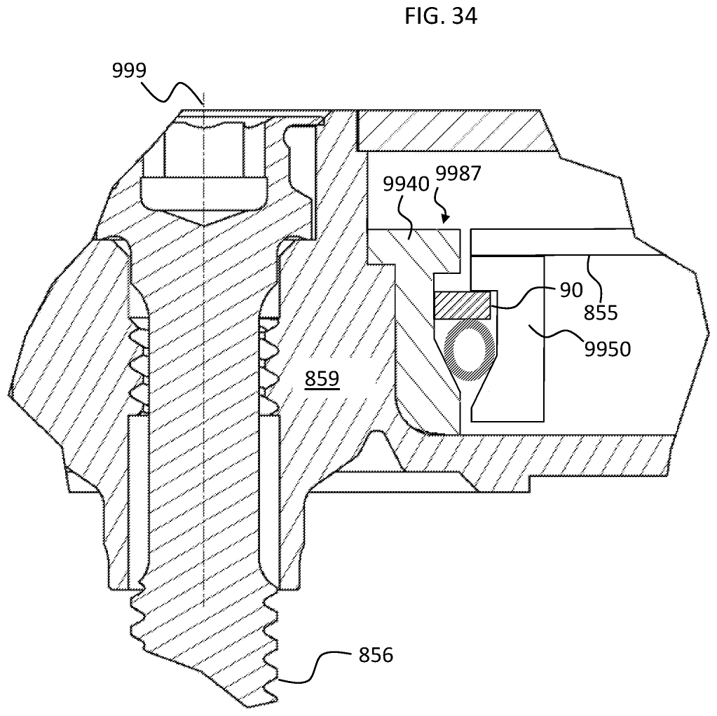

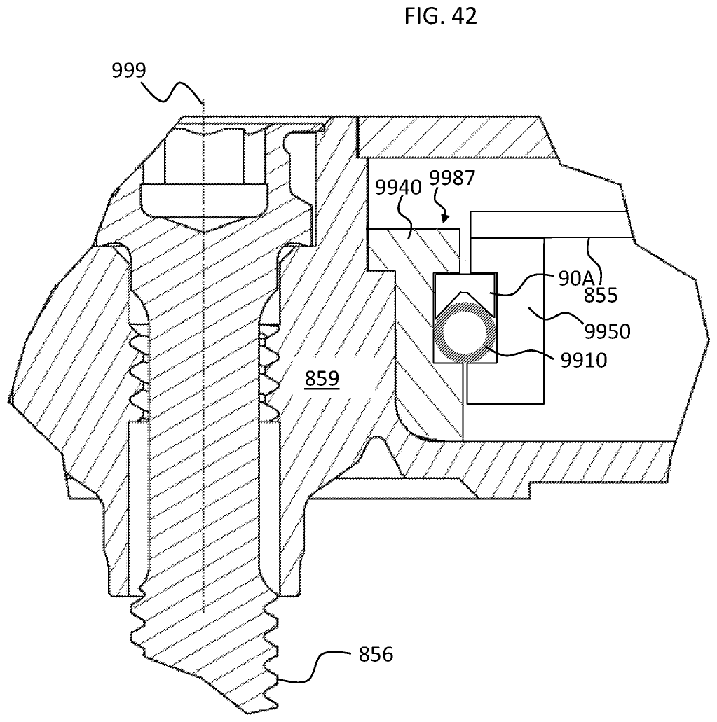

As shown in FIG. 29, spring is in point contact (or line contact with respect to a circular path) with other components of the support assembly. FIG. 29 shows five-point (or line) contact. However, as seen in FIG. 34, translation of the transducer seismic mass downward results in the spring being in only three-point contact. That said, in an alternate embodiment, even when the device is in the first mechanical state, the spring could be in three-point contact as well, or more accurately, only three-point contact. The number of contact points can be governed by the size and/or dimensions of the spring and/or the size and/or dimensions of the surfaces of the support assembly 9987 that interface with the spring. For example, changing the angle of the angled surfaces of the support assembly and/or moving the vertical surfaces away from the spring can change the five point contact shown in FIG. 29 to a three-point (line) contact. In an exemplary embodiment, the spring can be held in a six or seven or eight point contact or any values or range of values therebetween in one contact increments according to any of the points detailed herein. In some embodiments, while the surface of body 90 that interfaces with the spring 9910 is shown as a flat horizontal surface, in other embodiments, a “V” notch or the like could be located in the bottom of the body. This could create two points of contact with the body 90. FIG. 42 shows an example of this, where body 90A has a notch with a flat bottom, whereas in an alternate embodiment, the notch could be a V-shaped notch. The former can enable a three-point contact with the body 90A, and the latter can enable a two-point contact with the body 90A.

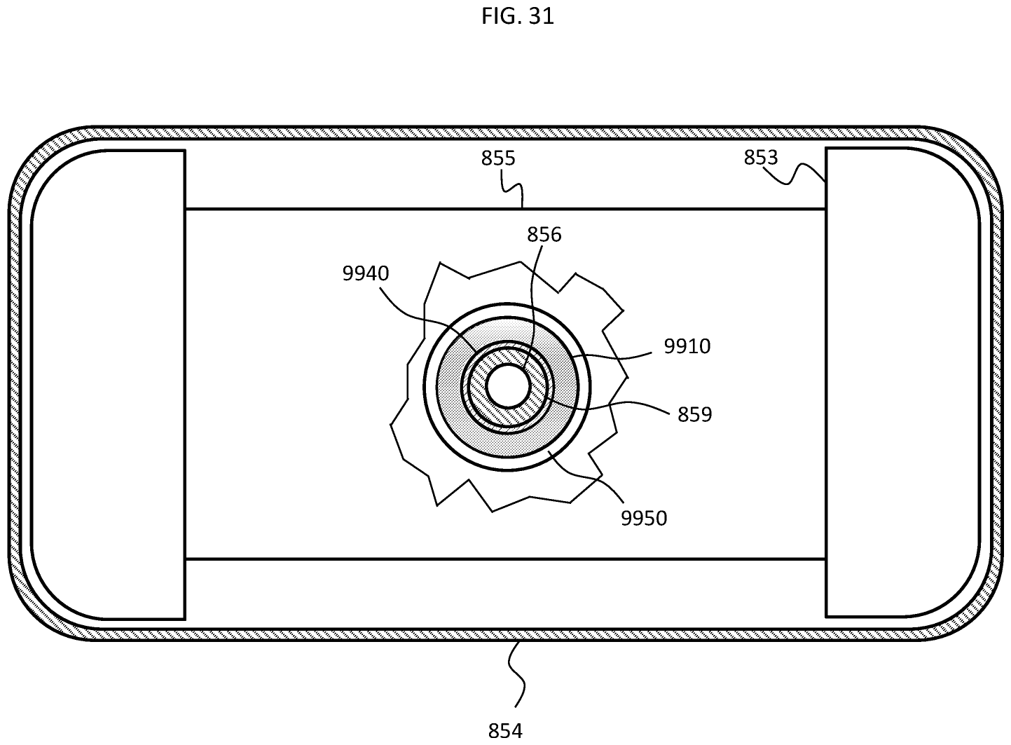

It is briefly noted that FIG. 29 and FIG. 29A show a cross-section without backdrops. In some embodiments, the surfaces of the subassemblies are curved and are rotationally symmetric about the axis 999. In some embodiments, one or more surfaces are flat. In an exemplary embodiment, the spring 9910 extends in a circular manner (perfectly circular or substantially perfectly). In an alternate embodiment, spring 9910 extends in an oval manner, or a racetrack manner, about axis 999. FIG. 31 shows a view of an implantable component 851 looking downward, with a break in the piezoelectric component 855 to show the components underneath, where portions of subassemblies 9940 and 9950 are not shown for purposes of clarity (and body 90 is not shown for clarity). Here, it can be seen that those sub-components form a circular space for spring 9910, while the embodiment of FIG. 32 is such that those sub-components form a racetrack space for spring 9910, and thus the normally at rest circular garter spring 9910 is forced into a racetrack configuration. Any device, system, and/or method that can enable the spring to be positioned about the longitudinal axis that can enable the teachings herein can be used in some embodiments.

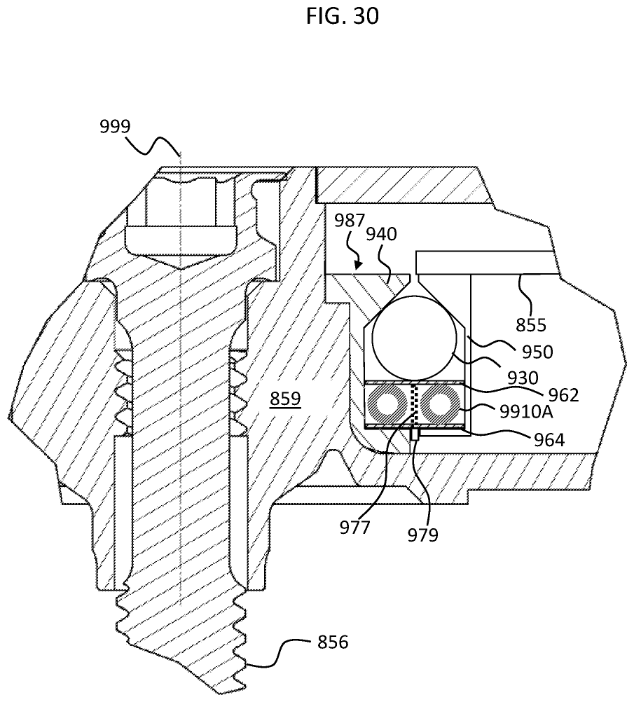

The garter spring arrangement is not exclusive to the embodiment of FIG. 29. The garter spring can be used as the spring in the embodiment of FIG. 9. Moreover, embodiments can include two or more springs. As seen in FIG. 30, there can be two or more garter springs 9910A positioned between the plates 962 and 964. And note that in an embodiment that uses the helical compression springs, there can be two such springs instead of the garter springs (there would be more than two of these springs—this is in reference to the view of FIG. 30/FIG. 9).

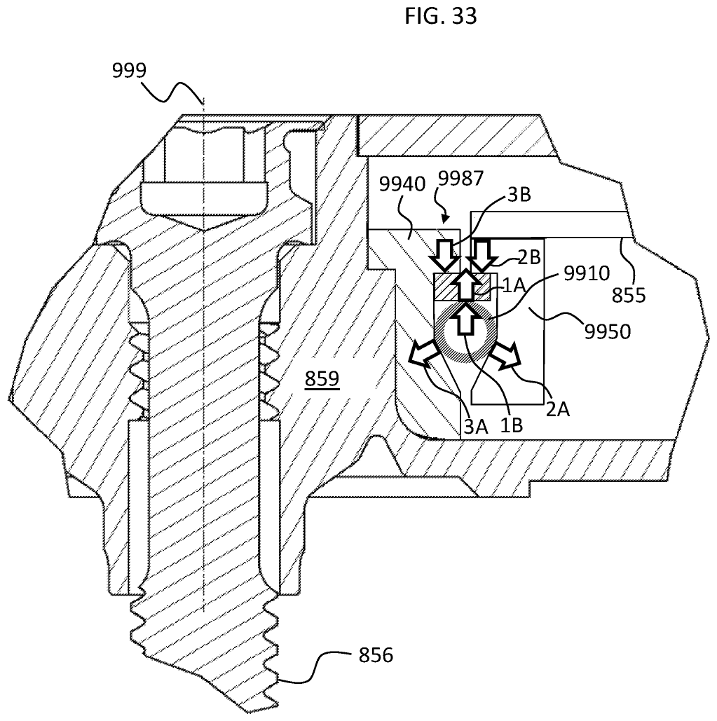

With reference to FIG. 33, where arrows 1B, 2B and 3B represent forces acting on the body 90, and arrows 1A, 2A and 3A represent forces that the spring exerts on the surrounding parts, in an exemplary embodiment, in a 1 G environment, 1A=1B, where 1A=vertical component of 2A+vertical component of 3A. The vertical component of 2A=2B and the vertical component of 3A=3B. Also, in this exemplary embodiment, the horizontal component of 2A=opposite of horizontal component of 3A.

When an acceleration causes a force to be present downward where the force is lower than 2B and 3B, the assembly will stay intact (as represented by FIG. 33—more on this in a moment) without any relative movement of subassembly 9950 with subassembly 9940 (and thus body 90 will remain forced against both of the bottom surfaces of those subassemblies). Thus, the arrangement of FIG. 31 can exist in an environment that is greater than 1 G.

If an acceleration causes forces to be larger than 2B and/or 3B, the parts will start to move in relation to each other as seen in FIG. 34. If the dynamic forces are high enough the transducer-seismic mass will move until the counterweights will move until they hit the inside of the housing.

Thus, embodiments include an arrangement where vibrational forces can be transferred from the piezoelectric component to the center post and then to the bone. Embodiments can provide an efficiency of a connection between the transducer-seismic mass and the center post in a manner where efficiency losses are minimal (including non-existent). Embodiments can include a connection that is as stiff as possible (the forces that hold the transducer-seismic mass in place at the first state) for forces created by the piezo. In embodiments, forces created by the transducer-seismic mass assembly are less than and/or equal to 3, 2.5, 2, 1.9, 1.8, 1.7, 1.6. 1.5, 1.4, 1.3, 1.2, 1.1, 1.0, 0.9, 0.8, or 0.7 N, or any value or range of values therebetween in 0.01 N increments during operation at 120 dB in a 1 G environment, and thus embodiments can enable such forces to be created by the transducer-seismic mass assembly to operate at at least any one of those forces while implementing bone conduction hearing/while enabling the vibrations to travel across the support assembly to the core as detailed herein, and otherwise in a manner that enables at least 80, 85, 90, 91, 92, 93, 94, 95, 96, 97, 98 or 99% or more of the energy generated by the transducer-seismic mass assembly to be transferred across the support assembly.

Embodiments include using piezo components where, if subjected to forces above approximately 8, 9, 10, 11, 12, 13, 14, 15, 16, 17, 18, 19, 20, 21, 22, 23, 24, or 25 N, or any value or range of values therebetween in 0.1 N increments, the piezo will break or otherwise achieve a state of impaired utility (including a state where the bone conduction device is effectively inoperative for evoking hearing percepts as would be required of an FDA approved medical device). The counterweights mass is, in some embodiments, 5, 6, 7, 8, 9, 10, 11, 12, 13, 14, 15, 16, 17, 18, 19, or 20 g, or any value or range of values therebetween in 0.1 g increments. Thus, the piezo could break at accelerations of around 150 Gs for example. Embodiments provide, in some embodiments, shock protection to over 400, 450, 500, 550, 600, 650, 700, 750 G, or any value or range of values therebetween in 1 G increments.

Embodiments include an assembly as detailed herein that is designed to be stiff or otherwise utilitarian to conduct the vibrations to the core to achieve a hearing percept for force levels below 3, 2.5, 2, 1.9, 1.8, 1.7, 1.6. 1.5, 1.4, 1.3, 1.2, 1.1, 1.0, 0.9, 0.8, or 0.7 N, or any value or range of values therebetween in 0.01 N increments (e.g., force 2B) and “compliant” for forces above one or more of the values just detailed. Embodiments include a joint that is released to prevent the piezo from breaking (or otherwise entering a reduced efficacious state).

Returning to some of the specifics of the design of the embodiment of FIG. 29, the spring 9910 is of a configuration (e.g., dimensioned and/or K value) so the forces created by the piezoelectric component during normal operation (which includes the extreme usage thereof in some embodiments) is lower than the values for 2B and 3B. In some embodiments, the force that causes the counterweight(s) and the piezo to move until the counterweights hit the housing are lower than the force at which the piezo breaks.

While the embodiments described above disclose a garter spring 9910, embodiments can include any element for 9910 that can deform under pressure that can return to its pre-deformation state that provides for the utilitarian teachings detailed herein.

And, as seen, embodiments also provide for an arrangement where the transducer-seismic mass returns to the original position after the shock forces dissipate, in the axial and/or radial direction.

During normal operation, or more accurately, when the support 9950 is in the normal position for normal operation, as seen in FIG. 29 (a non-shock state—the implant operating in a 1 G environment/or even if there is some acceleration and/or deceleration (owing to activity of the recipient) a 1 G plus or minus 0.3 G environment, for example)) the vibrations produced by actuation of the piezoelectric component are conducted to dynamic spring subassembly support 9950 (where the piezoelectric component is rigidly attached to the support 9950), which are then conducted from the support 9950 to the body 90 and then from the body 90 to the support 9940, and then to the core 859 and then to the bone (or to the bone fixture) to which the core 859 is connected. This is represented by path 1496, which has the features of the vibration path of that element detailed above.

Concomitant with the statement above that at least some features associated with the embodiments before FIG. 29 can be used with the embodiment of FIG. 29, the features of the alternate support subassembly 950A that has a more extensive top surface to provide additional bonding surface with the piezoelectric component 950A can be used in the embodiment of FIG. 29.

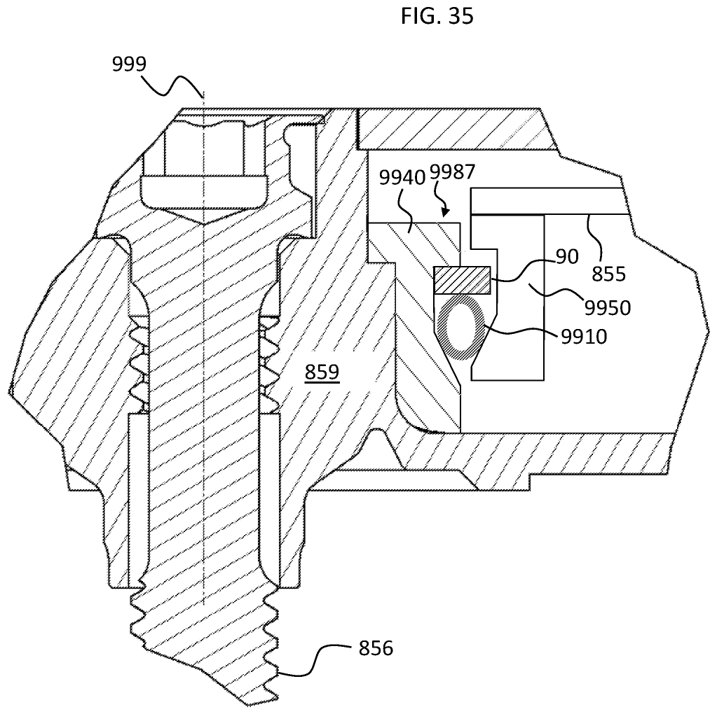

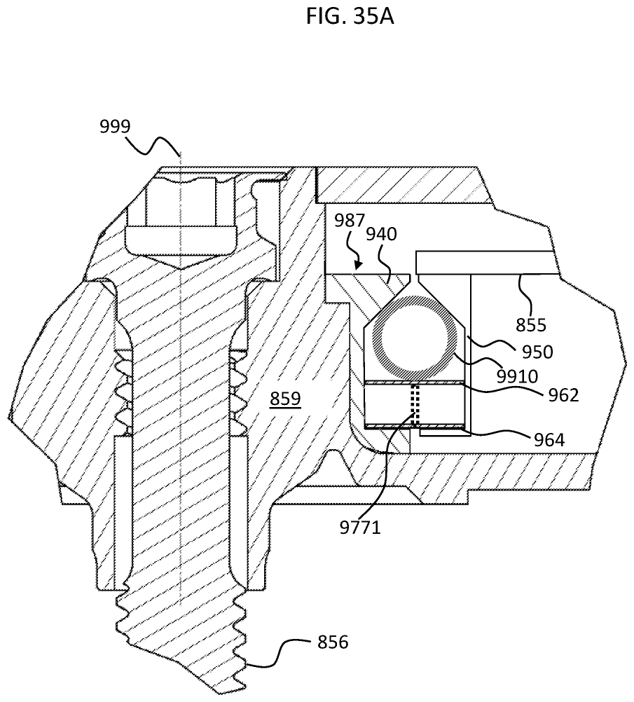

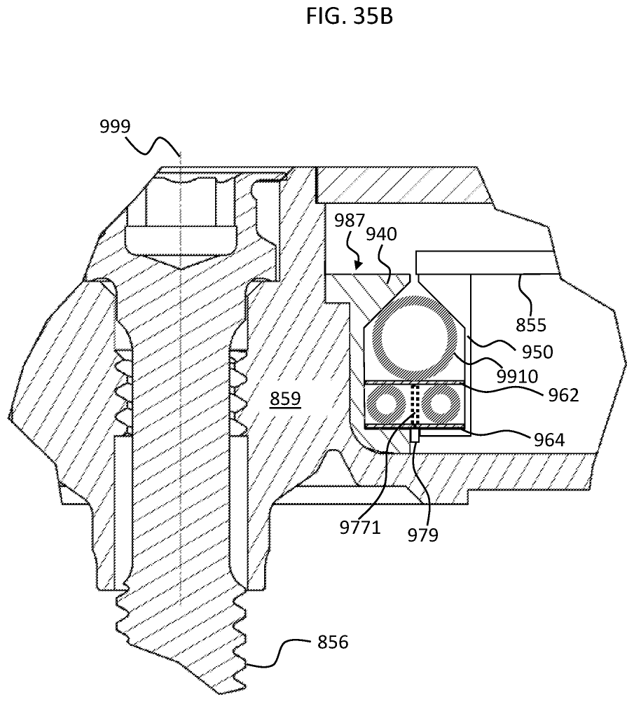

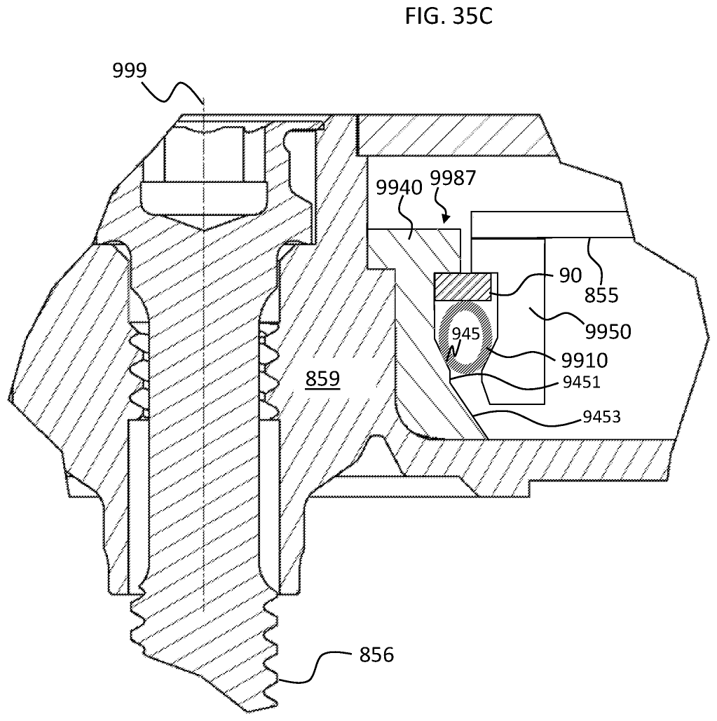

FIGS. 34-35 depict an exemplary principle of operation of the shock-proof assembly of the embodiment of FIG. 29, with some of the components shown in quasi-functional terms/black box format. As can be seen, in this exemplary embodiment, the transducer-seismic mass assembly in general, and the piezoelectric component 855 in particular, has moved from the position present in the state depicted in FIG. 29 to the state depicted in FIG. 34 or 35. FIG. 34 shows the device and the second mechanical state. Here, the transducer seismic mass assembly has been subjected to a deceleration such that the transducer seismic mass assembly moves downward relative to subassembly 9940. This causes the body 90 to move downward with subassembly 9950. This is because the top portion of subassembly 9950 pushes downward upon body 90, and body 90 is free to move in the longitudinal direction along axis 999. As seen, spring 9910, which again can be a garter spring or can be a tube, such as a polymer tube of some other flexible body (it could be a compressible solid ring, and the cross-section need not be circular—it could be rectangular for example) having sufficient structural features that the tube or spring, etc., is normally in a state where the cross-section shown in FIG. 29 is a round configuration (in this embodiment), is move downward along with body 90, and the shape thereof changes to a more oval configuration as shown. It is noted that in other embodiments, the normal/relaxed state of the spring with respect to its cross-section shown in FIG. 29 can instead be oval or can be any other shape that can enable the teachings detailed herein. When the device moves from the first mechanical state to the second mechanical state, the cross-section could change to a circular state or to a more circular state relative to that which existed when in the first circular state. In any event, in this exemplary embodiment, the purpose of spring 9910 is to provide sufficient upward force on body 90 that body 90 is held against subassembly 9940 so that vibrations can be transferred from the piezoelectric element 855 through subassembly 9950, and then into body 90, and then into subassembly 9940 and so on, during normal operation. Also, the configuration of the assembly 9987 is such that the spring does not provide so much force, in the 1 G environment, that subassembly 9950 is pushed downward and thus moves body 90 from subassembly 9940. The spring 9910 enables the subassembly 9950 to move downwards (and upwards as will be discussed below) to account for various decelerations, and thus provide the shock proofing according to the teachings detailed herein.

FIG. 35 shows the device in the third mechanical state. Here, there has been a deceleration with respect to movement upwards such that the transducer seismic mass assembly moves upwards relative to the core 859 is shown. As can be seen, spring 9910 is deformed owing to the movement of subassembly 9950 upwards and the lack of movement of body 90. Owing to the geometries of subassembly 9940 and subassembly 9950, the spring 9910 is deformed from its 1 G/first mechanical state to an oval shape as shown (by way of example). Again, the features associated with FIGS. 12 and 14 detailed above can be applicable here.

It is noted that in some embodiments, the entire vibratory path from the piezoelectric material to the bone travels through the body 90 to the core 859, bypassing the spring. In the second mechanical state or the third mechanical state, the vibrational path is decoupled because of the movement of the body 90 away from subassembly 9940 or the movement of subassembly 9950 from the body 90, respectively. In the case where the vibrational path is entirely made up of the path that extends from the body 90 to the housing, the vibratory path extending from the transducer-seismic mass assembly to the housing is completely decoupled.

The decoupling is automatic as it occurs without user input upon the component experiencing the G force above a certain level. This is contrasted to a situation where the recipient or some other person affirmatively takes an action to decouple the vibrational path.

Again, any of the above-noted features associated with the embodiments prior to FIG. 29 can be applicable to the embodiment of FIG. 29 unless otherwise noted provided that the art enables such.

As noted above, after the acceleration and/or deceleration is relieved from the component, the transducer-seismic mass assembly returns to that which is present in FIG. 29 (the first state) concomitant with the embodiments detailed above. Thus, in an exemplary embodiment, the implantable component is configured to automatically reestablish the vibratory path extending from the transducer-seismic mass assembly to the housing upon the housing being relieved from exposure of the G force above the certain level. It is noted that in an alternate embodiment, this return can be a result of a relief from exposure to G forces different than the forces which resulted in the decoupling and the first instance.

Concomitant with the teachings above, because the piezoelectric component 855 is not hard mounted or rigidly mounted to the core 859, or hard mounted or rigidly mounted directly or indirectly to the housing for that matter, but instead is mounted in a manner such that the piezoelectric component can move relative to the housing, the forces imparted on to the counterweight 853, which forces are transferred to the piezoelectric component 855, results in the piezoelectric component 855 moving downward upon those forces resulting in forces at the spring 9910 being greater than the compression force of the spring in the first mechanical state of FIG. 29. In the embodiment depicted in FIG. 34, the spring constant of the spring 9910 and/or the geometry of the subassemblies is such that the forces imparted onto spring 9910 in the deceleration scenario just described above are sufficient to deform the spring in a manner that results in the counterweight 853 striking the bottom of the housing 854 (as is the case in FIG. 13, except using the assembly 9987). In this exemplary embodiment, this stops any substantial further motion of the piezoelectric component 855 (there can be some further movement of the inboard portions of the piezoelectric component 855 (e.g., most prominently, the portions of the piezoelectric component 855 that face the core 859, at least in some embodiments), owing to the fact that the inboard portions are still free to move downward in the embodiment of FIG. 11, subject to the counterforce of the spring 9910, but this downward movement is negligible with respect to preserving the structural integrity of the piezoelectric component 855). In essence, the piezoelectric component floats inside the housing.

And note that in an embodiment, there can be a stop underneath subassembly 9950, so that, in an embodiment, subassembly 9950 bottoms out at the same time that the seismic mass bottoms out. Note further that a damper can be located beneath subassembly 9950 so that the “deceleration” of subassembly 9950 is spread out over a longer distance.

Note that any of the damping arrangements detailed above with respect to the embodiment of FIG. 9 can be used with the embodiment of FIG. 29 with the associated features thereof.

In view of the above, there is a device, such as an active transcutaneous bone conduction device, although embodiments can also be directed towards percutaneous and/or passive transcutaneous bone conduction devices, where the device includes a housing, and a piezoelectric component, such as a piezoelectric bender. The device further includes a support assembly configured to support the piezoelectric component in the housing. The support assembly can correspond to, for example, support assembly 9987 detailed above. In this exemplary embodiment, the support assembly includes a spring where, with respect to a cross-section lying on and parallel to a longitudinal axis of the device, the spring is in at least three-point contact with other components of the support assembly. And of course, with respect to the total device, the point contacts become line contacts (where line does not mean a straight line, or always a straight line-if the point contacts extend in a circle, there is a curved line contact).

As noted above, the spring can be a garter spring, or can be a resilient tube that can be compressed in a manner that can enable the teachings detailed herein.

FIG. 35A shows another exemplary embodiment that uses the plates 964 and 962, which are rigidly connected by beam 9771, in lieu of a body 90 (to save weight in this embodiment—note that this can be used in the embodiment of FIG. 29), where the ball has been replaced with garter spring 9910. In this embodiment, the principle of operation can be the same as the embodiment of FIG. 29, except in reverse, because the angled walls of the subassemblies are above the spring, and the substitute for the body 90 is located below the spring.

FIG. 35B is another variation, where three (3) garter springs are used. Note that in an embodiment, the lower garter springs can be replaced with one or two or more helical extension springs, such as the spring of the embodiment of FIG. 9.

FIG. 35C shows another variation, where there are a plurality of angled support surfaces on subassembly 9940. Here, there is the additional surface 9451 in the vertical direction, and the additional support surface 9453, which is acutely angled relative to the longitudinal axis and relative to the horizontal as can be seen. In an exemplary embodiment, when the transducer-seismic mass moves from the first state towards the second state, the body 90 will push the spring 9910 downward so that the spring goes below the bottom portion of surface 945, goes down towards surface 9451. This can have the effect of reducing or preventing further upward force against the body 90, and thus creating a situation where the transducer-seismic mass assembly can move downward to the second state with little additional resistance, or at least less resistance than that which was the case prior to the spring reaching the bottom of surface 945. The spring 9910, in at least some embodiments, can reach support surface 9453, but at this point, the transducer-seismic mass assembly has bottomed out or is close to bottoming out and otherwise reaching the second state. In some embodiments, the center of the spring 9910 (geometric center of the oval shown in FIG. 35C) does not reach a position further down than below the angled surface 945. In an embodiment, the center does not go beyond a location slightly above the vertical surface 9451. In these embodiments (and other variations thereof), this maintains the presence of a reaction force component in the vertical/axial direction acting to move the transducer-seismic mass assembly back to its first state position. In an embodiment, there could be a curvature between surface 945 and 9451, but the contact point between the spring and the subassembly 9940 is, in some embodiments, always at an angle (relative to the vertical). If the contact point of the spring (or at least the point where forces react against subassembly 9940) is on a vertical surface, there might not be a force acting to move the assembly back upwards. However, there could be an angled surface on the bridge 90, for example (e.g., on the side of the subassembly 9950 for example), that established the needed force vectors.

Note that in an embodiment, the “good” locations of the spring are maintained by dimensioning the subassemblies and the housing so that the transducer-seismic mass assembly can only move so much before bottoming out, which movement is not sufficient to permit the spring to leave the “good” locations where the spring always proves a force to return the transducer-seismic mass assembly back to the first state.

Thus, in view of the above, in an embodiment, there is a device, such as an implantable bone conduction device, that includes a housing and transducer-seismic mass assembly and a support assembly configured to support the transducer-seismic mass assembly in the housing. In an embodiment, the support assembly is configured to hold the transducer-seismic mass assembly at a first location (e.g., first state) within the housing in a first acceleration/deceleration environment while enabling the transducer-seismic mass assembly to move from the first location in a second acceleration/deceleration environment greater than the first environment (a shock environment for example). In this embodiment, the support assembly is configured so that a force applied to the transducer-seismic mass assembly that drives the transducer-seismic mass assembly to the first location when away from the first location increases over a first distance from the first location and then at least one of remains constant (no increase or decrease), decreases (from a higher state in the first distance for example) or increases at rate less than the increase over the first distance (e.g., if the increase was 10% per X distance, the increase is only 9% per X distance) over a second distance greater than the first distance from the first location. Of course, the first distance and the second distance are distances over which the transducer-seismic mass assembly is free to move within the housing.

In an exemplary embodiment, the first distance is at least 1.5, 2, 2.5, 3, 3.5, 4, 4.5, 5, 6, 7, 8, 9, 10, 11, 12, 13, 14 or 15 or any value or range of values therebetween in 0.1 increments times greater than the second distance (where the second distance is the total amount that exhibits the qualifier of the second distance). In an embodiment, the support assembly is configured so that the force applied to the transducer-seismic mass assembly that drives the transducer-seismic mass assembly to the first location when away from the first location remains constant over the first distance over the second distance. In an embodiment, support assembly is configured so that the force applied to the transducer-seismic mass assembly that drives the transducer-seismic mass assembly to the first location when away from the first location decreases over the first distance over a second distance. In an embodiment, the support assembly is configured so that the force applied to the transducer-seismic mass assembly that drives the transducer-seismic mass assembly to the first location when away from the first location increases at rate less than the increase over the first distance over the second distance.

In an embodiment, the feature that the support assembly is configured so that a force applied to the transducer-seismic mass assembly that drives the transducer-seismic mass assembly to the first location when away from the first location increases over a first distance from the first location and then at least one of remains constant, decreases or increases at rate less than the increase over the first distance over a second distance greater than the first distance from the first location is a result of global movement of the spring that supports the transducer-seismic mass assembly. That is, the entire spring moves, not just locally deforms/compresses. Indeed, that can be a feature of the implant even without these features.

Also, it is noted that the spring does not provide shock proofing in the traditional sense. The springs of the support assembly herein are not damper devices, and is not used as such. The spring is utilized in at least some of these embodiments to provide a force that pushes the body 90 upward, and pushes the subassembly 9950 downward, with resulting forces that create sufficient contact force between body 90 and the subassemblies of the support assembly 9987 so that the vibrations from the transducer seismic mass assembly can travel across the body 90 and into subassembly 9940 and then into core 859 to evoke a bone conduction hearing percept during normal operation in a 1 G environment or otherwise when not in a shock scenario. But then, when there exists a shock scenario, or otherwise a high G scenario, the spring enables the transducer-seismic mass assembly to move downward or upward as the case may be so that the transducer-seismic mass assembly comes into contact with the housing and thus does not overstress the piezoelectric component. Put another way, once the connection between the transducer-seismic mass assembly and the core is no longer needed or otherwise wanted, such as is the case in a shock scenario, that connection is eliminated by the resilient nature of the spring, and thereafter, less impediment to movement can be utilitarian. Thus, the spring does not so much absorb force as it enables movement of the transducer-seismic mass assembly in a high G environment while preventing movement of the transducer-seismic mass assembly in a low G environment or otherwise during normal operation of the bone conduction device. This movement is prevented for forces having a value below a threshold in the upward and/or downward direction (the thresholds can be the same or they can be different), but then the movement is permitted for forces having a value above those thresholds in the upward and/or downward direction. Once this threshold is met, there can be utilitarian value with respect to reducing the amount of force that resists this movement or otherwise reducing the resistance to the movement. This is because the goal then becomes to have the transducer-seismic mass assembly reached the top and/or the bottom of the housing as the case may be. Things that frustrate that can be alleviated.

Accordingly, there is a device, comprising a housing, a transducer-seismic mass assembly and a support assembly configured to support the transducer-seismic mass assembly in the housing. In this embodiment, the support assembly is configured to hold the transducer-seismic mass assembly at a first location within the housing in a first acceleration/deceleration environment (the first state) while enabling the transducer-seismic mass assembly to move from the first location (towards the location of the second and/or third state) in a second acceleration/deceleration environment greater than the first environment. In an embodiment, the second environment begins at the threshold of the acceleration/deceleration (the given G environment) that causes the transducer-seismic mass to move upward or downward (per FIG. 9 and FIG. 29 frame of references), whatever the case may be. In an embodiment of this embodiment, the support assembly is configured so that a force applied to the transducer-seismic mass assembly that drives the transducer-seismic mass assembly to the first location when away from the first location increase over a first distance from the first location (that is, as the transducer-seismic mass assembly moves downward or upward the force increases over the first distance) and then at least one of remains constant or decreases over a second distance greater than the first distance from the first location (again, as the transducer-seismic mass assembly moves downward or upward). The first distance and the second distance are distances over which the transducer-seismic mass assembly is free to move within the housing. In an exemplary embodiment, the first distance plus the second distance equal the total distance that the transducer-seismic mass assembly travels from the location of the first state to the location of the second state or the total distance that the transducer-seismic mass assembly travels from the location of the first state to the location of the third state, depending on the acceleration/deceleration regime. An exemplary embodiment, the first distance is less than, greater than and/or equal to 5, 10, 15, 20, 25, 30, 35, 40, 45, 50, 55, 60, 65, 70, 75 or 80% or any value or range of values therebetween in 1% increments of the total distance downward and/or the total distance upward (the two need not be the same).

In an embodiment, the amount of travel downward and/or upward is less than, greater than and/or equal to 200, 225, 250, 275, 300, 325, 350, 375, 400, 425, 450, 475, 500, 525, 550 or 600 micrometers or any value or range of values therebetween in 1 micrometer increments (and the two distances need not be the same).

In an embodiment, the maximum increase in force over the first distance, relative to the force at the first location, is less than, greater than and/or equal to 5, 10, 15, 20, 25, 30, 35, 40, 45, 50, 55, 60, 65, 70 or 75% or any value or range of values therebetween in 1% increments, and the maximum decrease in force over the second distance, relative to the force at the first location, is less than, greater than and/or equal to 5, 10, 15, 20, 25, 30, 35, 40, 45, 50, 55, 60, 65, 70 or 75% or any value or range of values therebetween in 1% increments, from the maximum force in the first distance.

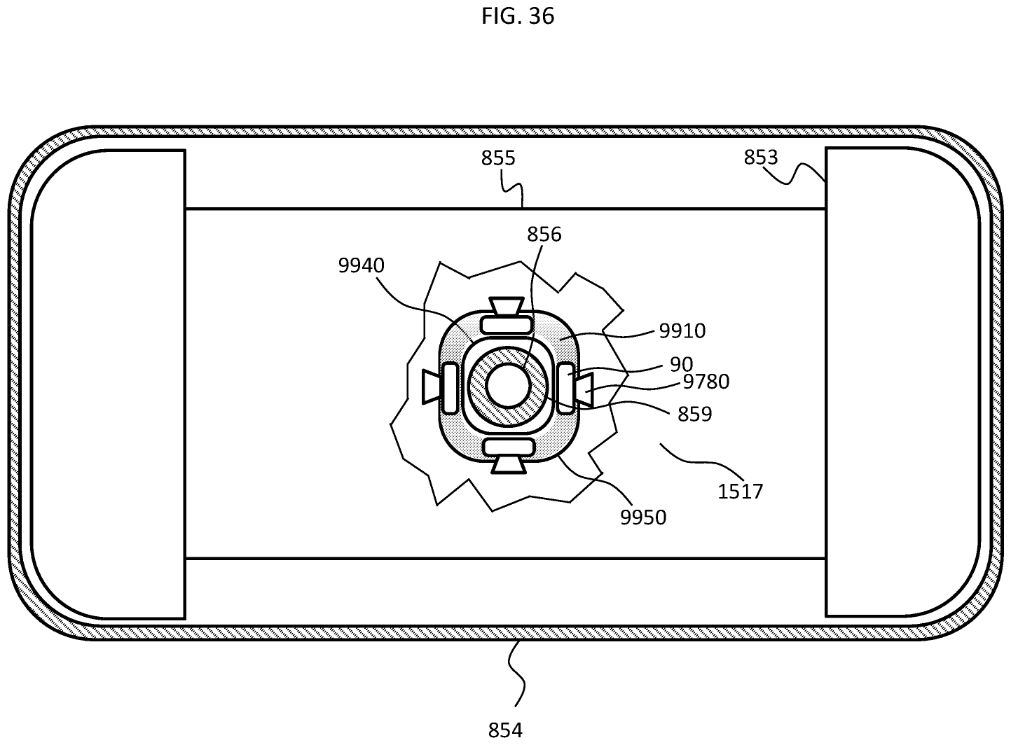

With respect to FIG. 32, in an embodiment, body 90 (not shown) can have a racetrack configuration, concomitant with the subassemblies 9940 and 9950 forming the racetrack pathway for the garter spring. This as opposed to the embodiment of FIG. 31, where the body 90 is a circular configuration. That said, embodiments can have a plurality of bodies as noted above, such as shown in FIG. 36, with bodies 90 located above the spring 9910. Here, four (4) bodies 90 are shown, where the bodies are elongate plates. The bodies 90 are spaced away from the walls of the subassemblies 9950 and 9940 as shown. Instead, tongues 9780 are connected to the bodies, and the tongues interface with subassembly 9950 in correspondingly shaped tracks therein that extend in directions into and out of the figure shown in FIG. 33. This enables the subassembly 9950 to move relative to the bodies 90 and vice versa. The tongues 9780 hold the bodies in the utilitarian orientation to enable the teachings detailed herein vis-a-vis vibrational transfer.

FIG. 35C also shows comparable additional surfaces on support subassembly 9950. These surfaces provide the functionality of the comparable surfaces of subassembly 9940 just described. Note also that surfaces 943 and 953 can be configured to also provide a similar effect. Upon the transducer-seismic mass assembly having moved a certain amount, these surfaces can be positioned so that further resistance by the spring is reduced or eliminated. Again, the idea is that upon experiencing a sufficient force that results in the transducer-seismic mass assembly moving, subsequent resistance that movement is undesirable in some embodiments.

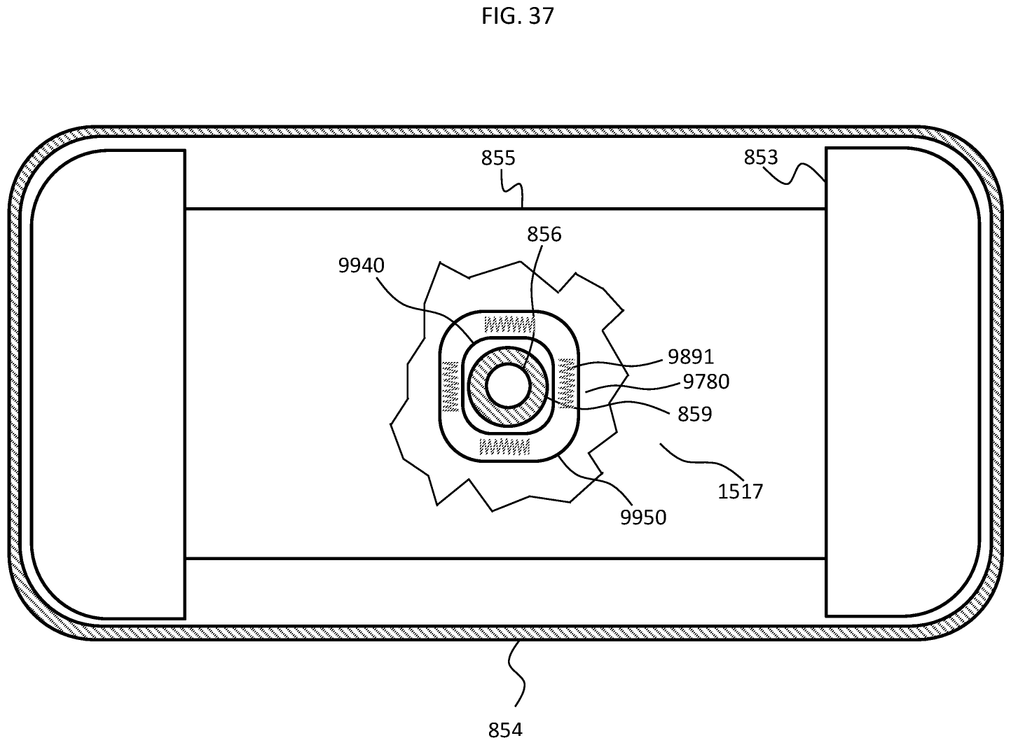

The view of FIG. 29 shows only one of the assemblies 9987. In at least some exemplary embodiments, a plurality of assemblies 9987 are evenly arrayed about the core 859. In an exemplary embodiment, there are two or three or four or five or six or seven or eight or nine or 10 or 11 or 12 or more assemblies 9987 or any value or range of values therebetween in one increments arrayed about the core 859. And this is not inconsistent with the use of the single garter spring that extends completely around the core, because not all portions of the garter spring need to be “supported” with respect to the subassemblies. There can be portions of the garter spring that extend between the subassemblies that are in free space or otherwise in the air. Corollary to this is that in at least some exemplary embodiments, there can be discrete springs each having discrete support assemblies, such as that seen in FIG. 37 as will be described in greater detail below. All of this said, in an exemplary embodiment, the supports are respectively part of an overall structure that extends about the core 859 in a manner analogous to the inner race and an outer race of a ball bearing assembly (albeit with a garter spring, or a coiled spring as will be described below with respect to FIG. 36).

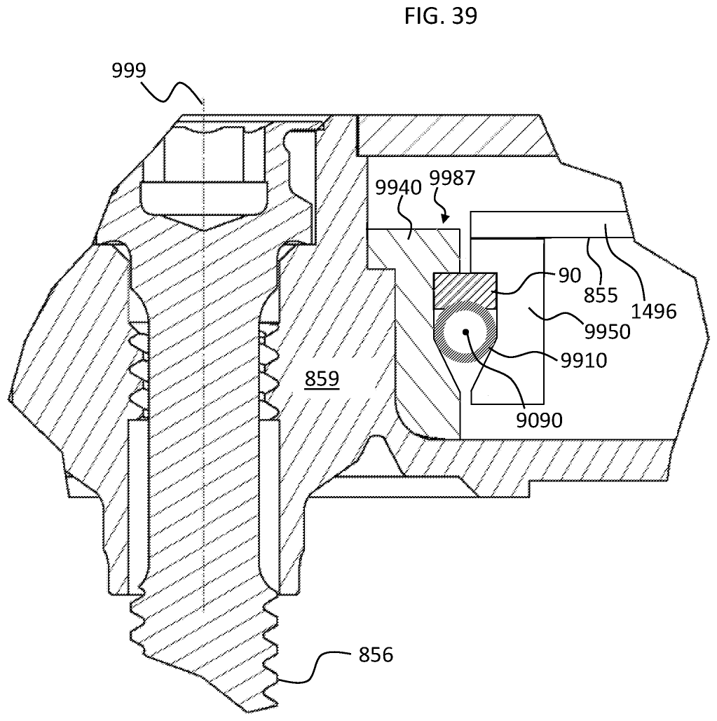

With reference to FIG. 29, shoulders/surfaces 941 and 951 “carry” the body 90 during normal operation, the first mechanical state. Shoulder/surfaces 941 also stops the body 90 from traveling upward past that surface as can be seen in FIG. 11, even though surface/shoulder 951 travels further upward past surface/shoulder 941. In an exemplary embodiment, the assembly 9987 is sized and dimensioned so that the body 90 is held for the most part in the parallel orientation or otherwise in an orientation extending normal to the direction of the longitudinal axis 999. This can be achieved by tolerancing the support 9940 relative to the support 9950 so that the structure thereof holds the body in the utilitarian orientation. While the embodiment shown utilizes a body with flat surfaces, in another exemplary embodiment, the body can have a cup shape on one side to accept the curvature of the spring, such as seen with body 90A in FIG. 39, where a curved channel extends in the bottom portion of the body 90A.

It is noted that in some embodiments, the spring 9910 can be attached in a rigid manner to the body 90. This can aid in keeping the body sufficiently parallel or otherwise sufficiently aligned with the various shoulders to enable operation of the shock proofing in a utilitarian manner. In an embodiment, the body 90 can have a hook that hooks through a loop of the spring 9910 to hold the spring 9910 against the body 90.

It is briefly noted that the utilitarian value of utilizing a single body 90 for example exists because the body will balance itself out because the body extends about the core 859. That is, there will be no moment on one side of the body that is not counteracted by a moment on the opposite side of the body.

As seen in FIGS. 34 and 35, when the devices are in the second mechanical state and the third mechanical state, the spring 9910 is deformed, relative to that which is the case in the first mechanical state. That is, in at least some embodiments, the spring 9910 always deforms relative to that which is the case in the first mechanical state when the given accelerations that move the entire transducer-seismic mass assembly exist. It is briefly noted that in at least some exemplary embodiments, the spring is always under compression, or at least deformation, even in the first mechanical state. This is because the principle of operation is such that the angled surfaces 945 and 955 prevent downward movement of the spring by an equal amount of the movement of surface 951. Corollary to this is that surface 941 prevents the body 90 from moving upward beyond surface 941, and thus upward movement of the spring 9910 owing to upward movement of the transducer-seismic mass assembly deforms the spring.

In an embodiment, the spring is in its relaxed state in the first mechanical state. That said, in an embodiment, the spring is also compressed, or otherwise deformed, in a first mechanical state. In an embodiment, there is a mechanical component that prevents the spring from extending to its relaxed state in the first mechanical state. By way of example only and not by way of limitation, there can be a cable or rod (note rod 977 can instead be a cable—it can be stiff in compression in tension, or just in tension) that extends from the body 90 (or 90A) to an opposite side of the spring 9910, to a washer or the like that is large enough to not pull through the openings of the cable, or can be wrapped around or attached to a coil. The above said, the rod or cable can be attached to the coils instead of the body 90. The effects of the rod or cable can be akin to those detailed above with respect to rod 977. The most that the spring can expand in the vertical direction is the length of the rod as limited by the washer/nut, etc. Note also that this concept can be applied in the horizontal direction as well, with a rod or cable extending from left to right and secured to the coil at opposite sides. This can enable the precise positioning of the transducer-seismic mass assembly irrespective of the relaxed position of the spring (for the most part).

Moreover, this can enable a range of limited G forces that will not result in movement of the transducer-seismic mass assembly from the location is positioned in in the first mechanical state.

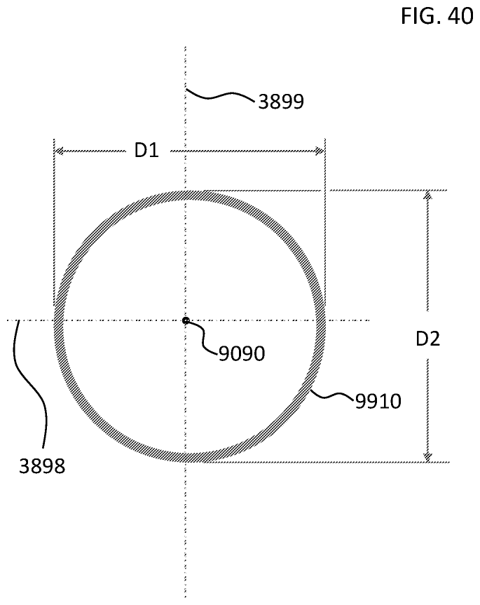

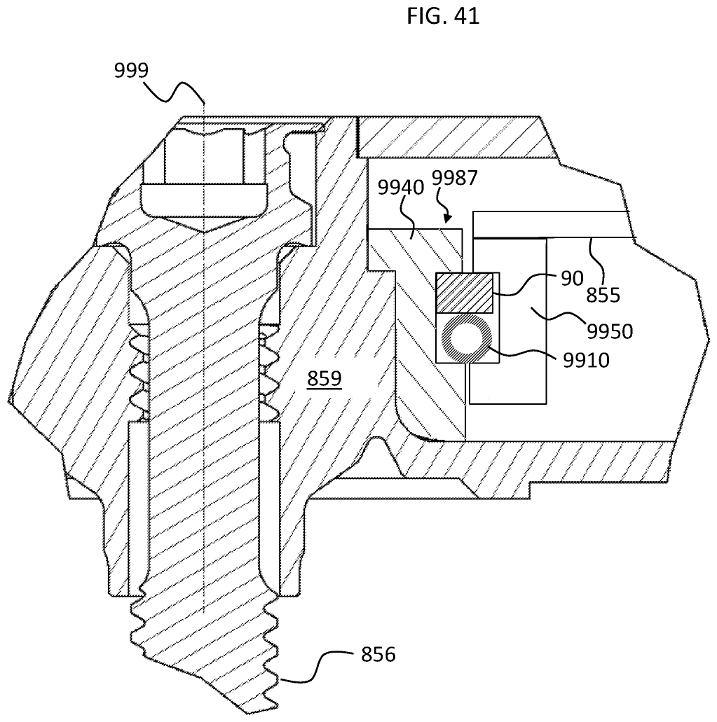

With respect to deformation of the spring, FIG. 40 shows a view taken through the spring 9910 showing one side of the spring, where axis 3899 is parallel to axis 999 and axis 3898 is perpendicular to axis 999 and 3899. In an exemplary embodiment, in the first state, D1 equals 0.9, 0.91, 0.92, 0.93, 0.94, 0.95, 0.96, 0.97, 0.98, 0.99, 1, 1.01, 1.02, 1.03, 1.04, 1.05, 1.06, 1.07, 1.08, 1.09, or 1.10×D2, or any value or range of values therebetween in 0.01 increments. In the second state and/or in the third state, the ratio of D1/D2 will change, with the ratio decreasing from that of the first state in some embodiments. That said, in some other embodiments, depending on the geometry of the surfaces of the support subassemblies, the ratio could increase from that of the first state. Indeed, while the embodiments above have presented the spring 9910 being against an acutely angled surface, FIG. 41 shows another embodiment where movement of the transducer-seismic mass assembly would cause the ratio to increase, owing to the horizontally aligned surfaces of the subassemblies. As seen, the assembly 9940 is configured to provide one or two gaps between the spring and the vertical walls for the D1 dimension to expand to accommodate movement of the transducer-seismic mass assembly. Again with reference to FIG. 42, the body 90A has a grooved underside to accommodate upward expansion of the spring 9910.

Embodiments thus can have a garter spring that can deform/that deforms upon the occurrence of a shock/high G forces, which is configured to otherwise hold the transducer-seismic mass assembly in place to enable bone conduction vibration during normal operation in a 1 G or 2 or 3, 4, 5, 6, 7, 8, 9, 10 G or less environment. In an embodiment, the ratio of D1/D2 in the first, second and/or third state is less than, greater than and/or equal to 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, or 1.5 or any value or range of values therebetween in 0.01 increments. And the value of that ratio for the first, second, and/or third state need not be the same. These values are presented in a manner for textual economy. Thus, the ratio in the first state can be 1.15, the ratio in the second state can be 0.88, and the ratio in the third state can be 0.76. Again, the values will be driven by the geometry of the surfaces of the support assembly. (The values of D1/D2 are the external diameter of the spring.)

Note further that while embodiments have been presented in terms of a spring having a ratio of D1/D2=1 (plus or minus 0.05 tolerancing) when the spring is in free space/without compression or tension (the dimensions of the spring when not in the implantable component/without influence on the spring by the support assembly), other embodiments can be different, where, for example, the spring can have any of the ratios just detailed when the spring is in free space, and thus the support assembly can deform the spring to have any one of the above ratios when the spring is placed into the support assembly and the device is in the first state.

Again, the “shape” of how the garter spring is deformed is dependent on the desired resistance to further movement of the transducer-seismic mass assembly. The shape of the garter spring can vary back and forth over the path of travel of the transducer-seismic mass assembly from the first state to the second state and/or from the first state to the third state. For example, D1 could contract initially, and then stop contracting and/or expand after a certain point between the first state and the second state or the first state and the third state. D1 could expand initially, and then stop expanding and/or contract after a certain point between the first state and the second state or the first state and the third state. Any of these could also be the case for D2.

In an exemplary embodiment, at rest in free space, D1 and D2 is less than, greater than and/or equal to 0.2, 0.25, 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, 1.5, 1.75, 2, 2.25, 2.5, 2.75, 3, 3.25, 3.5, 3.75 or any value and/or range of values there between in 0.005 mm increments, and D1 need not equal D2.

With respect to the global diameter (the diameter of the garter spring) at rest in free space, the diameter (outside) can be less than, greater than and/or equal to 0.75, 1, 1.25, 1.5, 2, 2.5, 3, 3.5, 4, 4.5, 5, 5.5, 6, 6.5, 7, 8, 9 or 10 mm, or any value or range of values therebetween in 0.005 mm increments.

In an exemplary embodiment, the body 90 is a titanium ring or a titanium washer, or other metal structure that can enable the vibrations to travel in accordance with the teachings detailed herein. In an exemplary embodiment, the components of the support assembly to which the vibrations travel during normal operation are substantially hard or otherwise rigid components to avoid attenuation or otherwise reduce attenuation or dampening of the vibration to a minimum.

And it is briefly noted that a visual inspection of FIG. 9 and FIG. 29 will show that the inner diameter of the body 90, in the case of a ring or washer, for example, that is equidistant about axis 999, is smaller than the outer diameter of the subassembly 9940, both at the top and the bottom. Accordingly, in some embodiments, the body 90 is a split ring that is configured to be able to be pulled apart to increase the diameter thereof to fit around the top of the subassembly 9940. Corollary to this is that in at least some embodiments, the garter spring 9910 has sufficient flexibility in otherwise structural features to enable the garter spring to be expanded in the global dimension so that the inner diameter thereof will fit over the outer diameter at the top of the subassembly 9940 without permanently deforming or otherwise yielding the garter spring 910.

In at least some exemplary embodiments, a flexible nature of the body 90 is such that it can enable the inner diameter to be expanded to essentially snap fit over the outer diameter of subassembly 9940. In this regard, the washer ring embodiment of body 90 can be sufficiently rigid or otherwise of a structure that can enable sufficient transmission of vibrations from the subassembly 9950 to the subassembly 9940 but also sufficiently flexible to enable the inner diameter of the ring or washer to be expanded to fit over the top of subassembly 9940. The values for the interior of the ring/washer can also apply to the outside (and need not be the same).

The above said, in some embodiments, subassembly 9940 is made out of two pieces threaded together. An exemplary embodiment, the top portion of subassembly 9940 threads onto the bottom portion of subassembly 9940. In an exemplary embodiment, the bottom portion is installed into the housing first, and then the spring and then the body 90 are put about the bottom portion, and then the top portion is attached to the bottom portion, which top portion has the larger diameter thus effectively trapping the body 90 to the subassembly 9940.

Note also that in at least some exemplary embodiments, the body 90 can be heated to expand so that it can fit around the top of subassembly 9940. When body 90 cools, it contracts, and thus is trapped onto/around subassembly 9940.

In an exemplary embodiment, the inner diameter of ring 90/washer 90 has less than, greater than and/or equal to 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.1, 1.2, 1.3, 1.4 or 1.5 mm, or any value or range of values therebetween in 0.001 mm increments clearance with surface 943 of subassembly 9940 when fully seated on subassembly 9940 with the body 90 concentric with the subassembly 9940. In an embodiment, again where the body 90 is concentric with the subassembly 9940, the maximum diameter of the subassembly 9940 (the top) overlaps (interferes) with the inner diameter of the body 90 by 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3 mm, or any value or range of values therebetween in 0.01 mm increments. In some embodiments, these are the amounts that the body 90 would have to expand to fit around the top of subassembly 9940.

And consistent with the embodiments above, the support assembly of FIG. 29 is configured to enable permanent shock-proofing of the piezoelectric component beyond that which results from damping.

As seen in FIGS. 34 and 35 relative to FIG. 29, the device is configured so that upon a first acceleration of a G force that overcomes the spring force or otherwise enables the transducer-seismic mass to translate, such as a G force of at least 5, 10, 15, 20, 25, 30, 35, or 40 G or more, or any value or range of values therebetween in 1 G increments, the spring will move in its entirety from a position at which the spring is located in a 1 G environment, in a direction of the acceleration. In an exemplary embodiment, this movement is in the vertical direction as shown in the figures. But also, in an exemplary embodiment, this movement can be in the horizontal direction, or more accurately, the movement can have a vertical component and a horizontal component. (This horizontal and vertical movement can be the case with respect to the embodiments that are supported by the balls detailed above, that utilize the support assembly of FIG. 9 for example. The ball can move in a vertical and a horizontal direction.) This leads to some additional exemplary features of this embodiment, where, for example, the spring is supported in the housing by at least two surfaces and the spring is configured to slide along the at least two surfaces when the device experiences the various G forces that result in a change in state from the first mechanical state. This is not the sliding that might occur by a common compression spring, as it is the lateral portions of the spring that slide. The spring can slide along 2, 3, 4, 5, 6, 7, or 8 or more surfaces, or any value or range of values therebetween in 1 increment.

In some embodiments, the device is configured so that upon a second acceleration of at least any of those just detailed, in a direction opposite the first acceleration, a portion of the spring will move from the position at which the spring is located in the 1 G environment, in a direction opposite the acceleration and/or in a direction normal to the direction of acceleration. This can be seen in FIG. 35 for example, where, for example, the movement of subassembly 9950 upwards compresses the spring in the horizontal direction, thus causing the spring to expand in the vertical direction.

Embodiments have focused on the arrangement of a device that has a hollow interior, such as a garter spring, or the flexible tube detailed above. Embodiments can utilize a solid spring as well (solid as compared to a coiled spring or a tube). For example, a compressible ring (compressible due to the point compressions detailed herein) that has a solid cross-section lying in a plane normal to a longitudinal axis of the device, which cross-section has at least two points of contact (or any of the contacts detailed herein) with the rest of the support assembly, can be used.

And owing to the example of a garter spring or the tube in a ring, in some embodiments, the spring is an endless spring. Conversely, it is noted that embodiments that use the techniques herein are not limited to endless springs. Coiled compression springs can be used, but oriented horizontally. This can be seen in FIG. 37, where there are four (4) coiled springs 9891, the rotation axis of which are located horizontally. Accordingly, embodiments can utilize a spring that is not a garter spring or an endless spring, but where the spring can have at least some of the features of the garter spring. And note while the embodiment shown in FIG. 37 presents four springs, in some other embodiments, there are only two or three springs. In an embodiment, there are 2, 3, 4, 5, 6, 7, 8, 9, 10, 11, 12, 13, 14, 15, 16, 17, 18, 19, or 20 springs, or any value or range of values therebetween in 1 increment, which springs are horizontally arrayed concomitant with the embodiment of FIG. 37. And it is further noted that while all the springs shown in FIG. 36 have a straight axis, embodiments can include locating the springs at the curvatures of the space between the subassemblies, and thus the springs can have a curved axis.

Embodiments can also include a device, such as any of those detailed herein, that includes the housing and the piezoelectric component. Here, the piezoelectric component has a maximum dimension (the horizontal direction of FIG. 29 for example). The device includes a spring, such as a coiled spring (but need not be so), such as a garter spring (but more on this in a moment) and the piezoelectric component is supported by the spring. In this embodiment, the spring extends along an axis that runs substantially parallel to the maximum dimension. Thus, in embodiments where the spring is a coiled spring, the coils extend about an axis (with respect to the garter spring, the axis is circular) that runs substantially parallel (which includes parallel) to the maximum dimension. (FIG. 29 shows axis 9090 according to this embodiment, where axis 9090 arcs towards axis 999 inward and above the sheet-axis 9090 extends about axis 999 in a circle, and lies on a plane normal to axis 999.) This axis represents the axis for the garter spring, the tube or the solid ring, for example.

As seen, the use of the garter spring results in springs that have a number of coils. In an embodiment, the spring has at less than, greater than or equal to 10, 15, 20, 25, 30, 35, 40, 45, 50, 55, 60, 65, 70, 75, 80, 85, 90, 95, or 100 coils or more, or any value or range of values therebetween in 1 coil increments.

Returning to how the spring is supported, in some embodiments, the garter spring is supported in the housing by at least two surfaces, a first surface of the at least two surfaces being non-parallel to a second surface of the at least two surfaces. In an embodiment, the garter spring is supported by at least 3, 4, 5, 6, 7, or 8 surfaces, or any value or range of values therebetween in 1 increment, and any one or more or all of those surfaces are not parallel to any one or more of the other surfaces (e.g., 3, 4, 5, 6, 7, or 8 surfaces, or any value or range of values therebetween in 1 increment are not parallel to each other). In some embodiments, none of the surfaces are parallel to each other.

Embodiments include a spring with a curved major axis. As seen, the major axis can be circular, or can be racetrack shaped. The major axis can be or at least have an arcuate portion (e.g., in the case of a non-endless spring that is bent, such as would be the case if the springs of FIG. 37 were moved 45 degrees clockwise or counterclockwise about the core). The curved major axis of the garter spring can extend equidistantly about axis 999.

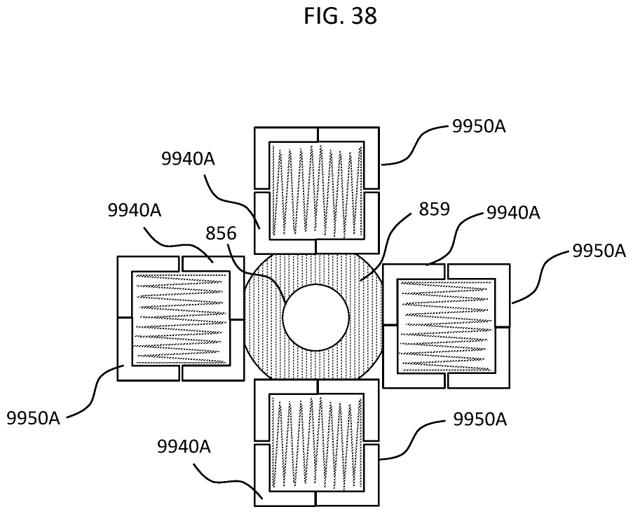

And while the embodiment of FIG. 37 shows a single support assembly (that completely circumnavigates the core), other embodiments, such as that of FIG. 38, can include a plurality of support assemblies. FIG. 38 shows sub-assemblies 9940A and 9950A (which can have the cross-sections of subassemblies 9940 and 9950 noted above, and variations thereof), the combination thereof forming four support assemblies. Any of the number of springs detailed herein can have respective support assemblies.

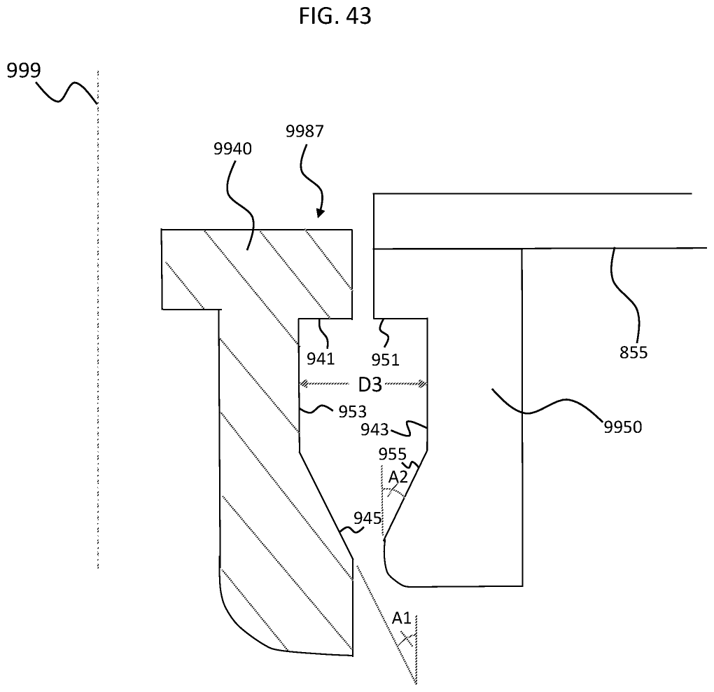

As noted above, the features of the angled surfaces can impact performance and otherwise influence how the spring is deformed. Some exemplary angles associated with some of the teachings detailed herein will now be described with reference to the embodiment of FIG. 29 by way of convenience only and not by way of limitation. It is to be noted that any of the features detailed herein with respect to the embodiment of FIG. 29 can be applicable to any of the other embodiments, concomitant time with the teachings detailed above, providing that the art enable such. For example, FIG. 43 depicts angles A1 and A2 for surfaces 945 and 955. These angles can be applicable to the surfaces 946 and 956 above, albeit the angle would be measured from the inside (where the material is) as the “control” is the vertical direction. And in this regard, the vertical (control) axis of the angles A1 and A2 are parallel to the axis 999. A1 and/or A2 (and the two need not be the same, but can be) can be any value greater than, less than and/or equal to values between (inclusive) of 0 and 85 degrees or any range of values therebetween in 0.1 degree increments depending on the embodiment. With respect to the zero values, this can be the embodiment where there are horizontal bearing surfaces at the bottom of the subassemblies 9940 and 9950 in addition to the horizontal surfaces at the top. Also seen is dimension D3, which can be any value greater than, less than and/or equal to values between (inclusive) of 0.25 to 1.5 mm or any range of values therebetween in 0.005 mm increments depending on the embodiment.

It is noted that any of these features just detailed can also be applicable to the additional surfaces of the embodiment of FIG. 35C relative to the embodiment of FIG. 29, and the values and features need not be the same. For example, surface 9453 can have a different angle relative to the horizontal then surface 945. The values for each surface are not repeated in the interest of textual economy. This does not mean that they must be the same. Any one surface can have any one of the features detailed above.

And while the embodiments above have focused on the concept of using the “local” spring force of the garter spring (the force exerted in reaction to forces applied about the circumference of the local cross-sections of the spring-those shown in FIG. 33), embodiments can also utilize the global spring force of the garter spring, where embodiments are configured to enable substantial lateral movement of the spring. In an exemplary embodiment, upon movement of the transducer-seismic mass assembly downward, spring 9910 will expand globally outward away from axis 999 in the horizontal direction a meaningful amount. The further that spring 9910 is moved outward, the greater the force desiring to return the spring to its static location. In this regard, this utilizes the hoop force of the spring 9910.

In a sense, at least some of the embodiments detailed above utilize both the local and global forces of the garter spring. In an exemplary embodiment, when the spring is in the second and/or third state, the force on the body 90 is less than, greater than and/or equal to 10, 15, 20, 25, 30, 35, 40, 45, 50, 55, 60, 65, 70, or 75%, or any value or range of values therebetween in 0.1% increments a result of hoop force, where the remainder is the local force.

Referring back to FIG. 29, as noted above, in an exemplary embodiment, the permanently shock-proofing is a result of the component being configured to automatically at least partially decouple a vibratory path extending from the transducer-seismic mass assembly to the housing upon the hosing experiencing a G force above a certain level. In an exemplary embodiment, the G force level that results in the decoupling is a G force that is equal to and/or no greater than 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 100, 125, 150, 175, 200, 250, 300, 350, 400, 450, 500, 550, or 600 Gs or more, or any value or range of values therebetween in 0.1 G increments.

Again, FIG. 29 depicts an exemplary vibratory path 1496 extending from the piezoelectric material 855 to the body 90, which can be a washer or a bridge, to the core 859 of the housing, from which the vibrations then transfer into the bone of the recipient and/or into the bone fixture of the recipient, or any other intermediate component, and then into the bone of the recipient to evoke a hearing percept via bone conduction. It is also noted that in an alternate embodiment, where the device of FIG. 29 (or FIG. 9 for that matter) is being utilized as a sensor transducer, the vibratory path 1496 (and the pathway of FIG. 9) would be in the opposite direction from that represented by the arrow tip. It is noted that in some embodiments, the entire vibratory path from the piezoelectric material to the bone travels through the body 90 to the core 859, bypassing the spring. That said, in some alternate embodiments, at least a portion of the vibratory path from the piezoelectric material 855 extends through the spring(s) to the housing. In some embodiments, the entire vibratory path extends through the springs, bypassing the connection between the bridge 930 and the core 859. In any event, in the second mechanical state, where the body is moved from the shoulder of the subassembly 9940, the vibrational path 1496 is decoupled because the body 90 is no longer in contact with any part of the housing (no longer in direct contact with any part of the housing) in some embodiments, and is otherwise in loose contact vis-à-vis the internal diameter. In the case where the vibrational path is entirely made up of the path that extends from the body 90 to the housing, the vibratory path extending from the transducer-seismic mass assembly to the housing is completely decoupled. In the case where the vibrational path is only partially made up of the path that extends from the body 90 to the housing, the vibrational path extending from the transducer-sized mass assembly to the housing is partially decoupled.

The decoupling is automatic as it occurs without user input upon the component experiencing the G force above a certain level. This is contrasted to a situation where the recipient or some other person affirmatively takes an action to decouple the vibrational path. As will be described in greater detail below, in some embodiments, the implantable components or any other components for that matter including a device that locks the vibrational path in place, so that the vibrational path will not be decoupled when the component is exposed to a given G force level. The ability to lock the vibrational path in place from an unlocked state does not mean that the component is not configured to permanently shockproof the assembly beyond that which results from damping. That is, in an exemplary embodiment that includes this locking feature, if the locking feature is engaged such that the vibrational path will not be decoupled when the component experiences the G force levels, if the vibrational path would be decoupled in the absence of the locking, such a component meets the feature of having the permanent shock proofing detailed herein, even though at that time the component is not shock proofed. It is also the case that such a component meets the other feature detailed herein regarding the ability of a component to enable the transducer-seismic mass assembly to translate within the housing, etc. That is, even in the presence of such a lock, because the device, prior to the locking, meets these features, such a device meets these features after the locking.

As noted above, after the acceleration and/or deceleration is relieved from the component, the transducer-seismic mass assembly returns to that which is present in FIG. 29 (the first state). Thus, in an exemplary embodiment, the implantable component is configured to automatically reestablish the vibratory path extending from the transducer-seismic mass assembly to the housing upon the housing being relieved from exposure of the G force above the certain level. It is noted that in an alternate embodiment, this return can be a result of a relief from exposure to G forces different than the forces which resulted in the decoupling and the first instance. That is, in an exemplary embodiment, the threshold level that resulted in the decoupling can be different than the threshold level that results in the recoupling. It is also noted that in an exemplary embodiment, the decoupling associated with downward movement of the transducer-seismic mass assembly can have a different threshold value than that which results in decoupling with respect to upward movement of the transducer-seismic mass assembly. In an embodiment, the force in one direction (downward or upward) that results in decoupling is at least and/or equal to and/or no more than 0.6, 0.7, 0.75, 0.8, 0.85, 0.9, 0.91, 0.92, 0.93, 0.94, 0.95, 0.96, 0.97, 0.98, 0.99, or 1.0, or any value or range of values therebetween in 0.01 increments of the force in the opposite direction (upward or downward).

In an embodiment, in the first mechanical state (relaxed state) the spring can be against the ring 90 with a force of less than, greater than and/or equal to 0.3, 0.4, 0.5, 0.6, 0.7, 0.8, 0.9, 1.0, 1.1, 1.2, 1.3, 1.4, 1.5, 1.6, 1.7, 1.8. 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.67, 3.8, 3.9 or 4.0 N or any value or range of values therebetween in 0.01 N increments axially. In an embodiment, these forces can be divided between subassemblies 9940 and 9950 with half for example, each in the axial direction. Thus, during shock, the spring can start to deform (e.g., compress), and in an embodiment, a maximum force pressing on 9950 (and 9940) is not higher than and/or equal to 3, 4, 5, 6, 7, 8, 9, 10, 11, 12, 13, 14, 15, 16 or 17 N or any value or range of values therebetween in 0.01N increments at a maximum travel (e.g., the maximum travels noted above). This means that at the start of the movement for instance at 10 μm movement downward or upward, the force is somewhere between the at rest/first state force and the maximum force. In an embodiment, with a mass of 10 g, 1N corresponds to approximately 10 G (1N=10 g*10 G=100 g, F=mass*acceleration). In an embodiment, the total mass of the transducer-seismic mass assembly or the total mass of the part that moves relative to the core (with or without the ring 90 depending on the embodiment) is less than, greater than and/or equal to 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 18, 19, 20, 21, 22, 23, 24 or 25 g or any value or range of values therebetween in 0.01 g increments.

It is noted that any disclosure of a device and/or system herein corresponds to a disclosure of a method of utilizing such device and/or system. It is further noted that any disclosure of a device and/or system herein corresponds to a disclosure of a method of manufacturing such device and/or system. It is further noted that any disclosure of a method action detailed herein corresponds to a disclosure of a device and/or system for executing that method action/a device and/or system having such functionality corresponding to the method action. It is also noted that any disclosure of a functionality of a device herein corresponds to a method including a method action corresponding to such functionality. Also, any disclosure of any manufacturing methods detailed herein corresponds to a disclosure of a device and/or system resulting from such manufacturing methods and/or a disclosure of a method of utilizing the resulting device and/or system.

Unless otherwise specified or otherwise not enabled by the art, any one or more teachings detailed herein with respect to one embodiment can be combined with one or more teachings of any other teaching detailed herein with respect to other embodiments. Unless otherwise specified or otherwise not enabled by the art, any one or more teachings detailed herein with respect to one embodiment can be excluded from combination with one or more teachings of any other teaching detailed herein with respect to other embodiments.

While various embodiments have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1-34. (canceled)

35. A device, comprising:
a housing;
a piezoelectric component; and
a support assembly configured to support the piezoelectric component in the housing, wherein
the support assembly includes a spring, wherein the spring is, with respect to a cross-section lying on and parallel to a longitudinal axis of the device, in at least three-point contact or three-line contact with other components of the support assembly.

36. The device of claim 35, wherein:
the spring is, with respect to a cross-section lying on and parallel to a longitudinal axis of the device, in three-point contact or three-line contact with the other components of the support assembly.

37. (canceled)

38. The device of claim 35, wherein:
the spring is a resilient collapsible tube.

39. The device of claim 35, wherein:
the support assembly is configured to enable permanent shock-proofing of the piezoelectric component beyond that which results from damping.

40. The device of claim 35, wherein:
the device is configured so that upon a first acceleration of at least 20 G, the spring will move in its entirety from a position at which the spring is located in a 1 G environment, in a direction of the acceleration.

41. The device of claim 40, wherein:
the device is configured so that upon a second acceleration of at least 20 G in a direction opposite the first acceleration, a portion of the spring will move from the position at which the spring is located in the 1 G environment, in a direction opposite the acceleration.

42. The device of claim 35, wherein:
the spring is a solid spring that has a solid cross-section lying in a plane normal to a longitudinal axis of the device, wherein the cross-section contacts at least two of the at least three points.

43. A device, comprising:
a housing;
a piezoelectric component having a maximum dimension; and
a spring, wherein
the piezoelectric component is supported by the spring, and
the spring extends along an axis that runs substantially parallel to the maximum dimension.

44-45. (canceled)

46. The device of claim 43, wherein:
the spring extend about an axis that runs substantially parallel to the maximum dimension.

47. The device of claim 43 wherein:
the spring is supported in the housing by at least two surfaces, a first surface of the at least two surfaces being non-parallel to a second surface of the at least two surfaces.

48. The device of claim 43 wherein:
the spring is supported in the housing by at least two surfaces; and
the spring is configured to slide relative along the at least two surfaces.

49. The device of claim 43, wherein:
the spring is a coiled spring, and
the spring has at least 20 coils.

50. The device of claim 43, wherein:
the spring is supported in the housing by a plurality of surfaces; and
none of the surfaces of the plurality of surfaces are parallel to each other.

51. A device, comprising:
a housing;
a piezoelectric component having a maximum dimension; and
a spring, wherein
the piezoelectric component is supported by the spring, and
the spring has a curved major axis.

52. The device of claim 51, wherein:
the spring is an endless spring.

53. The device of claim 51, wherein:
the device is a bone conduction device.

54. The device of claim 51, wherein:
the spring is a garter spring.

55. The device of claim 51, wherein:
the spring is a ring spring.

56. The device of claim 51, wherein:
the spring is a compression spring.

57. The device of claim 51, wherein:
the spring is a coiled spring with a finite length that is flexed laterally with respect to location along the major axis.

58-65. (canceled)
